(19) United States
(12) Patent Application Publication
(10) Pub. No.: US 2025/0012350 A1
(43) Pub. Date: Jan. 9, 2025

(54) GEAR ASSEMBLIES FOR DISSOCIATING ACTUATION MOTIONS AND FOR REDUCING THE EFFECT OF MOTOR INERTIA

(71) Applicant: Southco, Inc., Concordville, PA (US)

(72) Inventor: Eric Carabalona, Kenilworth, Warwickshire (GB)

(73) Assignee: Southco, Inc., Concordville, PA (US)

(21) Appl. No.: 18/690,482

(22) PCT Filed: Sep. 8, 2022
(86) PCT No.: PCT/US2022/042878

§ 371 Date: Mar. 8, 2024

Related U.S. Application Data
(60) Provisional application No. 63/241,778, filed on Sep. 8, 2021.
(60) Provisional application No. 63/341,676, filed on May 13, 2022.

(51) Int. Cl. F16H 57/025; F16H 35/00; F16H 57/02; F16H 57/028

(52) U.S. Cl. CPC F16H 57/025; F16H 57/028; F16H 2035/006; F16H 2057/02082

(57) ABSTRACT

A gear assembly configured to be driven by a motor and/or manual operation is disclosed. The gear assembly is configured to reduce or eliminate the effect of inertia of the motor on an output of the gear assembly and/or to dissociate a linear motion of the output relative to a rest position from an opposite rotational motion of an input of the gear assembly. The gear assembly may comprise a wheel configured to rotate about a wheel axis, and a drum and a locker both configured to move in response to rotation of the wheel. When both locker and drum are prevented from moving, the wheel continues to move. The gear assembly may comprise a gcar and a driver, both configured to rotate about a gear axis, and a spring disposed therebetween. When the linear motion causes the gear to move, the motion is not transferred to the driver.

### CROSS-REFERENCE TO RELATED APPLICATIONS

This application claims priority to U.S. Provisional Patent Application No. 63/241,778, filed on Sep. 8, 2021, titled “GEAR ASSEMBLIES FOR DISSOCIATING ACTUATION MOTIONS AND FOR REDUCING THE EFFECT OF MOTOR INERTIA,” and U.S. Provisional Patent Application No. 63/341,676, filed on May 13, 2022, titled “GEAR ASSEMBLIES FOR DISSOCIATING ACTUATION MOTIONS AND FOR REDUCING THE EFFECT OF MOTOR INERTIA,” the entireties of both of which are incorporated by reference herein for all purposes.

### FIELD OF THE INVENTION

The present invention relates to gear assemblies, and particularly to manually operated or motor-driven gear assemblies for dissociating actuation motions and/or for reducing the effect of motor inertia.

### BACKGROUND OF THE INVENTION

Manually operated and motor-driven assemblies are relied on in many applications, including locking systems used to secure items such as panels, doors, and doorframes together. Such locking systems may include latches configured for securing in a closed position and releasing from the closed position automotive glove box or accessory compartment doors.

In some instances, an electronically operated latch for automotive door closure systems is desirable due to the need for remote or push-button entry, coded access, key-less access, or monitoring for access. Operation of such an electronically operated latch uses a printed circuit board (PCB), which are traditionally used in motor-driven assemblies to create a brief short circuit so that the motor stops almost instantaneously. In other instances, the opening of latches requires the motor to have sufficient power to not only open the latch, but also to overcome the force of a coupler-type mechanism. Therefore, it has been found that there is a continuing need to improve upon or provide alternatives to existing manually operated or motor-driven assemblies.

### SUMMARY OF THE INVENTION

According to a first aspect of the present invention, a gear assembly configured to be driven by an output shaft of a motor and to reduce or eliminate the effect of inertia of the motor on an output of the gear assembly is disclosed. The gear assembly comprises a wheel configured to be engageably coupled directly or indirectly to the output shaft of the motor and to rotate about a wheel axis in response to motion of the output shaft of the motor. The gear assembly further comprises a drum rotatably mounted to the wheel and configured to rotate about the wheel axis in response to rotation of the wheel. The gear assembly also includes a locker configured to move relative to the wheel axis in response to motion of the wheel. The locker is movable between an unlocked position, in which the locker does not restrict the ability of the drum to rotate about the wheel axis in response to rotation of the wheel, and a locked position, in which the locker restricts the ability of the drum to rotate about the wheel axis in response to rotation of the wheel. When the locker is in the unlocked position, the locker is engaged by the wheel for rotation of the wheel and the drum together about the wheel axis. When the locker is in the locked position, the locker is disengaged from the wheel for rotation of the wheel relative to the drum, thereby allowing inertial motion of the output shaft of the motor and rotation of the wheel without causing rotation of the drum, and thereby reducing or eliminating the effect of inertia of the motor on the output of the gear assembly.

According to another aspect of the present invention, a gear assembly configured to transfer rotational motion of an input into linear motion of an output relative to a rest position and to absorb linear motion of the output relative to the rest position without opposite rotational motion of the input, thereby dissociating the linear motion of the output from the opposite rotational motion of the input is disclosed. The gear assembly comprises a gear mounted for rotational motion about a gear axis and coupled to generate the linear motion of the output relative to the rest position. The gear assembly further comprises a driver coupled directly or indirectly to the gear and mounted for rotational motion about the gear axis, the driver providing the input of the gear assembly. The gear assembly also includes a spring disposed in an interface between the gear and the driver, the spring being configured to bias the gear and the driver toward each other. The interface of the driver and the gear is configured such that rotational movement of the driver as the input of the gear assembly transfers to rotational movement of the gear of the gear assembly, and rotational movement of the gear of the gear assembly transfers to linear motion of the output relative to the rest position. The interface of the driver and the gear is further configured such that opposite linear motion of the output relative to the rest position causes the opposite rotational movement of the gear of the gear assembly, but the opposite rotational movement of the gear is not transferred to opposite rotational movement of the driver of the gear assembly. The gear assembly thus absorbs linear motion of the output from the rest position without opposite rotational motion of the driver by dissociating the linear motion of the output from the opposite rotational motion of the driver.

### BRIEF DESCRIPTION OF THE DRAWINGS

The above and other aspects and features of the present invention will become more apparent to those of ordinary skill in the art by describing in detail exemplary embodiments thereof with reference to the attached drawings.

FIG. 1A depicts a top view of an exemplary embodiment of an assembled latch.

FIGS. 1B-1G depict additional views of the latch shown in FIG. 1A.

FIG. 2 is an exploded view of the latch shown in FIG. 1A.

FIG. 3A is a top view of the latch shown in FIG. 1A, with the cover removed, showing the components therein.

FIGS. 3B-3C depict additional views of the latch shown in FIG. 3A.

FIGS. 4A-4D depict views of an embodiment of a motor.

FIGS. 5A-5E depict views of an embodiment of a worm screw.

FIGS. 6A-6E depict views of an embodiment of motor terminals.

FIGS. 7A-7C depict views of an embodiment of a micro-switch.

FIGS. 8A-8D depict views of an embodiment of a worm gear.

FIGS. 9A-9D depict views of an embodiment of a housing.

FIG. 10A is a perspective view of an exemplary embodiment of a gear assembly that can reduce or eliminate the effect of motor inertia.

FIG. 10B is an exploded view of the gear assembly shown in FIG. 10A.

FIG. 10C depict a view of a portion of the gear assembly shown in FIG. 10B.

FIGS. 10D and 10E are detailed views of another portion of the gear assembly shown in FIG. 10B.

FIG. 10F depicts a view of another portion of the gear assembly shown in FIG. 10B.

FIG. 10G is a detailed view of a portion of the gear assembly shown in FIG. 10F.

FIGS. 11A-11F depict views of an embodiment of a wheel.

FIGS. 12A-12F depict views of an embodiment of a drum.

FIGS. 13A-13J depict views of an embodiment of a locker.

FIG. 14 is a perspective view of an embodiment of a compression spring.

FIGS. 15A-15T depict views of a portion of the gear assembly shown in FIG. 10A, showing movement of one or more components of the gear assembly.

FIGS. 16A-16G depict views of an embodiment of a lever.

FIG. 17A is a perspective view of an exemplary embodiment of another gear assembly, or “dissociation assembly,” that can dissociate actuation motions.

FIG. 17B is an exploded view of the dissociation assembly shown in FIG. 17A.

FIGS. 18A-18D depict views of an embodiment of a driver.

FIGS. 19A-19B depict views of an embodiment of a torsion spring.

FIGS. 20A-20F depict views of an embodiment of a gear.

FIG. 21 depicts an exemplary interface between the driver shown in FIG. 18A and the torsion spring shown in FIG. 19A.

FIG. 22 depicts an exemplary interface between the driver shown in FIG. 18A and the gear shown in FIG. 20A.

FIG. 23 depicts an exemplary interface between the gear shown in FIG. 20A and the torsion spring shown in FIG. 19A.

FIGS. 24A-24H depict views of an embodiment of a pawl.

FIGS. 25A-25C, 26A-26C, 27A-27C, 28A-28C, 29A-29C, 30A-30C, 31A-31C, 32A-32C, 33A-33C, 34A-34C, and 35A-35C depict views of a portion of the latch shown in FIG. 1A, showing movement of components of the dissociation assembly shown in FIG. 17A in response to motion of the gear assembly shown in FIG. 10A.

FIGS. 36A-36I depict views of a portion of the latch shown in FIG. 1A, showing movement of one or more components of the dissociation assembly shown in FIG. 17A in response to manual operation of the latch.

FIGS. 37A-37D depict views of an embodiment of a cover.

FIGS. 38A-38B depict views of another exemplary embodiment of an assembled latch.

FIGS. 39A-39B depict views of the latch shown in FIG. 38A, showing the components therein.

FIG. 40 is an exploded view of the latch shown in FIG. 38A, showing another exemplary embodiment of a dissociation assembly.

FIGS. 41A-41B depict views of another exemplary embodiment of a latch, with the cover removed, showing the components therein.

FIG. 42 is an exploded view of the latch shown in FIG. 41A, showing another exemplary embodiment of a dissociation assembly.

FIGS. 43A-43B depict views of another exemplary embodiment of an assembled latch.

FIGS. 44A-44B depict views of the latch shown in FIG. 43A, showing the components therein.

FIG. 45 is an exploded view of the latch shown in FIG. 43A, showing another exemplary embodiment of a dissociation assembly configured for operation in response to manual actuation of the latch.

FIGS. 46A-46B depict views of another exemplary embodiment of a latch configured for manual actuation.

FIG. 47A depicts another exemplary dissociation assembly, showing the dissociation assembly being arranged within the latch shown in FIG. 46A.

FIG. 47B is an exploded view of the dissociation assembly shown in FIG. 46A.

FIGS. 48A-48G depict views of a portion of the latch shown in FIG. 46A, showing movement of components of the dissociation assembly shown in FIG. 47A.

FIG. 49A-49B depict views of another exemplary embodiment of a gear assembly.

FIG. 49C is an exploded view of the gear assembly shown in FIG. 49A.

FIGS. 50A-50B depict views of a portion of the gear assembly shown in FIG. 49A, showing arrangement of the components of the gear assembly.

FIGS. 51A-51C depict views of a portion of the gear assembly shown in FIG. 49A, showing movement of one or more components of the gear assembly.

FIG. 52 is a perspective view of another exemplary embodiment of a locker.

FIGS. 53A-53B depict views of an exemplary embodiment of a shaft.

FIG. 54A depicts a top view of an exemplary embodiment of an assembled latch.

FIGS. 54B-54G depict additional views of the latch shown in FIG. 54A.

FIG. 55 is an exploded view of the latch shown in FIG. 54A.

FIG. 56A is a top view of the latch shown in FIG. 54A, with the cover removed, showing the components therein.

FIGS. 56B-56C depict additional views of the latch shown in FIG. 56A.

FIGS. 57A-57C depict views of another embodiment of a micro-switch.

FIGS. 58A-58D depict views of another embodiment of a worm gear.

FIGS. 59A-59D depict views of another embodiment of a housing.

FIG. 60A is a perspective view of another exemplary embodiment of a gear assembly that can reduce or eliminate the effect of motor inertia.

FIG. 60B is an exploded view of the gear assembly shown in FIG. 60A.

FIG. 60C depict a view of a portion of the gear assembly shown in FIG. 60B.

FIGS. 60D and 60E are detailed views of another portion of the gear assembly shown in FIG. 60B.

FIG. 60F depicts a view of another portion of the gear assembly shown in FIG. 60B.

FIG. 60G is a detailed view of a portion of the gear assembly shown in FIG. 60F.

FIGS. 61A-61F depict views of another embodiment of a wheel.

FIGS. 62A-62F depict views of another embodiment of a drum.

FIGS. 63A-63J depict views of another embodiment of a locker.

FIGS. 64A-64J depict views of a portion of the gear assembly shown in FIG. 60A, showing movement of one or more components of the gear assembly.

FIGS. 65A-65G depict views of another embodiment of a lever.

FIG. 66 is an exploded view of another exemplary embodiment of a dissociation assembly.

FIGS. 67A-67H depict views of another embodiment of a pawl.

FIGS. 68A-68C, 69A-69C, 70A-70C, 71A-71C, 72A-72C, 73A-73C, 74A-74C, 75A-75C, 76A-76C, 77A-77C, and 78A-78C depict views of a portion of the latch shown in FIG. 54A, showing movement of components of the dissociation assembly shown in FIG. 66 in response to motion of the gear assembly shown in FIG. 60A.

FIGS. 79A-791 depict views of a portion of the latch shown in FIG. 54A, showing movement of one or more components of the dissociation assembly shown in FIG. 66 in response to manual operation of the latch.

FIGS. 80A-80D depict views of another embodiment of a cover.

FIG. 81A depicts an exemplary embodiment of an isolator feature of the cover shown in FIG. 80A.

FIG. 81B is an exploded view of the isolator feature of FIG. 81A.

FIG. 81C depicts a cross-section view of the isolator feature of FIG. 81A.

FIG. 81D depicts cross-section view of the isolator feature of FIG. 81B.

FIGS. 82A-82F depict exemplary embodiments of mounting arms of the isolator feature.

FIGS. 83A-83C depict exemplary embodiments of the gear assembly of FIG. 60A.

FIG. 84 is a top view of another exemplary embodiment of an assembled latch, with the cover removed, showing the components therein.

FIG. 85A is a perspective view of another exemplary embodiment of a gear assembly that can reduce or eliminate the effect of motor inertia.

FIG. 85B is an exploded view of the gear assembly shown in FIG. 85A.

FIG. 85C depicts a view of a portion of the gear assembly shown in FIG. 85B.

FIG. 85D depicts a view of another portion of the gear assembly shown in FIG. 85B.

FIG. 85E is a detailed view of a portion of the gear assembly shown in FIG. 85D.

FIGS. 86A-86F depict views of another embodiment of a wheel.

FIGS. 87A-87F depict views of another embodiment of a drum.

FIGS. 88A-88G depict views of another embodiment of a lever.

### DETAILED DESCRIPTION OF THE INVENTION

The exemplary assemblies disclosed herein are configured for dissociating motor actuation from mechanical actuation. Additionally or optionally or alternatively, the assemblies disclosed herein are configured for reducing or eliminating the effect of inertia of a motor on an output of an assembly, such as a motor-driven assembly.

The assemblies described herein are particularly suitable, for example, for use in a latch, such as an electronic glove box latch (EGBL). In one non-limiting example, the disclosed assembly desirably limits or reduces cost associated with additional components, as well as desirably limits or reduces the power required to operate a system, such as a locking system comprising a latch. Still further, the disclosed assemblies desirably reduces the effect of inertia of a motor on an output of the assembly. More specifically, the disclosed motor-driven assembly desirably limits or reduces the number of electric signals needed to control and drive the EGBL because it makes it possible to avoid the use of a PCB while desirably reducing the effect of inertia of a motor on an output of the gear assembly.

An electronic glove box latch is intended for unlatching or latching a door assembly having a door, such as a glove box door for a vehicle, for example. The door is generally rectangular in shape and is mounted over an opening, such as an opening formed in a dashboard of a vehicle. Further, the door is hinged to the opening and can move between a closed position and an open position. In the closed position of the door, a front face of the door is flush with the surface of the dashboard. In the open position of the door, the door protrudes from the surface of the dashboard. Strikers are conventionally provided at the perimeter of the opening of the dashboard.

Although embodiments of gear assemblies are described herein with respect to a latch, such as an electronic glove box latch (EGBL), it will be understood that the invention is not so limited. Other suitable applications for an exemplary motor-driven assembly of the present invention and/or an exemplary manually operated assembly of the present invention will be readily understood by one of ordinary skill in the art from the description herein.

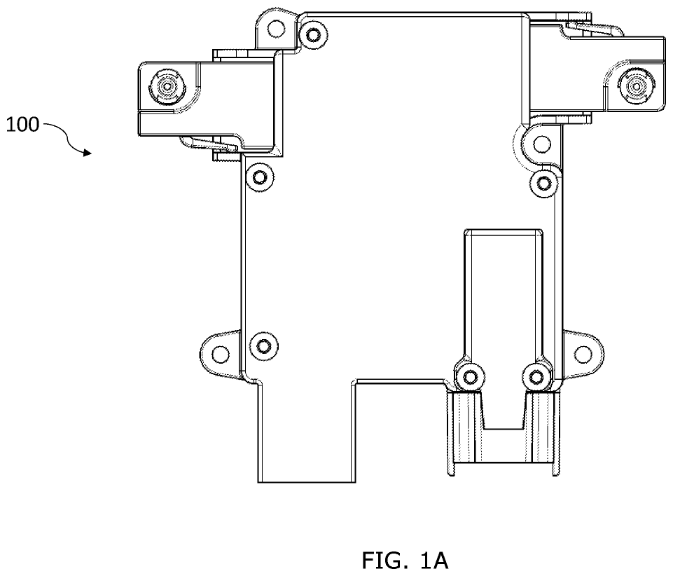

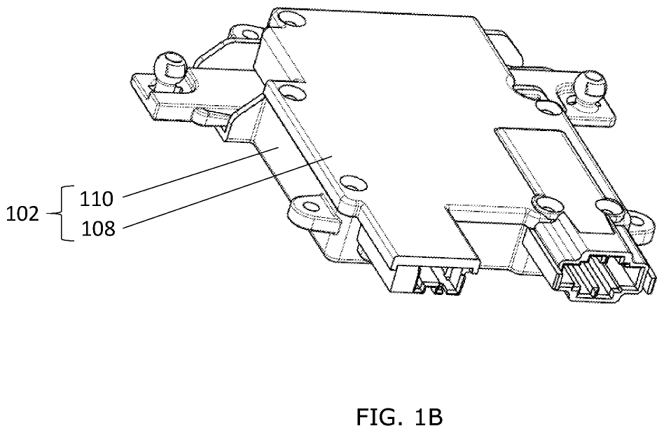

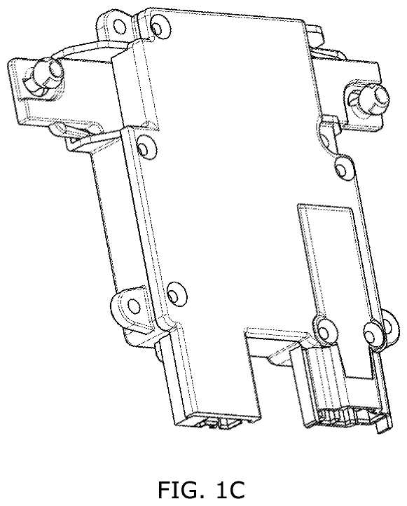

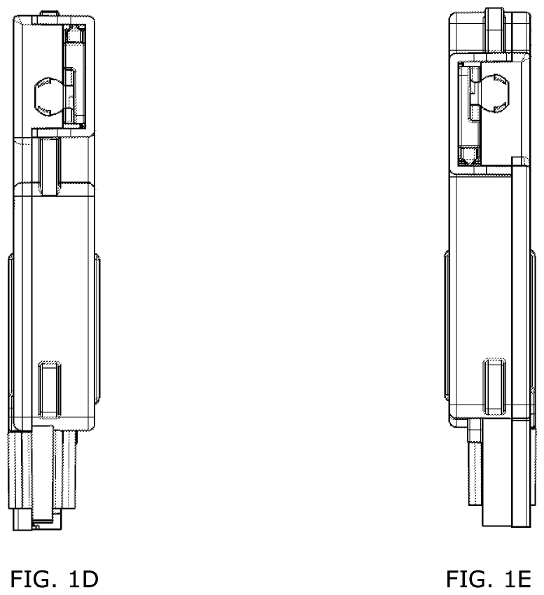

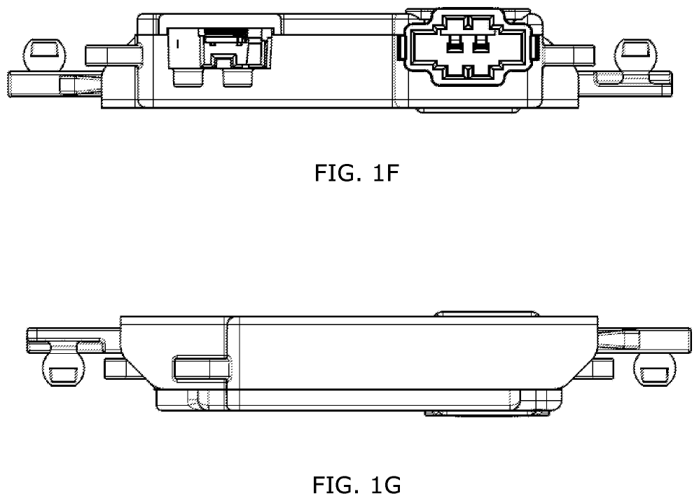

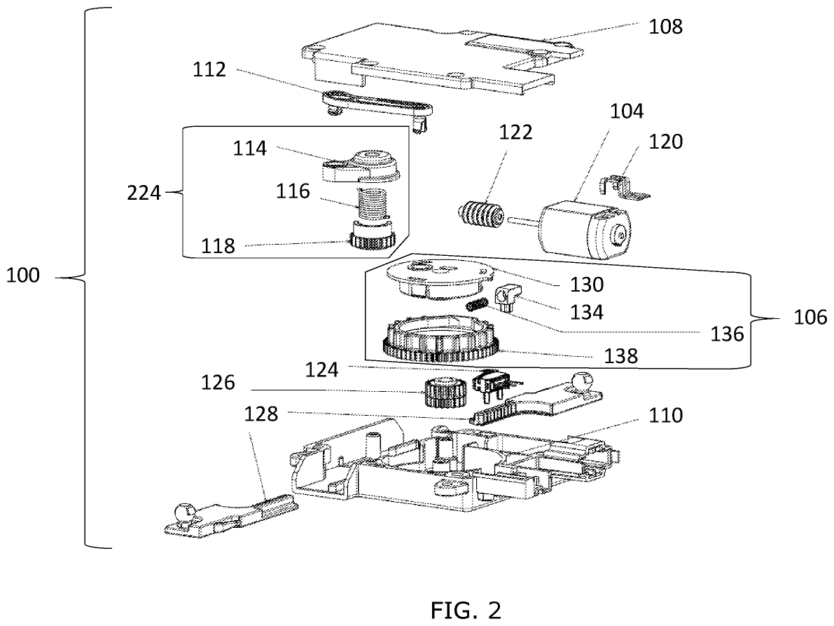

An embodiment of an assembled latch incorporating aspects of the present invention is disclosed in FIGS. 1A-1G and 2. An assembly, such as latch 100, is usable for unlatching or latching a door assembly. In a non-limiting example, latch 100 is configured for unlatching the door assembly by motor-driven operation and latching the door assembly by manual operation. Further, the latch 100 can be configured to operate automotive door closure systems, such as glove boxes and the like. In general, latch 100 comprises an enclosure 102, a motor 104, and an exemplary gear assembly 224 that permits a partial or complete, direct or indirect disconnection and/or separation of motion of one component from motion of another component, generally referred to herein as a “dissociation assembly.” Additionally or optionally, latch 100 may include an exemplary gear assembly 106. Additional details of latch 100 are described below.

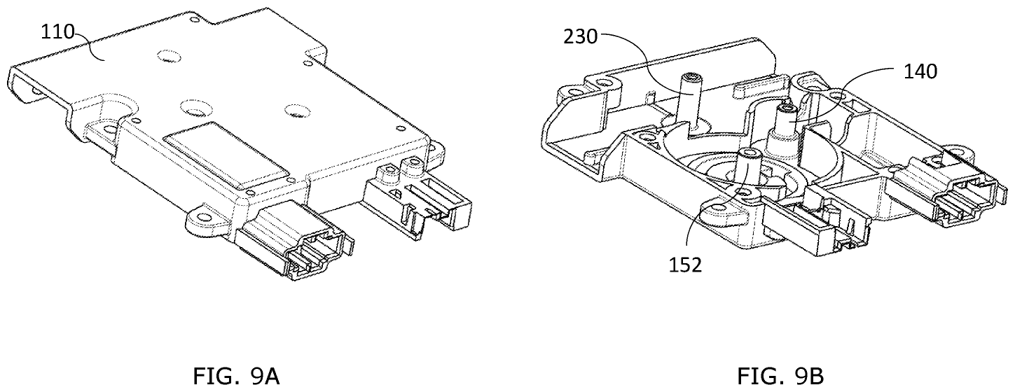

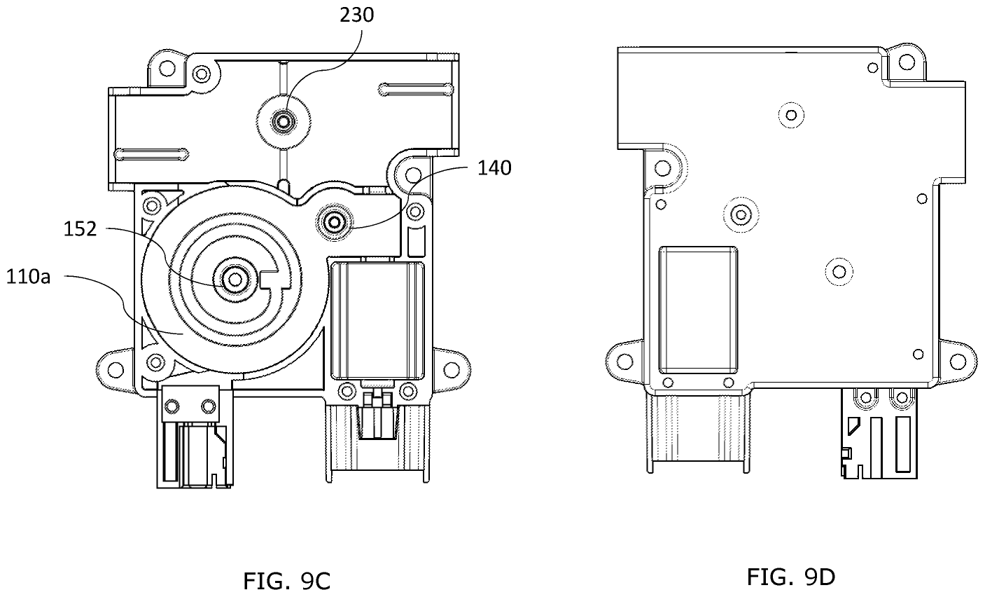

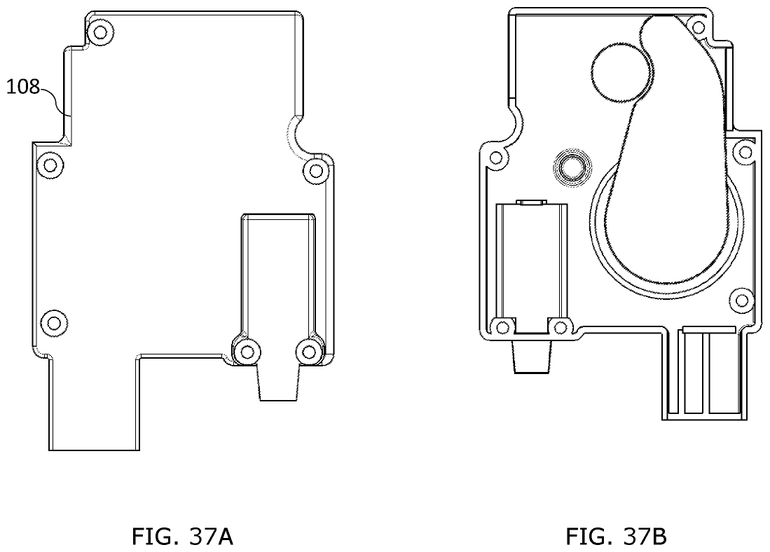

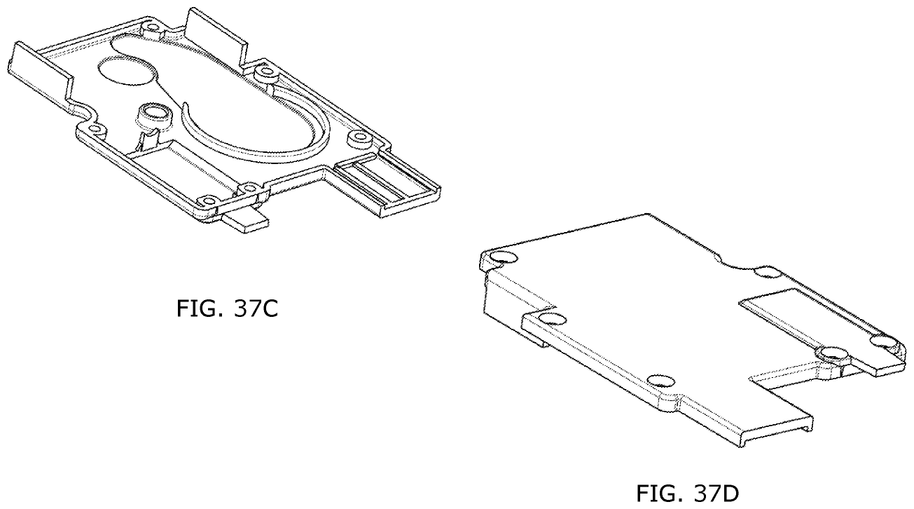

Enclosure 102 (FIG. 1B) at least partially houses operational components of the latch 100, including the motor 104 and the exemplary gear assembly 106. In an example, as seen in FIG. 2, the enclosure 102 can be formed from one or more structures that together define an interior. In particular, the one or more structures can include a cover 108 (FIGS. 37A-37D) and a housing 110 (FIGS. 9A-9D). As seen in FIG. 2, the operational components of the latch 100 (e.g., the motor 104 and the gear assembly 106) are provided or positioned within this interior of the enclosure 102, thereby providing protection for at least these components and concealing wiring and other items that may affect operation of the latch 100. Additional details of these operational components are discussed further below.

Although the enclosure 102 is illustrated as being comprised of separate components, e.g. cover 108 and housing 110, one of ordinary skill in the art would understand from the description herein that the enclosure 102 may be integrally formed as a single body of unitary construction. As depicted in FIGS. 37A-37D and FIGS. 9A-9D, respectively, the cover 108 and the housing 110 each have a shape and size that corresponds to the other, such that together, each of cover 108 and housing 110 may have surfaces or portions thereof that correspond or conform to the shape, size, and surface of one or more of the components of the latch 100.

The cover 108 and housing 110 may be made of more durable material, relative to one or more of the other components of the latch 100. In an example, the cover 108 and housing 110 are formed from a more rigid material intended to provide support and/or a mounting structure for the components of the latch 100. However, it would be understood from the description herein that optionally, the top cover 108 and housing 110 may comprise different materials.

As shown in FIGS. 1A-1G, the cover 108 and housing 110 may generally have a rectangular shape. However, various modifications may be made in the size and shape of the enclosure 102 without departing from the invention, so long as the enclosure 102 may be positioned at least partially within a cavity or space. In an exemplary embodiment, the cavity or space may be defined within a door housing, such as a door housing mounted to a dashboard of the vehicle, or within a door movably mounted to the door housing.

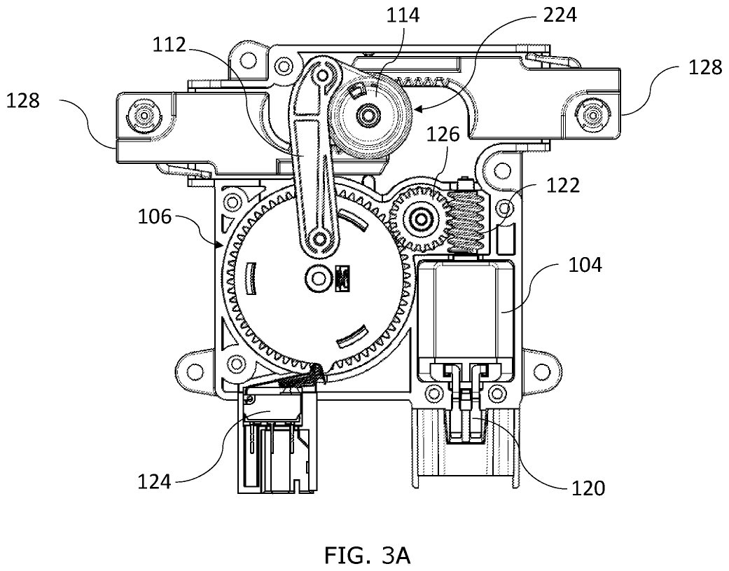

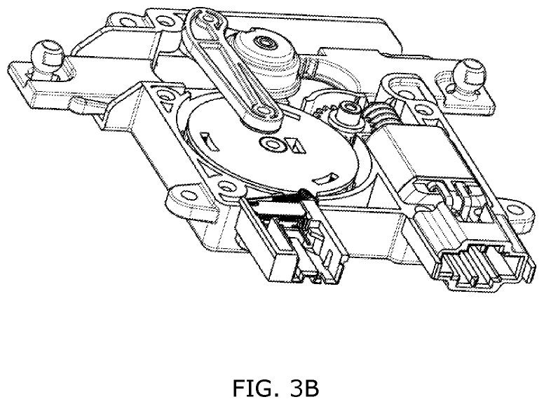

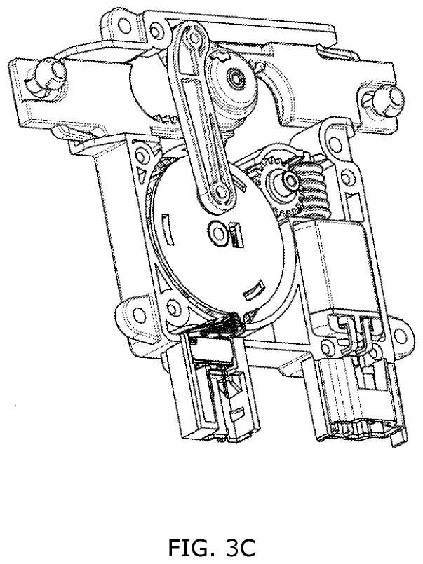

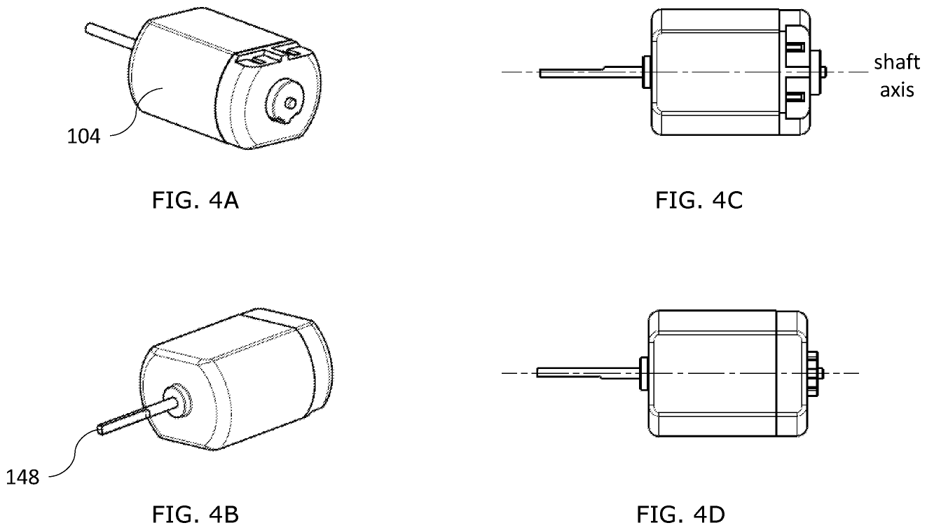

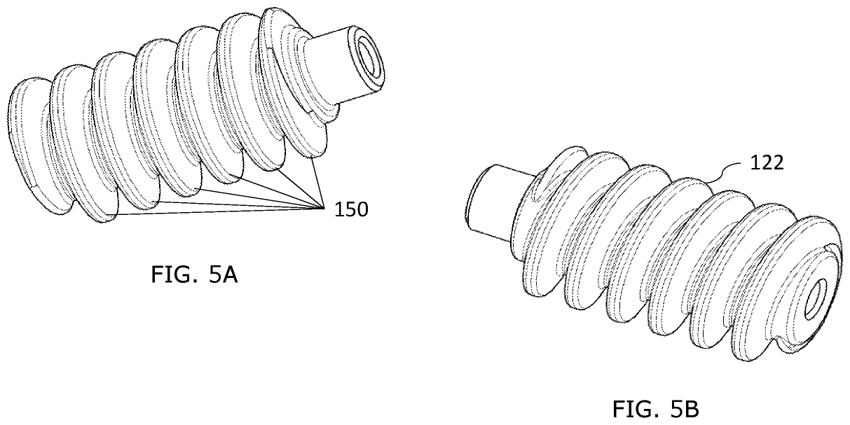

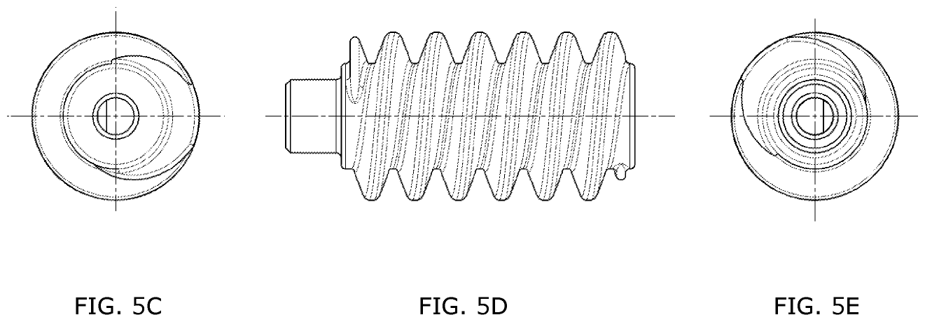

Referring now to at least FIGS. 3A-3C, arrangement of the operational components of the latch 100, including the motor 104, are shown without the cover 108. Motor 104 is mounted to the housing 110. As seen in FIGS. 4A-4D, motor 104 has a rotatable output shaft 148 configured to rotate around a shaft axis (FIG. 4C) for a single direction (either clockwise or counter-clockwise). Rotatable output shaft 148 may have a fixed worm screw 122 having teeth 150, the details of which are shown in FIGS. 5A-5E.

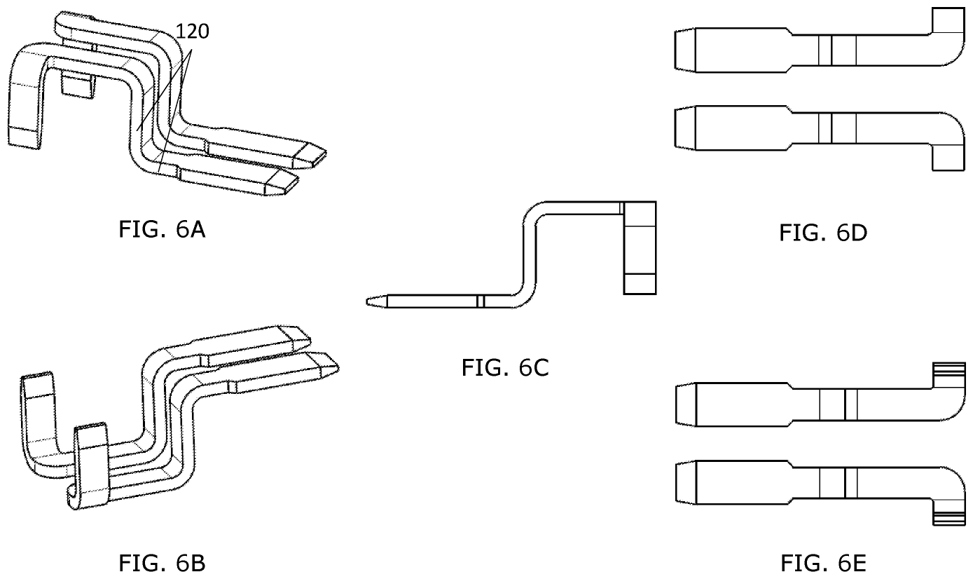

Two electrically conductive tracks 120, or motor terminals (FIGS. 6A-6E) interconnect the motor 104 to one or more of a power source (not shown) or the micro-switch 124. One track 120 interconnects the motor 104 to the power source, and the other track 120 may electrically connect the motor 104 to the micro-switch 124. Alternatively, both tracks 120 may connect motor 104 to the power source, and the motor 104 may be connected to the micro-switch 124 by one or more wires, for example.

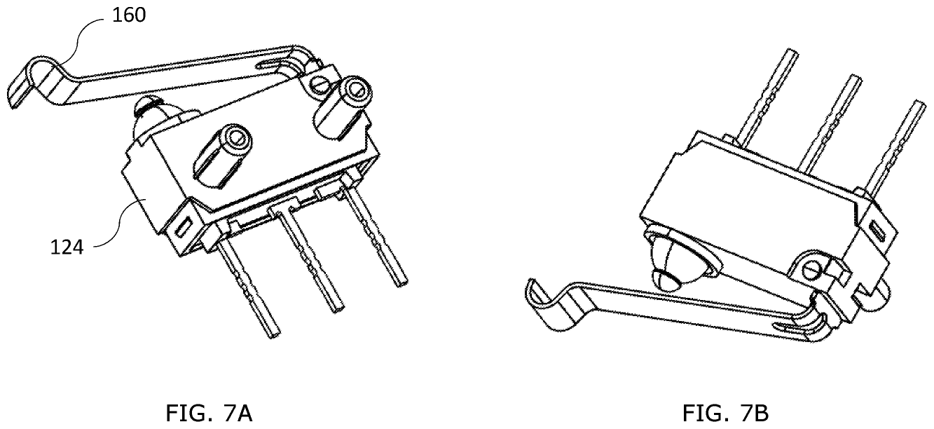

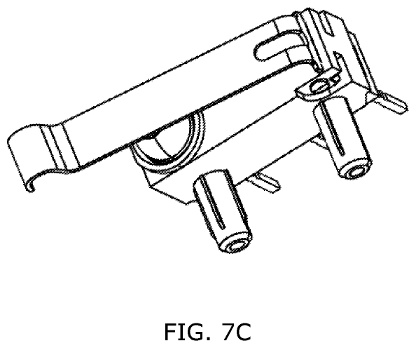

Details of the micro-switch 124 are shown in FIGS. 7A-7C. A wiper arm 160 extends from the micro-switch 124 and is positioned to engage with a curved portion 162 of a drum 130 having a predetermined circumferential length (discussed further below). In a non-limiting example, the micro-switch 124 is configured to detect rotation of the drum 130, and communicate one or more rotational positions of the drum 130 to a processor and/or controller in the vehicle. The micro-switch 124 may be generally referred to as a sensor, and/or may be substituted by a rotary encoder, Hall-effect sensor, a Linear Variable Differential Transformer (LVDT), potentiometer, optical proximity sensor, transducer, eddy-current sensor, or photodiode, for example.

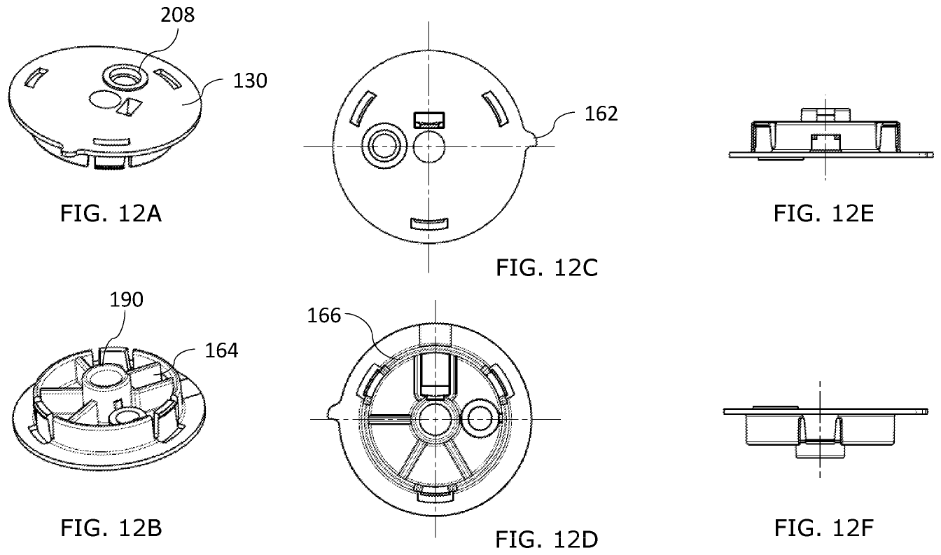

The micro-switch 124 is configured to sense rotation of the drum 130 based upon the interaction between the wiper arm 160 and curved portion 162 (FIG. 12C) of drum 130. The curved portion 162 may be referred to herein as an indexing means. As an alternative to the curved portion 162, those skilled in the art will recognize that the indexing means could be a surface, recess, marking, magnet, circuit, magnetic feature, optical feature, post, slot, pin, or a combination thereof, for example, or any other feature on the drum 130 that can be used for tracking movement of the drum 130. Also, the indexing means could be provided on a different or another component of the gear assembly 106 or of the latch 100.

In an exemplary embodiment including an electronic glove box latch, the signal outputted by the micro-switch 124 may be outputted to a computer or control unit in a vehicle, thereby indicating when rack or pawls 128 (discussed further below) are withdrawn, which signifies that a panel or door, such as a glove box door, is open. The computer or control unit in a vehicle may be configured to activate a light or bulb within the glove box when the glove box door is open.

Turning now to FIGS. 3A, 8A-8D, and 9A-9D, a wheel 138 may be engageably coupled directly or indirectly to the output shaft 148 of the motor 104, such that gear 126 is optional. In a non-limiting example, when the wheel 138 is configured to be engageably coupled indirectly to the output shaft 148 of the motor 104, latch 100 further comprises at least one gear 126 interposed between the output shaft 148 of the motor 104 and the wheel 138. The at least one gear 126 is configured to be driven by the output shaft 148 of the motor 104. In an exemplary embodiment, worm gear 126 is rotatably mounted to the housing 110 by a shaft 140 (FIG. 9B) extending upward from the housing 110. An upper set 142 of teeth on the worm gear 126 is non-rotatably connected to and meshes with teeth 150 on the worm screw 122, such that the worm gear 126 rotates along with the worm screw 122. The lower set 144 of teeth on the worm gear 126 mesh with teeth 146 of the wheel 138 (further discussed below).

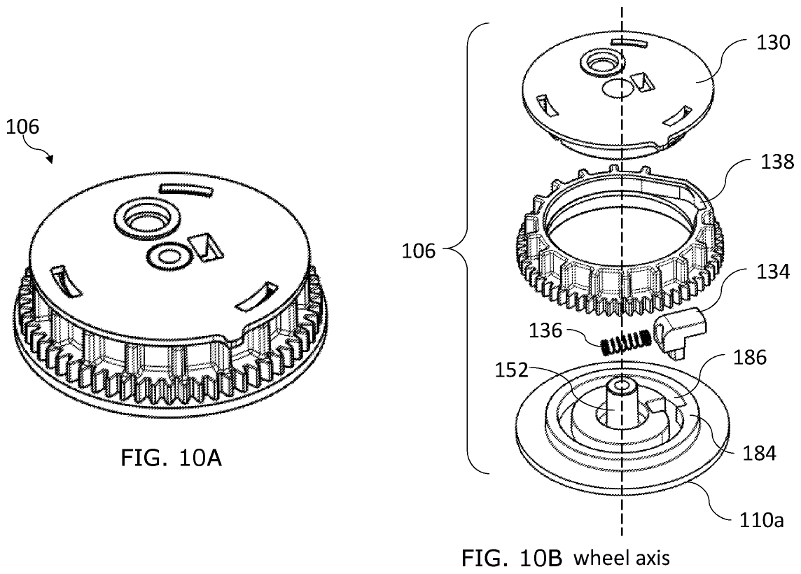

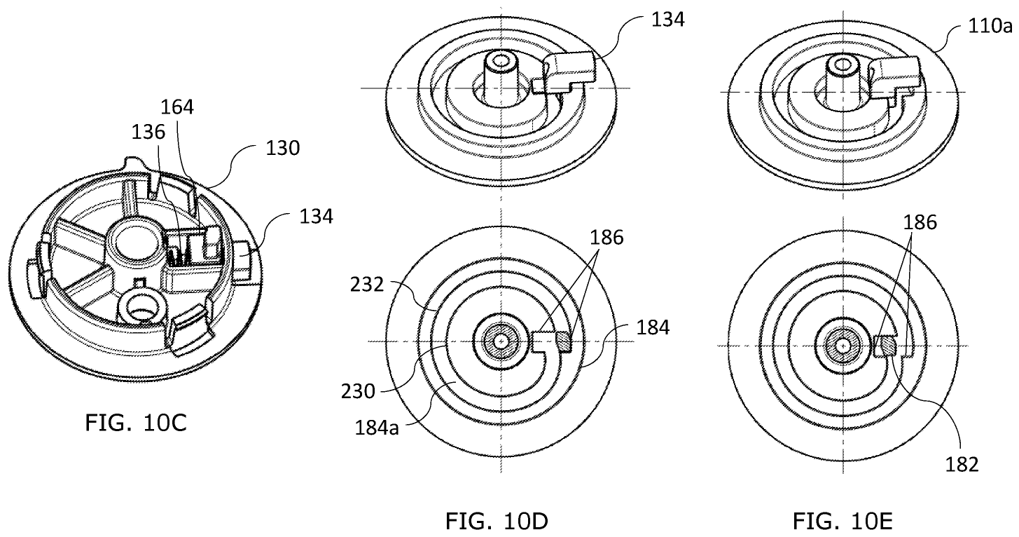

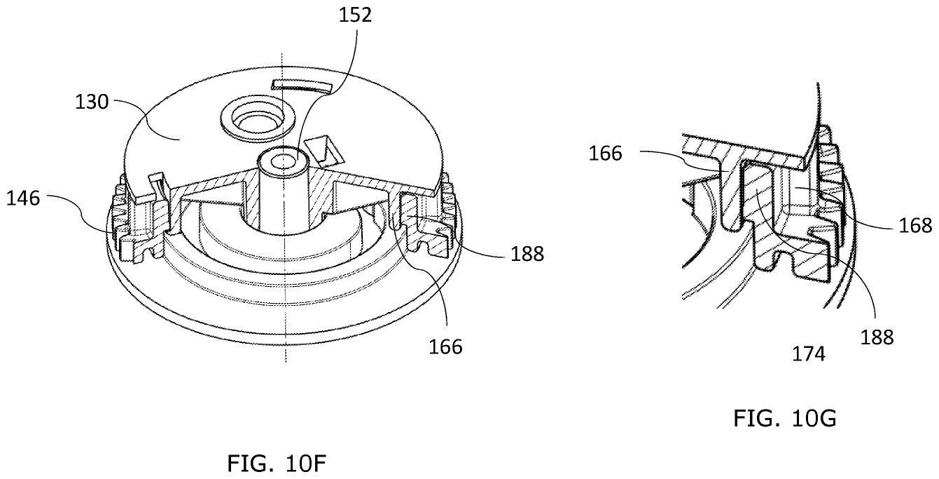

Referring now to FIGS. 10A-10G, details of the exemplary gear assembly 106 are disclosed. The gear assembly 106 is configured to be driven by the output shaft 148 of the motor 104. Further, the gear assembly 106 is configured to desirably reduce or eliminate the effect of inertia of the motor on an output of the gear assembly 106.

In one non-limiting example, without the use of a PCB for creating a brief short circuit between the two terminals 120 (FIGS. 6A-6E) of the motor 104 so that the motor 104 stops almost instantaneously, the output shaft 148 of the motor 104 continues to rotate, thereby causing wheel 138 to rotate in response to the motion of the output shaft 148, for an additional non-negligible rotational amount, such as a partial or plural number of turns, due to the effect of inertia of the motor 104. Continued rotation of the motor 104 can lead to operational failure of latch 100 because the continued rotation of motor 104 may cause or otherwise contribute to one or more components of the latch 100 being undesirably displaced past a rest or home position for resetting a use cycle of latch 100.

The effect of inertia of the motor 104, e.g., the additional non-negligible number of turns, on an output of the gear assembly 106, can vary greatly based on operating conditions of gear assembly 106 or of latch 100 generally. These operating conditions may include the range of temperatures (generally −40° C. to +90° C.) as well as a range of voltages (often between 9V and 16V). Therefore, the exemplary gear assembly 106 described herein is configured to address the inertial effect of the motor 104 under various operating conditions by desirably reducing or eliminating the effect of inertia of the motor 104 on an output of the gear assembly 106.

In general, gear assembly 106 comprises the wheel 138, the drum 130, and a locker 134. Operation of the gear assembly 106 is generally described below, and addition details of the individual components are described thereafter.

In an exemplary embodiment, as seen in FIG. 10B, gear assembly 106 also includes a housing 110a defining an annular surface 184. In an exemplary embodiment, housing 110 defines annular surface 184, such that it comprises a track 184a (FIG. 10D) having an internal side wall 230 and an external side wall 232. The internal and external side walls 230/232 may be radially disposed at an internal wall radial distance and an external wall radial distance, respectively, relative to a wheel 10) axis (FIG. 10B), or a center of the drum 130 (discussed further below).

Further, a radially displaced portion 186 (FIGS. 10D and 10E) of the annular surface 184 may be displaced radially relative to the wheel axis or the center of the drum 130. Although FIGS. 9B-9C show the housing 110a as being integrally formed with the housing 110 as a single body of unitary construction, one of ordinary skill in the art would understand from the description herein that the housing 110a or annular surface 184 may be separate components relative to the housing 110, or another one or more components of the latch 100.

The wheel 138 is rotatably mounted with respect to the housing 110 by a second shaft 152 (FIG. 9B). Further, the wheel 138 is configured to be engageably coupled indirectly to the output shaft 148 of the motor 104 via at least one gear 126, as illustrated in FIG. 3A. Optionally, the wheel 138 may be configured to be engageably coupled directly or indirectly to the output shaft 148 of the motor 104.

In a non-limiting example, when a wheel 138 is configured to be engageably coupled indirectly to the output shaft 148 of the motor 104, at least one gear 126 is interposed between the output shaft 148 of the motor 104 and the wheel 138. In this configuration, as shown in FIGS. 10A-10B, wheel 138 is configured to rotate about the wheel axis in response to movement of the at least one gear 126 in response to motion of the output shaft 148 of the motor 104. Further, as illustrated in FIG. 10B, drum 130 is rotatably mounted to the wheel 138 and is configured to rotate about the wheel axis in response to rotation of the wheel 138.

As best shown in FIGS. 10C-10E, locker 134 is mounted for movement relative to the drum 130. The locker 134 may comprise a leg portion 182 positioned adjacent the annular surface 184 of the housing 110a. As seen in FIG. 10C, at least a portion of locker 134 is positioned within a cavity 164 (FIG. 12B) defined by a rear surface 166 (FIG. 12D) of the drum 130. In particular, as seen in FIG. 10C and 10D, locker 134 is configured to move radially relative to the wheel axis in response to motion of the wheel 138.

The locker 134 is further movable radially between the unlocked position (FIG. 10D), in which the locker 134 does not restrict the ability of the drum 130 to rotate about the wheel axis in response to rotation of the wheel 138, and the locked position (FIG. 10E), in which the locker 134 restricts the ability of the drum 130 to rotate about the wheel axis in response to rotation of the wheel 138. Movement of the locker 134 between the unlocked and locked positions is facilitated by the radially displaced portion 186 of the annular surface 184.

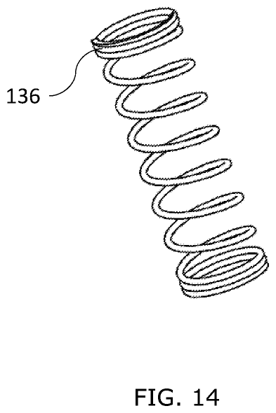

A biasing means, such as spring 136 (FIG. 14), may be disposed within the drum 130 and may be configured to bias the locker 134 toward the unlocked position. In operation, when the locker 134 is in the unlocked position, locker 134 is engaged by the wheel 138 for rotation of the wheel 138 and the drum 130 together about the wheel axis. Conversely, when the locker 134 is in the locked position, locker 134 is disengaged from the wheel 138 for rotation of the wheel 138 relative to the drum 130, thereby allowing inertial motion of the output shaft 148 of the motor 104 and rotation of the wheel 138 without causing rotation of the drum 130, and thereby reducing or eliminating the effect of inertia of the motor 104 on the output of the gear assembly 106.

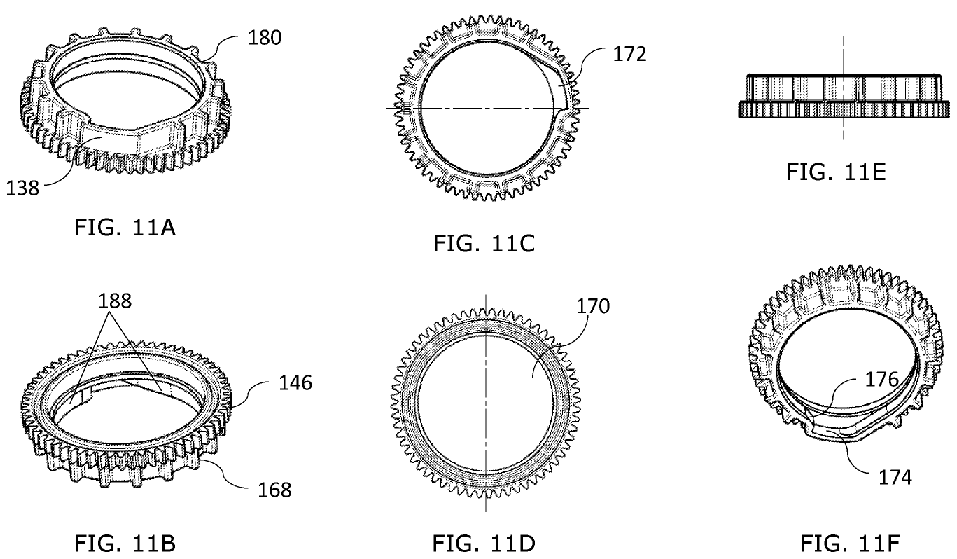

Individual details of wheel 138, drum 130, and locker 134 are discussed below and with reference to FIGS. 11A-11F, 12A-12F, and 13A-J, respectively.

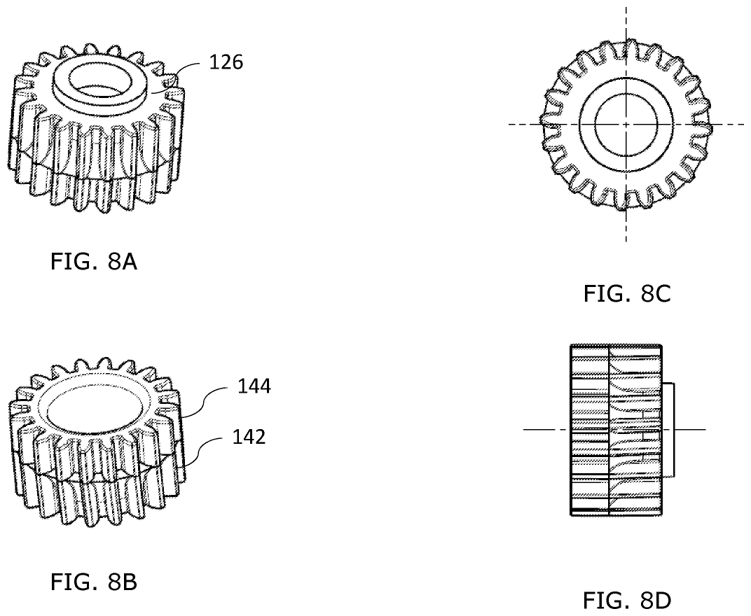

FIGS. 11A-11F depict the wheel 138. The wheel 138 has a circular body with a set of gear teeth 146 extending along its outer perimeter. As shown in FIG. 3A, the set of gear teeth 146 are configured to mesh with lower set 144 of teeth on the worm gear 126 (FIG. 8B). The wheel 138 further includes reinforced ribs 168 extending along a perimeter defined by the set of gear teeth 146. A thru-hole 170 extends through the center of the wheel 138 and through its thickness. In an assembled form of the gear assembly (as shown in FIGS. 10A-10B), shaft 152 passes through the hole 170 of wheel 138 and hole 190 of drum 130, for mounting the wheel 138 and the drum 130 within the enclosure 102.

As best illustrated in FIGS. 10F-10G, a side wall 188 of wheel 138 is configured to engage with an exterior of the rear surface 166 of drum 130 when at least rear surface 166 of the drum 130 is nested within thru-hole 170. In particular, the smooth interface between wheel 138 and the drum 130 via the engagement between side wall 188 of the wheel 138 and the exterior of the rear surface 166 is configured to cause drum 130 to rotate about the wheel axis in response to motion of the wheel 138. Additionally or optionally, the smooth interface between wheel 138 and the drum 130 via the engagement between side wall 188 of the wheel 138 and the exterior of the rear surface 166 desirably allows the wheel 138 to continue to rotate relative to the drum 130, even when the drum 130 is immobilized (by the locker 134).

The wheel 138 has a radial surface 180 defined by hole 170, and at least a portion of radial surface 180 is configured to move the locker 134 against the biasing means 136, such that at least the leg portion 182 of the locker 134 is positioned adjacent the annular surface 184 of the housing 110a. The radial surface 180 comprises a C-shaped channel 172 formed by a sidewall 174 and an angled surface 176. The channel 172 of the wheel 138 is positioned to face the locker 134, when the locker 134 is in the unlocked position.

As stated above, the radial surface 180 may comprise side wall 174 that is disposed at a first radial distance relative to the wheel axis, or the center of the drum 130. The radial surface 180 may further comprise another side wall 188 disposed at a second radial distance relative to the wheel axis, or the center of the drum 130, such that the first radial distance is greater than the second radial distance. Still further, the first and second radial distances may be both greater than that of the distance between the annular surface 184 of the housing 110a relative to the wheel axis, or the center of the drum 130.

FIGS. 12A-12F depict the drum 130. The drum 130 has a circular body and the rear surface 166 defining an annular surface with a plurality of cavities 164. As shown in FIG. 10C, one cavity 164 is configured to at least partially contain locker 134. In one exemplary embodiment, cavity 164 is configured to completely contain L-shaped body 192 of locker 134. As stated above, the drum 130 is rotatably mounted to the wheel 138, such that the rear surface 166 generally corresponds to the shape and configuration of the wheel 138. As best illustrated in FIG. 10A, at least rear surface 166 of the drum 130 is configured to be nested within thru-hole 170 defined by wheel 138. Still further, the center of the drum 130 defines an opening 190, through which shaft 152 may pass for rotatably mounting the drum 130 to the wheel 138 and for mounting the drum 130 within the enclosure 102.

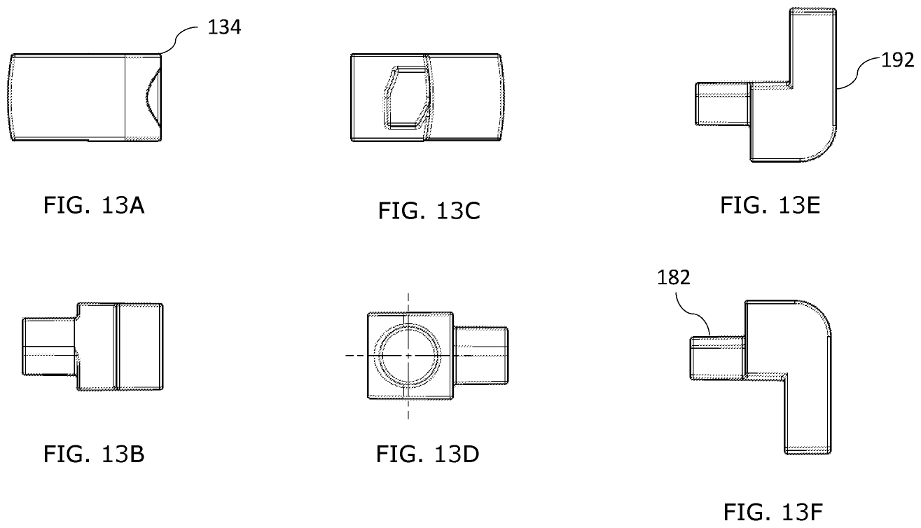

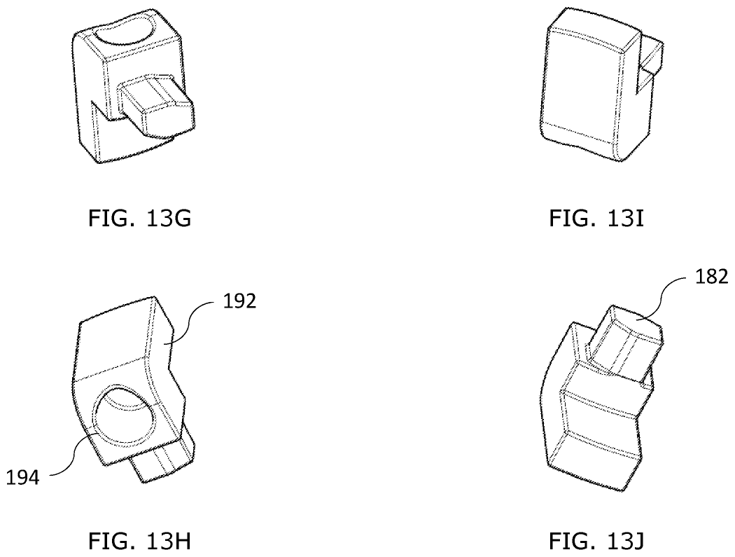

FIGS. 13A-13J depict the locker 134. The locker 134 may comprise a generally L-shaped body 192 and the leg portion 182 extending downwardly from the body 192, as shown in FIG. 13H, for example. The body 192 may further define an opening 194 configured to receive at least a portion of biasing means 136 (as seen in FIGS. 10B and 10C). Although FIGS. 10B and 10C show biasing means 136 as being disposed within the body 129 of the locker 134 (via opening 194, for example), one of ordinary skill in the art would understand from the description herein that the biasing means 136 may additionally or optionally or alternatively, be disposed within a portion of the drum 130.

One skilled in the art would also understand from the description herein that locker 134 may have a different size and geometry based on one or more components of the gear assembly 106 or of the latch 100. In the embodiment illustrated in FIGS. 13A-13J, the L-shaped body 192 of locker 134 is configured to have a size and geometry, such that body 192 is received by cavity 164 of the drum 130. Further, body 192 of locker 134 is configured to travel along the annular surface 184 of the housing 110a. In particular, the leg portion 182 may be positioned adjacent the annular surface 184 of the housing 110a, such that the radially displaced portion 186 (FIG. 10D and 10E) of the annular surface 184 is positioned to move the leg portion 182 and therefore the locker 134, from the unlocked position (FIG. 10D) to the locked position (FIG. 10E).

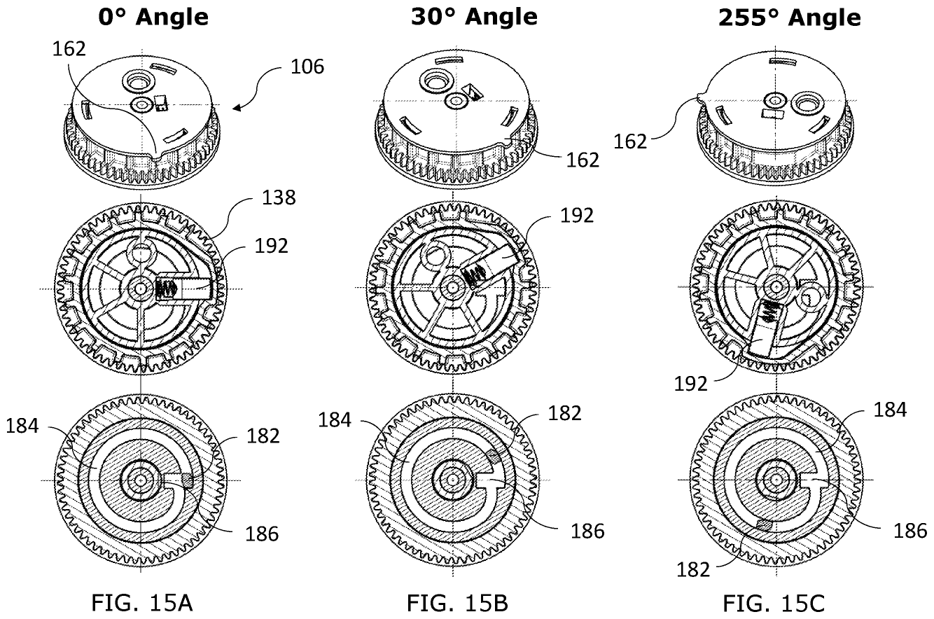

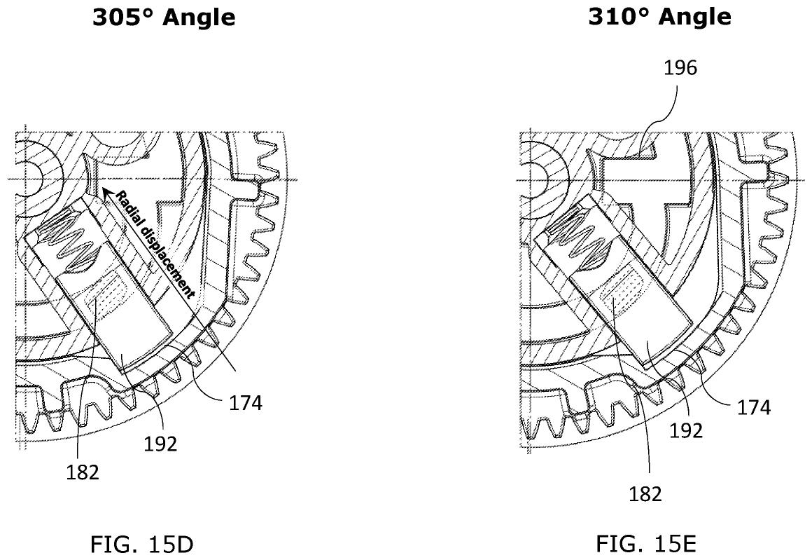

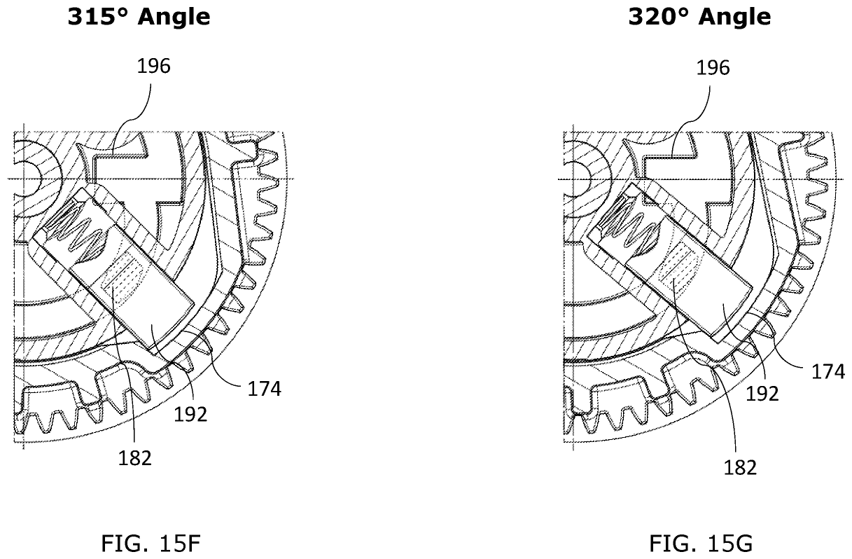

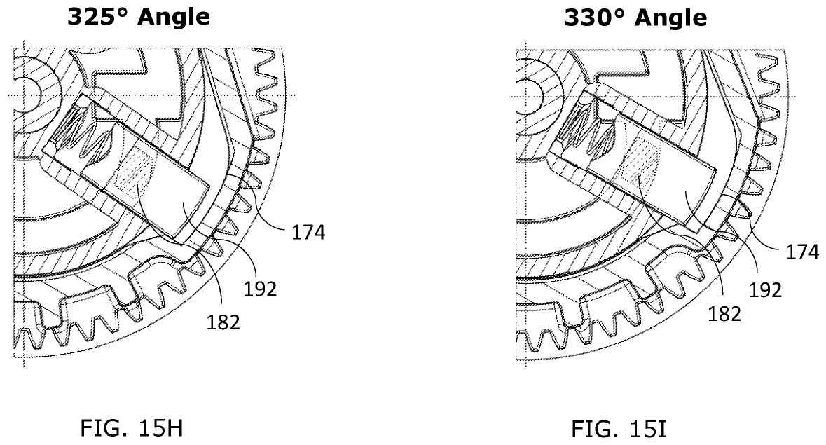

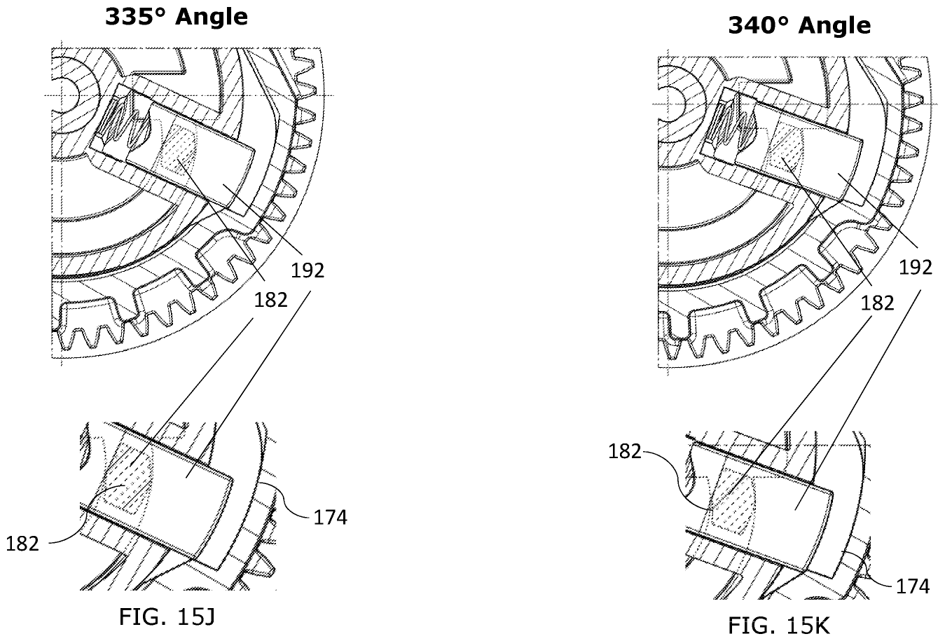

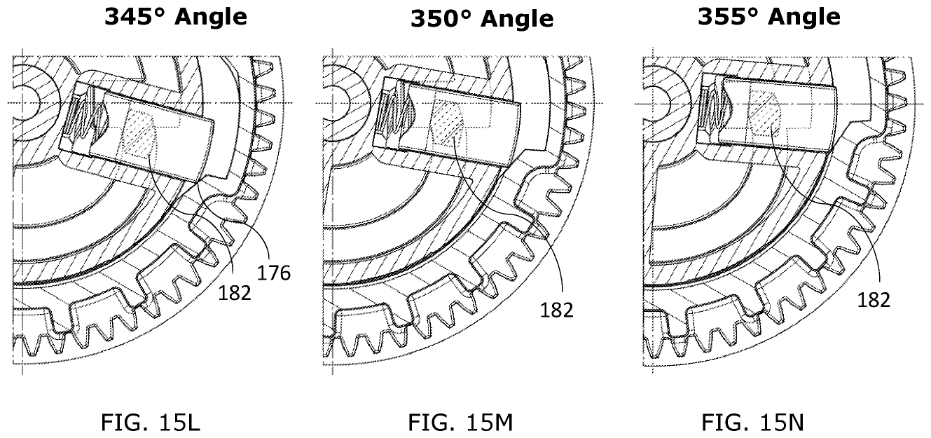

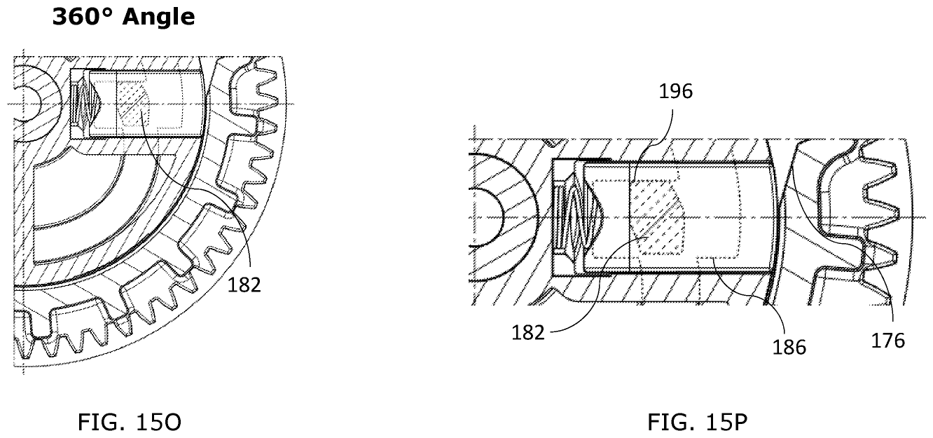

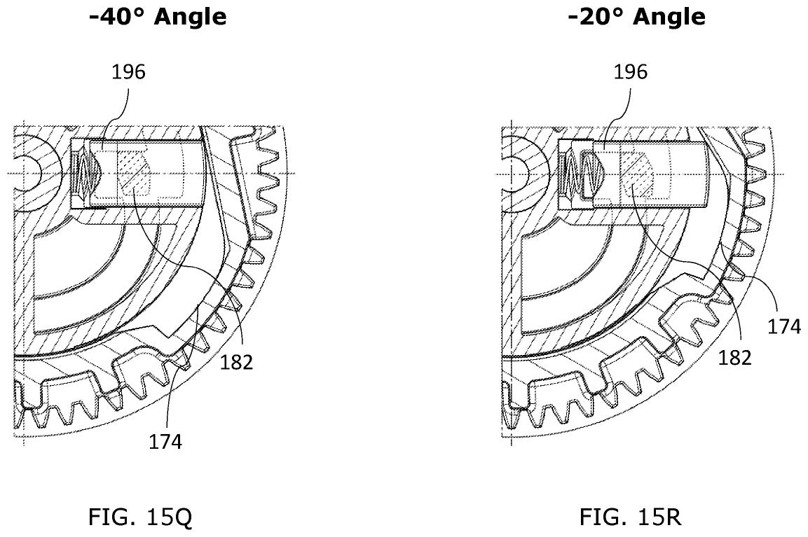

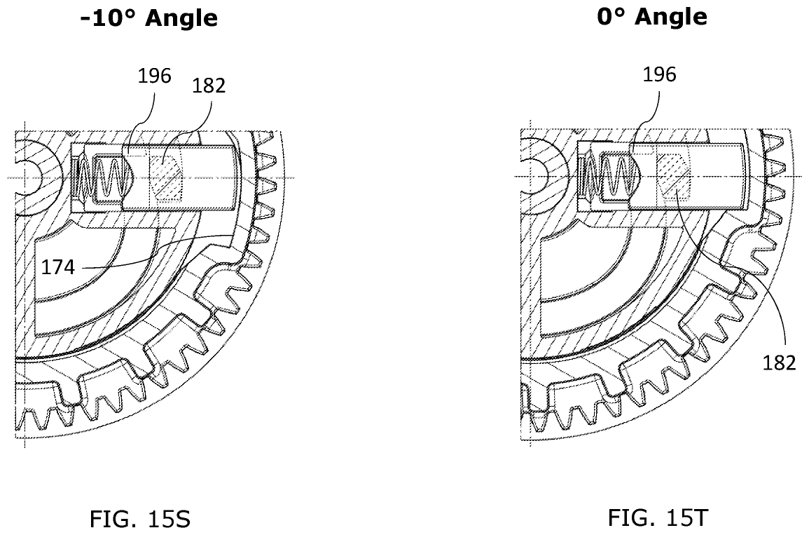

Turning now in FIGS. 15A-15T, the operation of the gear assembly 106 is illustrated.

In an exemplary embodiment, a user may actuate a remotely-located button, switch or icon located on a remote control, the dashboard or a touchscreen of a vehicle, by way of non-limiting example. Activating the remotely-located button, switch or icon causes activation of the motor 104. When motor 104 is activated for opening the latch 100, for example, the rotatable output shaft 148 is actuated to rotate about the shaft axis (FIG. 4C). The worm screw 122 fixed to the output shaft 148 is thereby actuated.

This motion may be transferred to one or more components of the gear assembly 106. In a non-limiting example, the teeth of 150 of the worm screw 122 is non-rotatably connected to, and meshes with, upper set 142 of teeth on the worm gear 126, such that the worm gear 126 rotates along with the worm screw 122. The wheel 138, which is coupled indirectly to the rotatable output shaft 148 of the motor 104 via the lower set 144 of teeth on the worm gear 126, is configured to move in response to motion of the worm screw 122 because the lower set 144 of teeth on the worm gear 126 meshes with teeth 146 of the wheel 138. However, it should be understood from the description herein that wheel 138 may alternatively be coupled directly to the worm screw 122 or output shaft 148 of the motor 104.

This arrangement of the one or more components of the latch 100 causes the wheel 138 to rotate around the wheel axis. In response to this motion of the wheel 138 caused by the activation of the motor 104, the drum 130 is also configured to rotate about the wheel axis because it is rotatably mounted to the wheel 138. The rotation of the drum 130 is sensed by micro-switch 124 based upon the interaction between the wiper arm 160 and curved portion 162 (FIG. 12C) of drum 130. Specifically, the motor 104 rotates the drum 130 by a single revolution and along a single direction (counter-clockwise or clockwise), as sensed and permitted by the switch 124. Once the wiper arm 160 of the switch 124 engages with the curved portion 162 of drum 130 and therefore detects one or more rotational positions of the drum 130, the switch consequently deactivates the supply of power to the motor 104.

However, the wheel 138 is allowed to continue rotate without causing rotation of the drum 130, thereby allowing inertial motion of the output shaft 148 of the motor 104 and thereby reducing or eliminating the effect of inertia of the motor 104 on the output of the gear assembly 106. As will be discussed in further detail below, the wheel 138 is allowed to rotate without causing rotation of the drum 130, based on the arrangement or interface of the locker 134 and its interactions with one or more components of the gear assembly 106, e.g. wheel 138 and drum 130.

As stated above, the locker 134 is mounted for movement relative to the drum 130. As shown, for example, in FIGS. 15A-15T, the locker 134 is configured to travel for an angular displacement in response to motion of the wheel 138. In particular, as illustrated in FIGS. 15A-15D, the radial distance of the annular surface 184, relative to the wheel axis or the center of the drum 130, is constant. Therefore, the radial distance of the locker 134 relative to the wheel axis or the center of the drum 130 is constant as the locker 134 moves within a range of angular displacement between 0° to 305°.

Movement of the locker 134 is illustrated in FIGS. 15A-15D by way of showing a cross-section of the leg portion 182 as it travels along the annular surface 184 of the housing 110a. Specifically, the leg portion 182 of the locker 134 is maintained at a constant leg radial distance relative to the wheel axis, or the center of the drum 130. More specifically, FIGS. 15A-15D show the leg portion 182 is at a constant leg radial distance relative to the wheel axis, or the center of the drum 130, when the locker 134 is moved (in response to motion of the drum 130) for an angular displacement of 0°, 30°, 255°, and 305°, respectively.

Referring now to FIGS. 15D-15P, the radial distance of the annular surface 184, relative to the wheel axis or the center of the drum 130, is not constant with respect to the radially displaced portion 186 of the annular surface 184 of the housing 110a. In this way, the radially displaced portion 186 of the annular surface 184 of the housing 110a is positioned, such that as the locker 134 moves within a range of angular displacement between 305° to 360°, the locker 134 is guided toward the locked position.

When the locker 134 is in the locked position, the leg portion 182 of the locker 134 is prevented by a stop surface 196 of the radially displaced portion 186 from moving in response to motion of the wheel 138. When the locker 134 is prevented from moving in response to motion of the wheel 138, the drum 130 is thereby prevented from moving and the wheel 138 is allowed to continue to rotate in response to the inertial motion of the motor 104, without causing the drum 130 to rotate. This thereby reduces or eliminates the effect of inertia of the motor 104 on an output of the gear assembly 106.

In an exemplary embodiment, as shown in FIGS. 15D-15I, the locker 134 moves against the biasing operation of the biasing means 136 and moves within a range of angular displacement between 305° to 330°. One or more of the leg portion 182 and the body 192 of the locker 134 is thereby caused to move along a radial displacement direction and for a distance. The distance may be a range between 0 mm to 0.9 mm in one embodiment, for example. The radial displacement direction is relative to the sidewall 174 of the wheel 138, as shown in FIG. 15D.

In particular, as illustrated in FIG. 15E, the body 192 is radially displaced for 0.1 mm relative to sidewall 174 of the wheel 138, when angular displacement is 310°. As illustrated in FIG. 15F, the body 192 is radially displaced for 0.25 mm relative to sidewall 174 of the wheel 138, when angular displacement is 315°. As illustrated in FIG. 15G, the body 192 is radially displaced for 0.4 mm relative to sidewall 174 of the wheel 138, when angular displacement is 320°. As illustrated in FIG. 15H, the body 192 is radially displaced for 0.6 mm relative to sidewall 174 of the wheel 138, when angular displacement is 325°. As illustrated in FIG. 151, the body 192 is radially displaced for 0.9 mm relative to sidewall 174 of the wheel 138, when angular displacement is 330°.

As shown in FIGS. 15J-15K, the locker 134 moves against the biasing operation of the biasing means 136 and moves within a range of angular displacement between 335° to 340°. One or more of the leg portion 182 and the body 192 of the locker 134 is thereby caused to move along the radial displacement direction (shown in FIG. 15D) and for a distance. The distance may be a range between 1.2 mm to 1.5 mm.

As illustrated in FIG. 15J, showing a detailed portion of the leg portion 182 and a portion of the wheel 138, the body 192 is radially displaced for 1.2 mm relative to sidewall 174 of the wheel 138, when angular displacement is 335°. As illustrated in FIG. 15K, showing a detailed portion of the leg portion 182 and a portion of the wheel 138, the body 192 is radially displaced for 1.5 mm relative to sidewall 174 of the wheel 138, when angular displacement is 340°.

Still further, as shown in FIGS. 15J-15L, as the locker moves within a range of angular displacement between 335° to 345°, the locker is guided away from the side wall 174 of the wheel 138 and towards the angled surface 176 (FIG. 151) of the wheel 138. In this way, the angled surface 176 of the wheel 138 moves the locker 134 against the biasing means 136 and toward the locked position, in which the locker 134 restricts the ability of the drum 130 to rotate about the wheel axis in response to rotation of the wheel 138.

As shown in FIGS. 15L-15P, the locker 134 moves against the biasing operation of the biasing means 136 and moves within a range of angular displacement between 345° to 360°. One or more of the leg portion 182 and the body 192 of the locker 134 is thereby caused to move along the radial displacement direction (shown in FIG. 15D) and for a distance. The distance may be a range between 1.9 mm to 3 mm. As illustrated in FIG. 15L, the body 192 is radially displaced for 1.9 mm relative to sidewall 174 of the wheel 138, when angular displacement is 345°. As illustrated in FIG. 15M, the body 192 is radially displaced for 2.35 mm relative to sidewall 174 of the wheel 138, when angular displacement is 350°. As illustrated in FIG. 15N, the body 192 is radially displaced for 2.75 mm relative to sidewall 174 of the wheel 138, when angular displacement is 355°. As illustrated in FIG. 150, the body 192 is radially displaced for 3 mm relative to sidewall 174 of the wheel 138, when angular displacement is 360°.

FIG. 15P is a detailed view of a portion of the gear assembly 106 illustrated in FIG. 150, showing that the angled surface 176 moves the locker 134 toward the locked position, such that at least the leg portion 182 of the locker 134 moves within radially displaced portion 186 of the annular surface 184 and toward the stop surface 196. When the leg portion 182 is radially displaced such that it is adjacent the stop surface 196, the locker 134 is in the locked position, in which the locker 134 restricts the ability of the drum 130 to rotate about the wheel axis in response to rotation of the wheel 138. Still further, when both the locker 134 and the drum 130 are prevented from moving in response to motion of the wheel 138, the wheel 138 continues to move in response to motion of the motor 104, thereby allowing inertial motion of the output shaft 148 of the motor 104, and thereby reducing or eliminating the effect of inertia of the motor 104 on the output of the gear assembly 106.

Then, as shown in FIGS. 15Q-15T, after the wheel 138 is prevented from moving in response to immobility of the output shaft 148 or the inactivation of the motor 104, and when the motor 104 is subsequently activated for a new use cycle, the locker 134 is configured to move back toward the unlocked position, in which the locker 134 does not restrict the ability of the drum 130 to rotate about the wheel axis in response to rotation of the wheel 138. Thus, when rotation of wheel 138 stops, in response to immobility of the output shaft 148 or the inactivation of the motor 104, the locker 134 is retained in the locked position, and when the motor 104 is subsequently actuated to begin a new use cycle, the wheel 138 rotates in response to the activation of the motor 104 and the locker 134 is moved toward the unlocked position in response to movement of the wheel 138. Radial displacement of the locker 134 toward the unlocked position comprises radial displacement of at least the leg portion 182 of the locker 134 within the radially disposed portion 186 of the annular surface 184 and toward the side wall 174 of the wheel 138.

As shown in FIG. 15Q, the body 192 of the locker 134 is at a distance of 3 mm relative to the side wall 174 of the wheel 138, when the angular displacement is −40°. As shown in FIG. 15R, the body 192 of the locker 134 moves toward the side wall 174 and reaches a distance of 1.5 mm relative to the side wall 174, when the angular displacement is −20°. As shown in FIGS. 15S and 15T, the body 192 of the locker 134 moves toward the side wall 174 until the body 192 of the locker 134 reaches a distance of 0 mm relative to the side wall 174, when the angular displacement is between −10° and 0°, at which point the locker 134 is in the starting position or the unlocked position.

It should be understood that the above description of operating the gear assembly 106 is not limited to any step or sequence of steps, and may vary from that which is shown and described without departing from the scope and spirit of the invention.

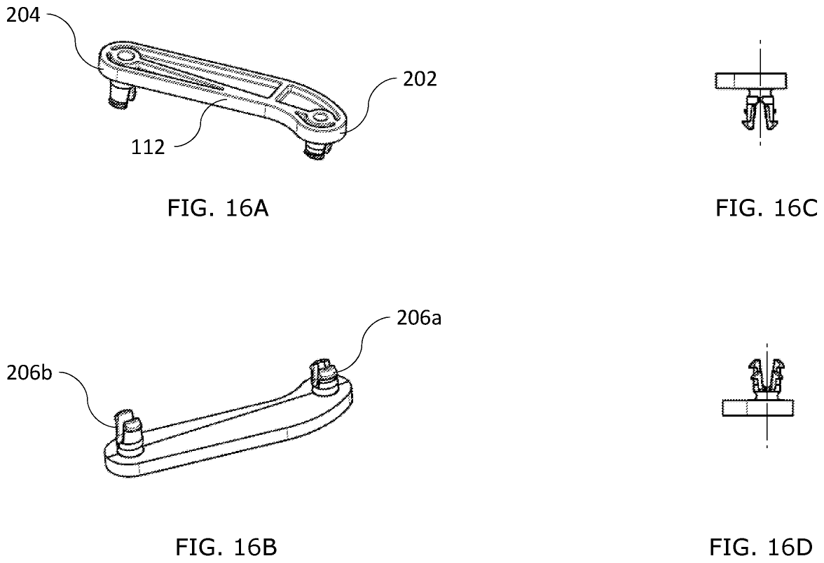

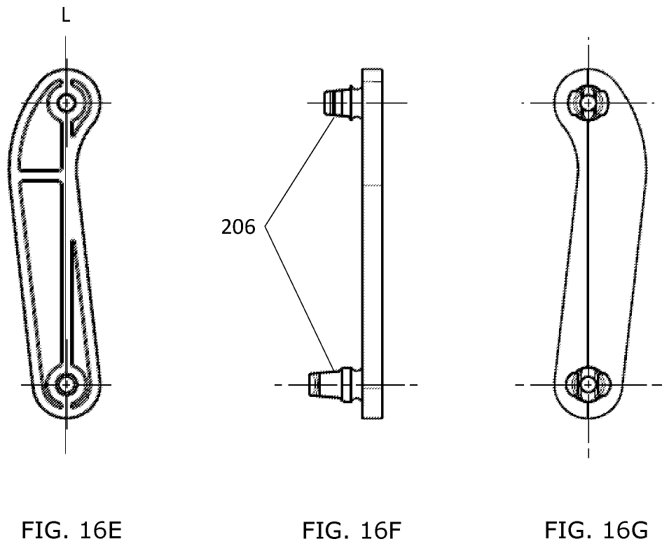

Turning now to a discussion of the other components of latch 100 and with reference FIG. 3A, a lever 112 is coupled to the drum 130 and configured to move in response to motion of the drum 130. FIGS. 16A-16G depict the lever 112. The lever 112 is an elongated body having a length “L” between a top end 202 and a bottom end 204. Each of top end 202 and bottom end 204 includes a U-shaped curved surface 206. Surface 206a of top end 202 and surface 206b of bottom end 204 are configured to 25 provide a mechanical connection between at least one component of the gear assembly 106 and one or more components of latch 100, such as at least one component of the dissociation assembly 224 (discussed further below). In particular, as shown in FIG. 3A, surface 206a of top end 202 is configured to be coupled to a portion of a driver 114 and surface 206b of bottom end 204 is configured to be received by opening 208 defined by the drum 130. In this way, the lever 112 moves in response to an output of the gear assembly 106, particularly the motion of drum 130, resulting in movement of the at least one rack or pawl 128.

In an exemplary embodiment, latch 100 includes the gear assembly 106 to facilitate the motorized opening (unlatched state) of the latch 100 and the dissociation assembly 224 to facilitate the motorized opening and the manual closing (latched state) of the latch 100.

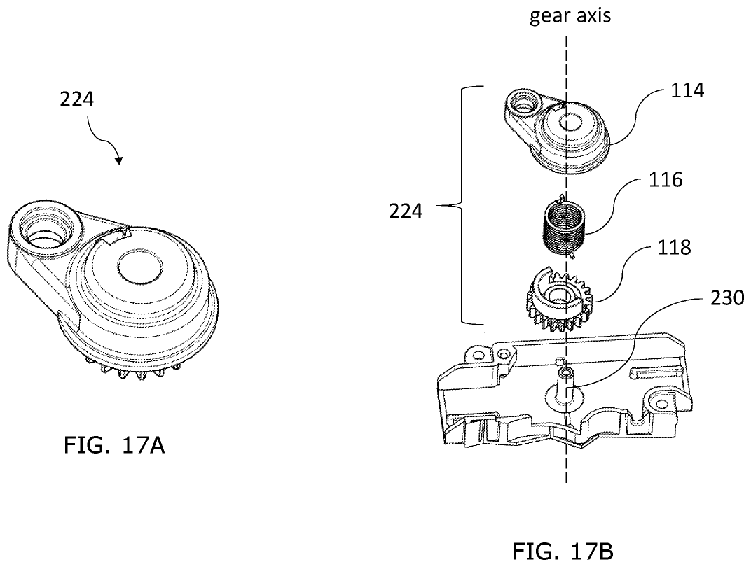

Referring to FIGS. 17A-17B, dissociation assembly 224 generally comprises the driver 114, the torsion spring 116, and the gear 118. In an exemplary embodiment, the gear 118 is rotatably mounted to the housing 110 by a shaft 230 extending upward from the housing 110. Further, the gear 118 is mounted for movement relative to the at least one pawl 128 and configured to move about a gear axis. Driver 114 is rotatably mounted to the gear 118 and configured to rotate about the gear axis in response to movement of lever 112, as will be discussed below.

Coupled to the lever 112, the exemplary dissociation assembly 224 is configured to facilitate the motor-driven opening of the at least one pawl 128, such that motion of the lever 112 in response to motion of the drum 130 causes the driver 114 to move, thereby causing the at least one pawl 128 to move toward an unlocked position. When the at least one pawl 128 is the unlocked position, the latch 100 is in the unlatched state.

Additionally or optionally, the dissociation assembly 224 is further configured to facilitate manual actuation of the at least one pawl 128, such that the at least one pawl 128 is manually moved toward a locked position. When the at least one pawl 128 is in the locked position, the latch 100 is in the latched state. Additional details regarding the operation and the components of the dissociation assembly 224 are discussed below.

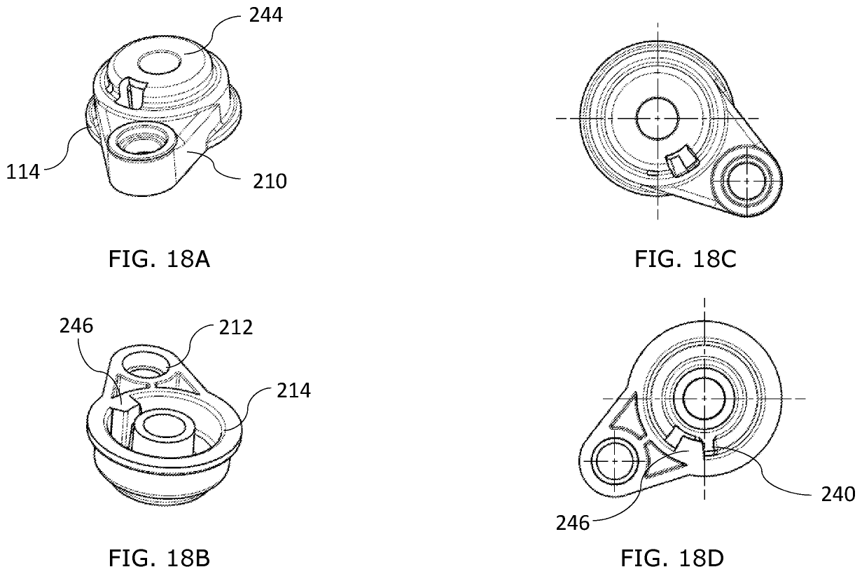

FIGS. 18A-18D depict the driver 114. In a non-limiting example, driver 114 is configured to be connected to the lever 112, such that motion of the lever 112 in response to motion of the drum 130 causes the driver 114 to move, thereby causing the at least one pawl 128 to move between the unlocked position and the locked position. The driver 114 has a circular body 244 and a protrusion 210. Protrusion 210 defines an aperture 212 configured to receive surface 206a of the lever 112 for coupling driver 114 to the lever 112.

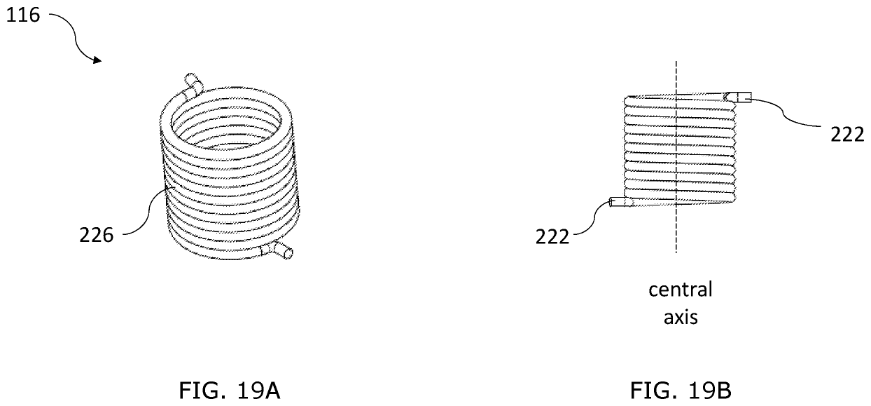

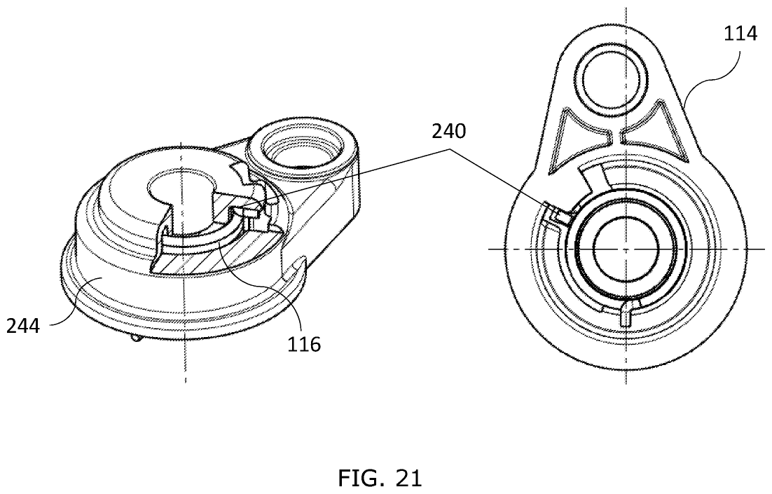

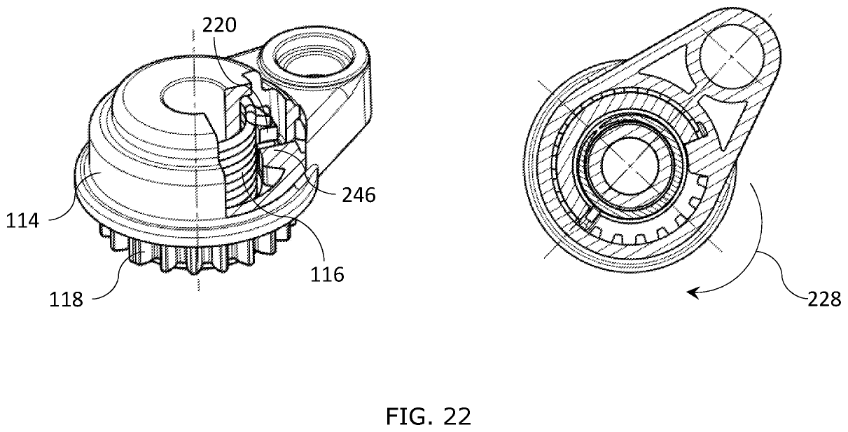

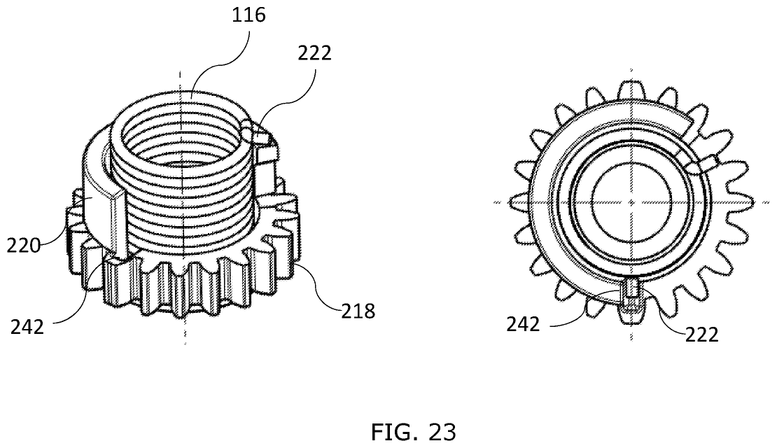

FIGS. 19A and 19B depict the torsion spring 116. The torsion spring 116 includes a coiled body 226 having two free ends 222. The free ends 222 extend in opposite directions along separate axes that are each oriented perpendicular to a central axis of the coiled body 226. One free end 222 of spring 116 is held by slot 240 defined by driver 114 (FIG. 21) and another end 222 of spring 116 is held by slot 242 defined by gear 118 (FIG. 23).

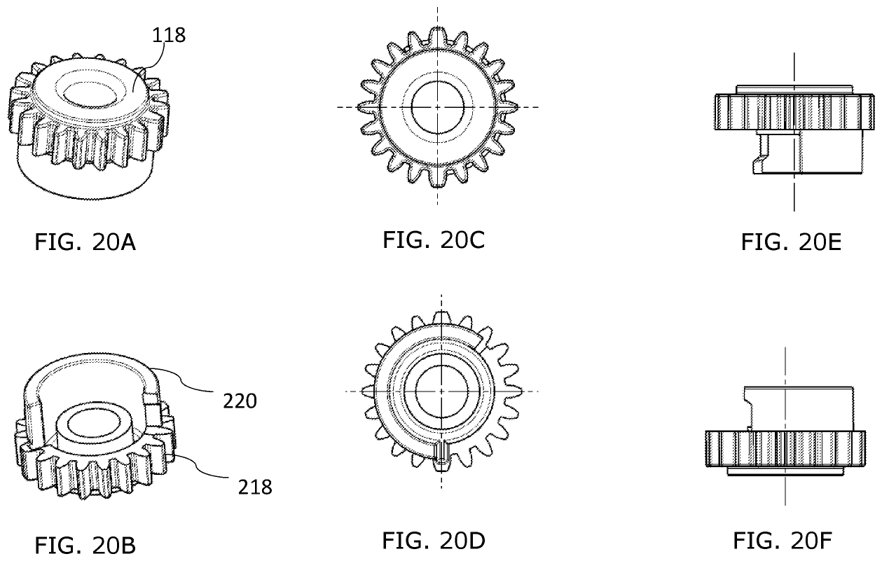

As best shown in FIGS. 18B and 21, the body 244 of driver 114 defines an annular recess 214 configured to receive at least the coiled body 226 of the spring 116. Similarly, as best shown in FIGS. 20B and 23, the coiled body 226 is positionable adjacent a radial surface 220, which extends upward from set of gear teeth 218 and extends along for a portion of a circumferential length of gear 118 (discussed further below). Thus, in an assembled example of dissociation assembly 224, the driver 114 and gear 118 together define an interior configured to completely enclose spring 116.

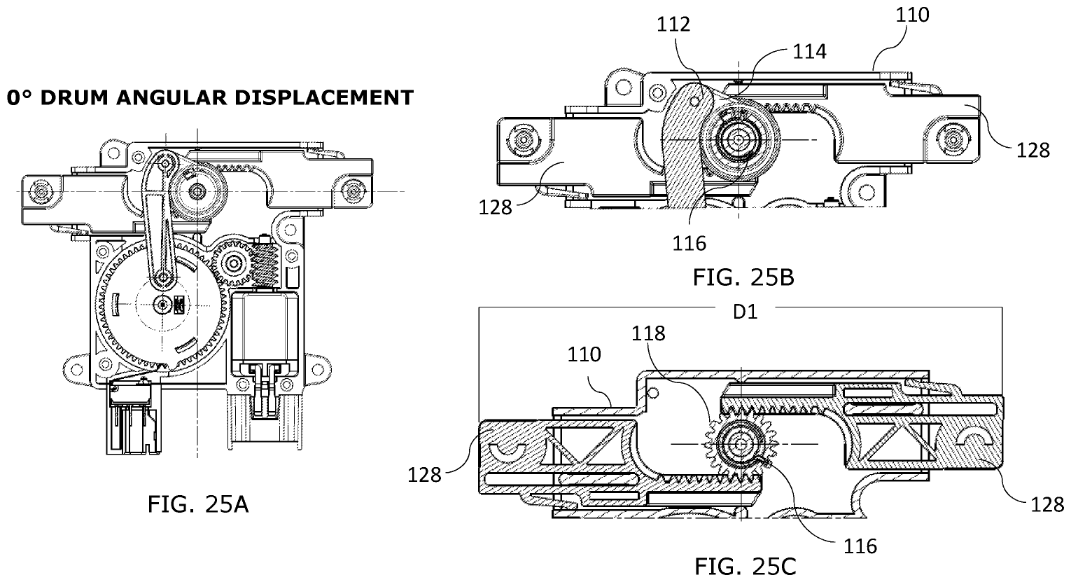

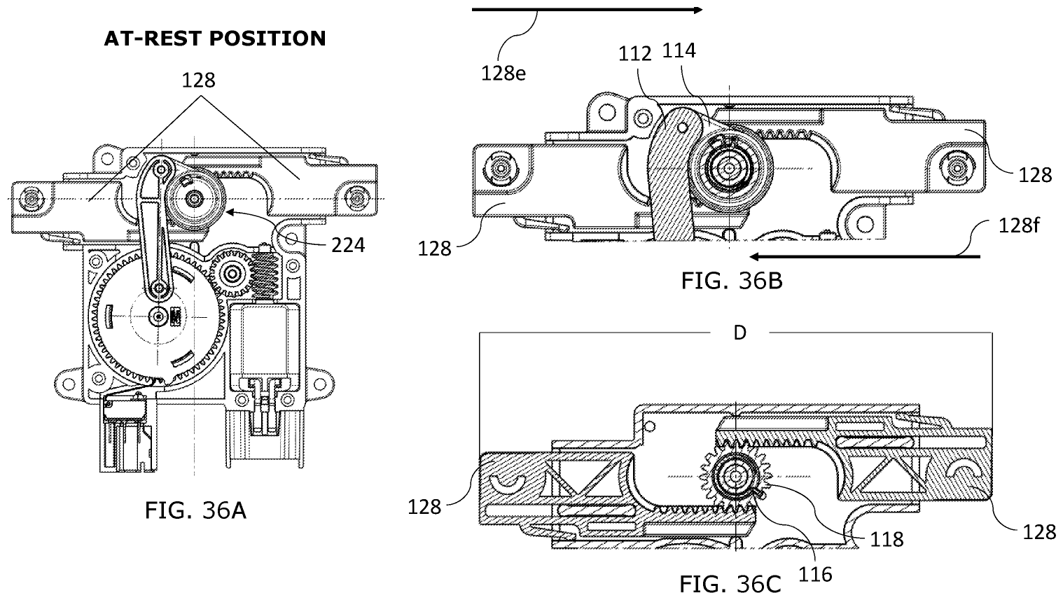

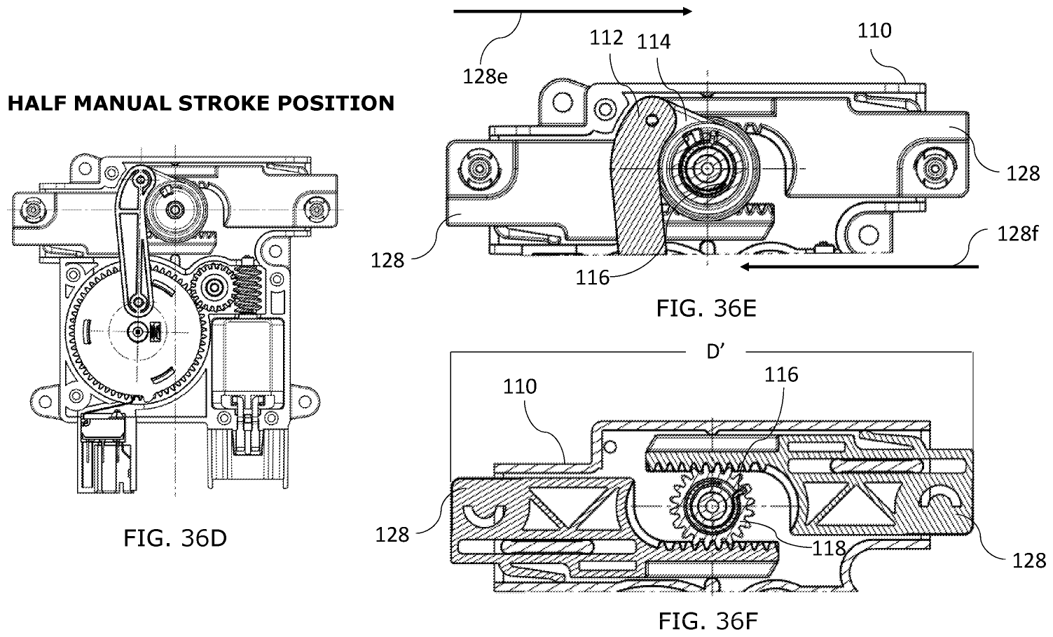

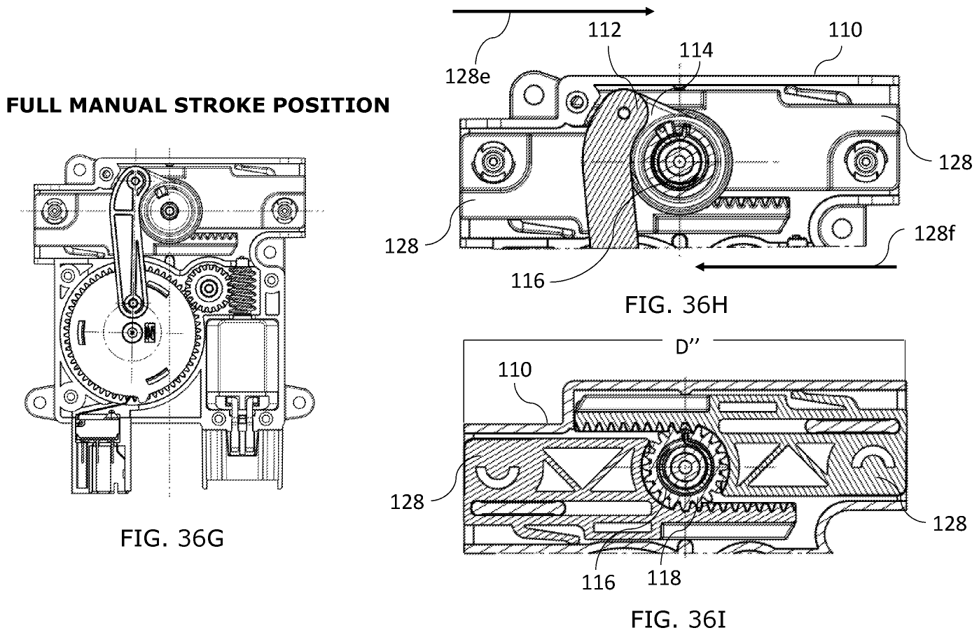

FIGS. 20A-20F depict the gear 118. Gear 118 has a generally circular body with a set of gear teeth 218 extending along its outer perimeter. As stated above and as shown in FIG. 20B, a radial surface 220 extending upward from set of gear teeth 218 and extends along for a portion of a circumferential length of gear 118. Radial surface 220 is configured to be received within annular recess 214 of driver 114. As shown in FIG. 22, the spring 116 is configured for retaining gear 118 in a home, or rest, position (FIGS. 25A-25C and 36A-36C). In particular, the spring 116 exerts a biasing force to maintain “wall-to-wall” contact between at least radial surface 220 of the gear 118 and stop surface 246 of driver 114.

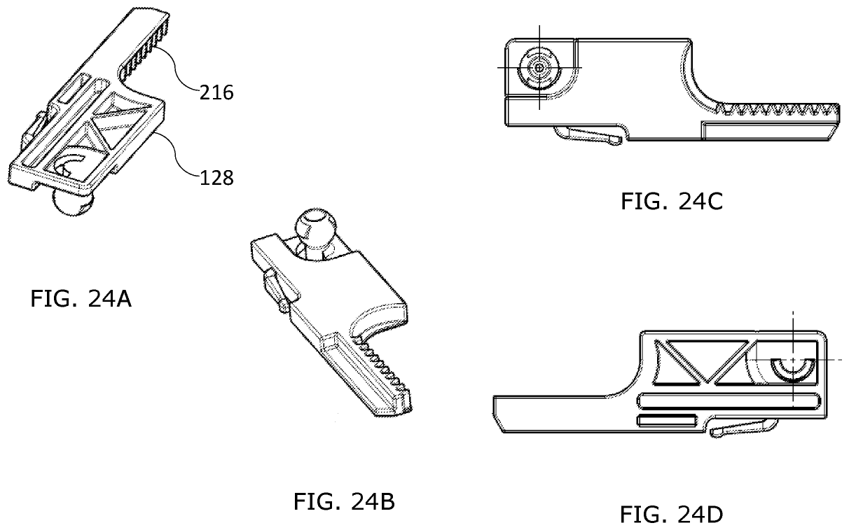

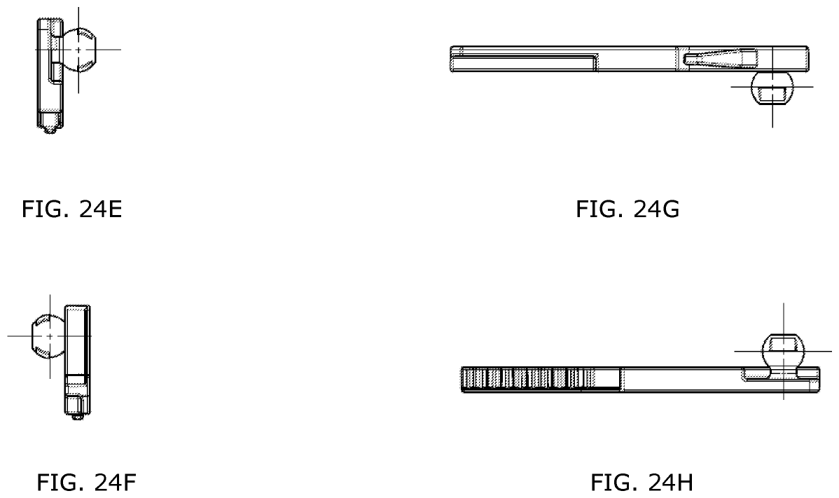

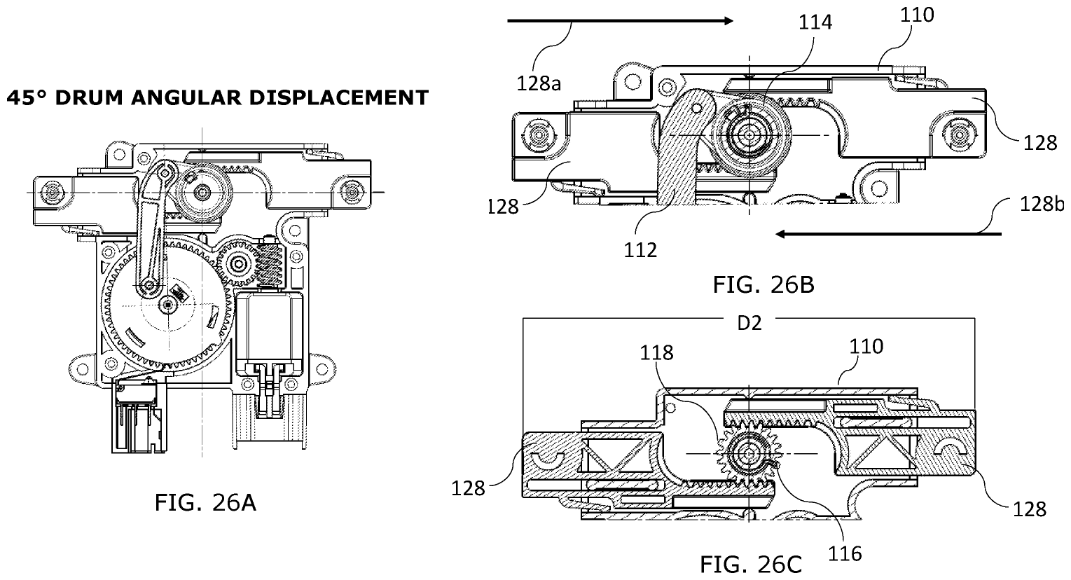

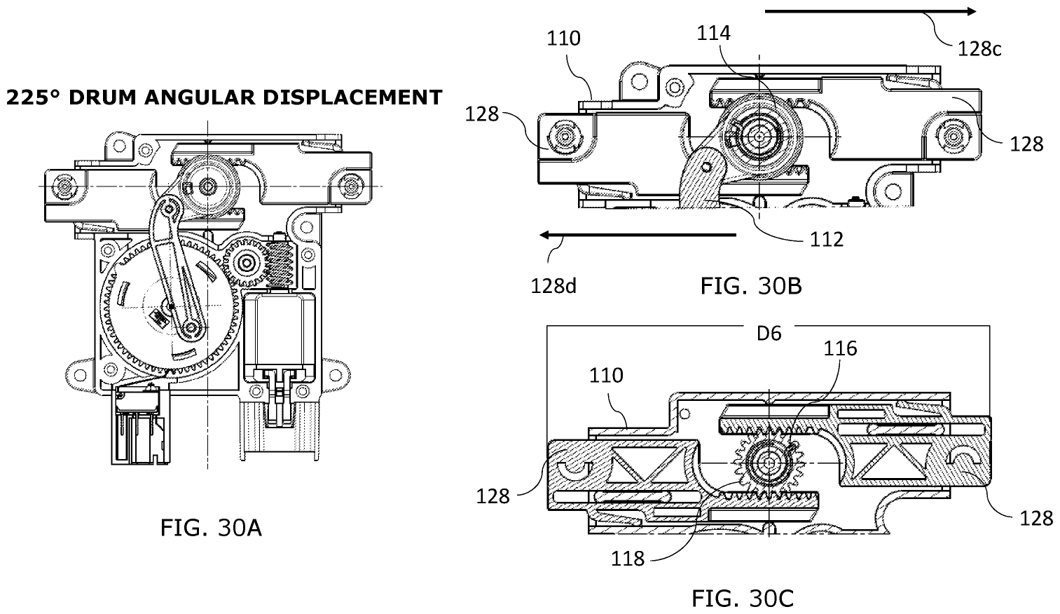

FIGS. 24A-24H depict the pawl 128. The pawl 128 is movable between the locked position and the unlocked position. Specifically, the pawl 128 is capable of laterally translating from side to side, as depicted by the arrows (128a, 128b, 128c, 128d) in FIGS. 26B and 30B, for example. The pawls 128 move synchronously with each other and in an opposite translational direction thereto because the pawls 128 are interconnected together by the dissociation assembly 224 (as shown in FIG. 25A, for example).

One pawl 128 comprises a set of gear teeth 216 and another pawl 128 comprises another set of gear teeth 216, wherein the set of gear teeth 216 and the another set of gear teeth 216 are opposite of each other when the latch 100 is assembled (as shown in FIG. 3A). Still further, in an assembled form of the latch 100, the teeth 218 on the gear 118 are meshed with both sets of gear teeth 216, such that movement of the gear 118 causes simultaneous translation of the pawls 128 between the locked and unlocked positions.

When the pawl 128 is in the unlocked position, the latch 100 is in the unlatched state. When the pawl 128 is in the locked position, the latch 100 is in the latched state. In an exemplary embodiment, when the pawl 128 is in the unlocked position, the pawl 128 is in a withdrawn or retracted position relative to housing 110 and is positioned to not interact with strikers (not shown) in the door housing, such that the latch 100 is in the unlatched state and the door is in an open state. Conversely, when the pawl 128 is in the locked position, the pawl 128 is in an extended position relative to housing 110 and is positioned to interact with strikers (not shown) in the door housing, such that the latch 100 is in the latched state and the door is in a closed state.

However, one of ordinary skill in the art would understand that the above relationship between the extended or withdrawn position of the at least one pawl and the unlatched or latched state of the latch is not so limited, such that the opposite configuration (e.g. when the at least one pawl 128 is in an extended position, the latch 100 is in the unlatched state and when the at least one pawl 128 is in a withdrawn position, the latch 100 is in the latched state) remains within the scope and spirit of the invention.

The operation of the dissociation assembly 224, with reference to the latch 100 and components thereof, will now be discussed below.

As stated above, the dissociation assembly 224 may be configured to facilitate the motor-driven opening of the at least one pawl 128, such that motion of the lever 112 in response to motion of the drum 130 causes the driver 114 to move, thereby causing the at least one pawl 128 (discussed further below) to move toward an unlocked position. To this end, the at least one pawl 128 is connected to the dissociation assembly 224, which may be configured to move in response to motion of the lever 112. Accordingly, movement of the driver 114 in response to motion of the lever 112 results in movement of the gear 118, thereby causing simultaneous movement of the at least one pawl 128 from the locked position toward the unlocked position. In other words, movement of the driver 114 in response to motion of the lever 112 results in movement of the gear 118.

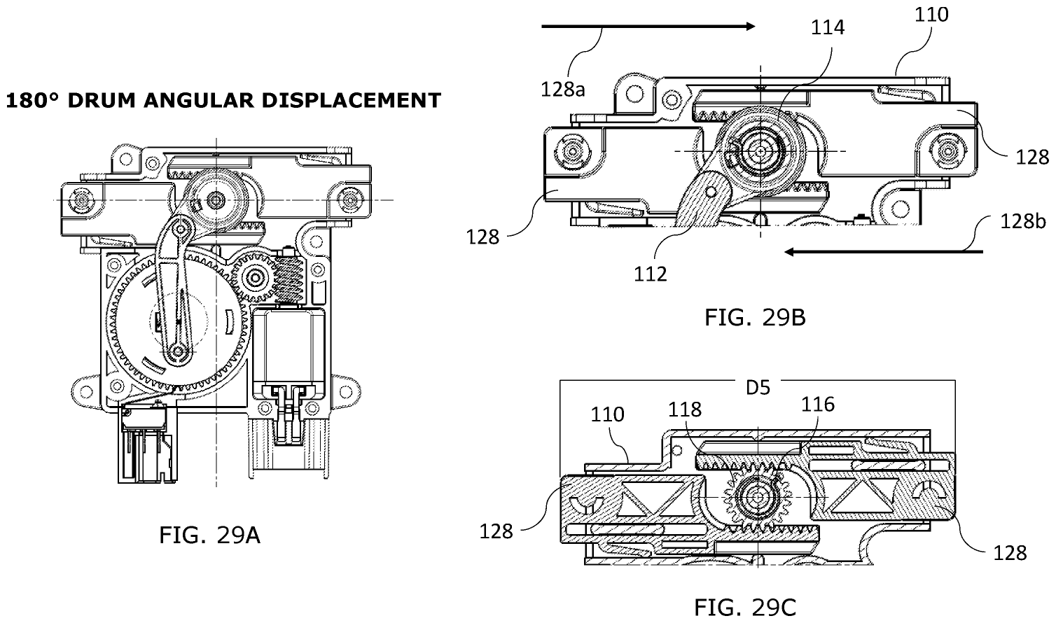

At a particular angular displacement of the drum 130 (discussed below with reference to FIGS. 25A-25C, 26A-26C, 27A-27C, 28A-28C, and 29A-29C), movement of the lever 112 causes the at least one pawl 128 to move toward the withdrawn or retracted position relative to the housing 110 or enclosure 102. The at least one pawl 128 is withdrawn or retracted until the at least one pawl 128 reaches the unlocked position, at which point the latch 100 is in the unlatched state and a door, such as a glove box door, can be opened. In particular, the latch 100 is in the unlatched state when the angular displacement of the drum reaches 180° (as illustrated in FIGS. 29A-29C) because at this degree of angular displacement, the at least one pawl 128 is configured to be disengaged from the strikers (not shown) and another component, such as a bumper in the glove box, for example, pushes the door or lid open.

While the latch 100 is still in this unlatched state, continued angular displacement of the drum 130 from 180° until 360° (discussed below with reference to FIGS. 30A-30C, 31A-31C, 32A-32C, 33A-33C, 34A-34C, and 35A-35C) causes the at least one pawl 128 to return to the locked position, which places them in a “reset” condition in preparation for another use cycle of latch 100, such as for moving the latch 100 back to the latched state from the unlatched state.

Movement of the latch 100 toward the latched state (discussed below with reference to FIGS. 36A-36I) is achieved by manual actuation of the at least one pawl 128 toward a withdrawn or retracted position relative to the housing 110 until they are back in a position to engage with the strikers (not shown) and subsequently, the biasing force of torsion spring 116 moves the at least one pawl 128 back toward the locked position. When the at least one pawl 128 is in the locked position, the latch 100 is thus in the latched state.

Various latch designs may require the motor to have sufficient power to overcome the biasing force of the torsion spring 116. However, this arrangement of the exemplary dissociation assembly 224, with reference to latch 100 and its components, allows for a motor-driven assembly, such as gear assembly 106, to move latch 100 to the unlatched state, by desirably requiring less power (e.g. less powerful or cheaper motor 104). This is achieved because as the driver 114 moves in response to lever 112, the driver 114 causes the gear 118 to rotate via the “wall to wall” contact between the radial surface 220 of the gear 118 and the stop surface 246 of driver 114. This “wall to wall” contact causes the gear 118 to move in response to motion of the driver 114, thereby resulting in no relative movement between the gear 118 and the driver 114. Since the gear 118 does not move relative to the driver 114, then spring 116 also does not move since as discussed above, spring 116 is enclosed within an interior collectively defined by the driver 114 and gear 118. Thus, movement of gear 118 in response to motion of driver 114 is desirably achieved without compression of spring 116.

Turning now to FIGS. 25A-25C, 26A-26C, 27A-27C, 28A-28C, 29A-29C, 30A-30C, 31A-31C, 32A-32C, 33A-33C, 34A-34C, and 35A-35C, these figures depict movement of components of the dissociation assembly 224, in response to an output, e.g. motion, of the gear assembly 106. As stated above, the dissociation assembly 224 may be configured to facilitate the motor-driven opening of the at least one pawl 128, such that motion of the lever 112 in response to motion of the drum 130 causes the driver 114 to move, thereby moving the at least one pawl 128 to move toward an unlocked position and therefore moving latch 100 toward the unlatched state.

As stated above, the drum 130 is configured to travel for an angular displacement in response to motion of the wheel 138. As shown in FIGS. 25A-25C, the driver 114 is immobilized in a locked or rest position, as determined by the arrangement of the lever 112, which is connected to gear assembly 106, when the motor 104 is inactive (and therefore provides no output from the gear assembly 106). Further, an end portion of one of the at least one pawl 128 and another end portion of the another of the at least one pawl 128 are in an extended position relative to housing 110 for a distance (D1).

As shown in FIGS. 26A-26C, the drum 130 is depicted as traveling an angular displacement of 45° in a single direction, e.g., counter-clockwise direction. In response to the motion and angular displacement of the drum 130, the lever 112 moves and therefore causes driver 114 and gear 118 to move. Specifically, the teeth 218 on the gear 118 are meshed with both sets of gear teeth 216 of the at least one pawl 128, such that movement of the gear 118 causes simultaneous translation of the at least one pawl 128. The at least one pawl 128 simultaneously moves until an end portion of one of the at least one pawl 128 and another end portion of another of the at least one pawl 128 are in a first withdrawn position relative to the rest position shown in FIG. 25C, for example, for a distance (D2). Specifically, the at least one pawl 128 laterally translates in a direction depicted by the arrows (128a, 128b) in FIG. 26B, for example.

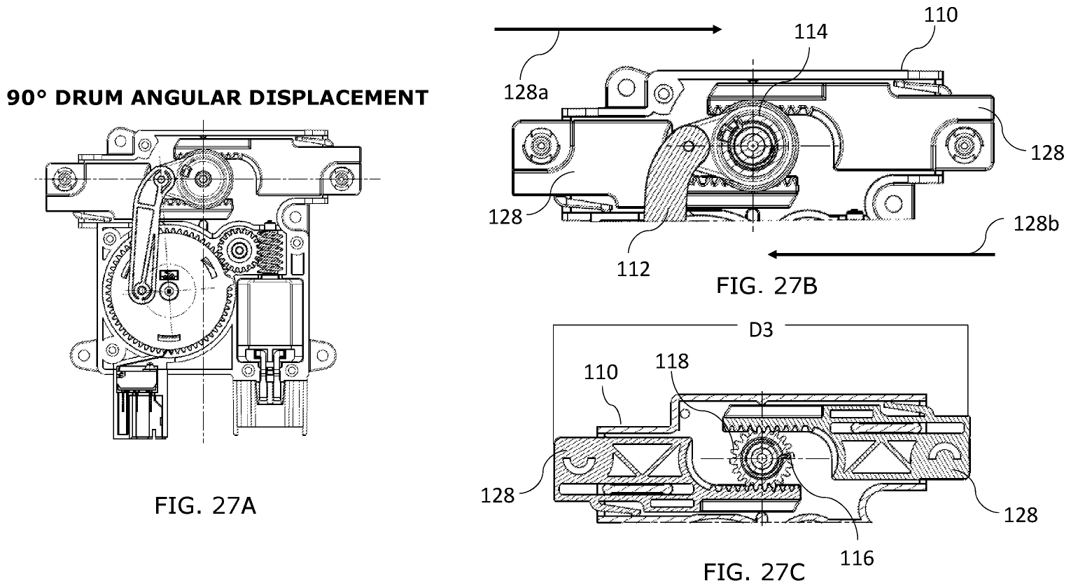

As illustrated in FIGS. 27A-27C, the drum 130 is depicted as traveling an angular displacement 90° in a single direction, e.g., counter-clockwise direction. Similar to the operation described above, the lever 112 moves in response to the angular displacement of the drum 130, and therefore causes driver 114 and gear 118 to move. The teeth 218 on the gear 118 are meshed with both sets of gear teeth 216 of the at least one pawl 128, such that the at least one pawl 128 simultaneously moves until an end portion of one of the at least one pawl 128 and another end portion of another of the at least one pawl 128 are in a second withdrawn position relative to the rest position shown in FIG. 25C, for example, for a distance (D3). Specifically, the at least one pawl 128 laterally translates in a direction depicted by the arrows (128a, 128b) in FIG. 27B, for example.

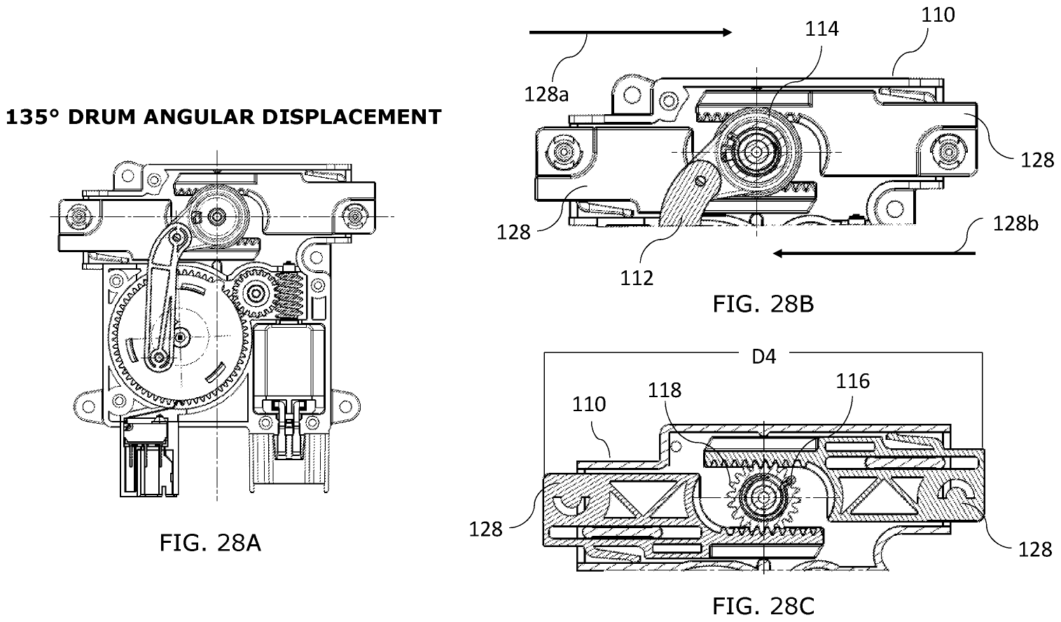

As illustrated in FIGS. 28A-28C, the drum 130 is depicted as traveling an angular displacement 135° in a single direction, e.g., counter-clockwise direction. Similar to the operation described above, the lever 112 moves in response to the angular displacement of the drum 130, and therefore causes driver 114 and gear 118 to move. The teeth 218 on the gear 118 are meshed with both sets of gear teeth 216 of the at least one pawl 128, such that the pawls 128 simultaneously move until an end portion of one of the pawls 128 and another end portion of another of the pawls 128 are in a third withdrawn position relative to the rest position shown in FIG. 25C, for example, for a distance (D4). Specifically, the at least one pawl 128 laterally translates in a direction depicted by the arrows (128a, 128b) in FIG. 28B, for example.

As illustrated in FIGS. 29A-29C, the drum 130 is depicted as traveling an angular displacement 180° a single direction, e.g., counter-clockwise direction. Similar to the operation described above, the lever 112 moves in response to the angular displacement of the drum 130, and therefore causes driver 114 and gear 118 to move. The teeth 218 on the gear 118 are meshed with both sets of gear teeth 216 of the at least one pawl 128, such that the pawls 128 simultaneously move until an end portion of one of the pawls 128 and another end portion of another of the pawls 128 are in a fourth withdrawn position relative to the rest position shown in FIG. 25C, for example, for a distance (D5). Specifically, the at least one pawl 128 laterally translates in a direction depicted by the arrows (128a, 128b) in FIG. 29B, for example. At this degree of angular displacement, e.g. 180°, the at least one pawl 128 is in the fully withdrawn or retracted position, e.g. the unlocked position, such that the at least one pawl 128 is configured to be disengaged from the strikers. When the at least one pawl 128 is disengaged from the strikers, the latch 100 is thus in the unlatched state and a door, such as a glove box door, can be opened.

As illustrated in FIGS. 30A-30C, while the latch is still in the unlatched state, the drum 130 is depicted as traveling an angular displacement 225° in a single direction, e.g., counter-clockwise direction. Similar to the operation described above, the lever 112 moves in response to the angular displacement of the drum 130, and therefore causes driver 114 and gear 118 to move. However, when the drum 130 has traveled an angular displacement of at least 180° and/or while the latch 100 is in the unlatched state, the at least one pawl 128 begin to move or return to the rest or locked position. In particular, the movement of the at least one pawl 128 to the locked position while the latch 100 is in the unlatched state desirably places them in a “reset” condition in preparation for another use cycle of latch 100, such as for moving the latch 100 back to the latched state from the unlatched state. The teeth 218 on the gear 118 are meshed with both sets of gear teeth 216 of the at least one pawl 128, such that the pawls 128 simultaneously move until an end portion of one of the pawls 128 and another end portion of another of the pawls 128 are in a first extended position relative to the fourth withdrawn position shown in FIG. 29C, for example, for a distance (D6). Specifically, the at least one pawl 128 laterally translates in a direction depicted by the arrows (128c, 128d) in FIG. 30B, for example.

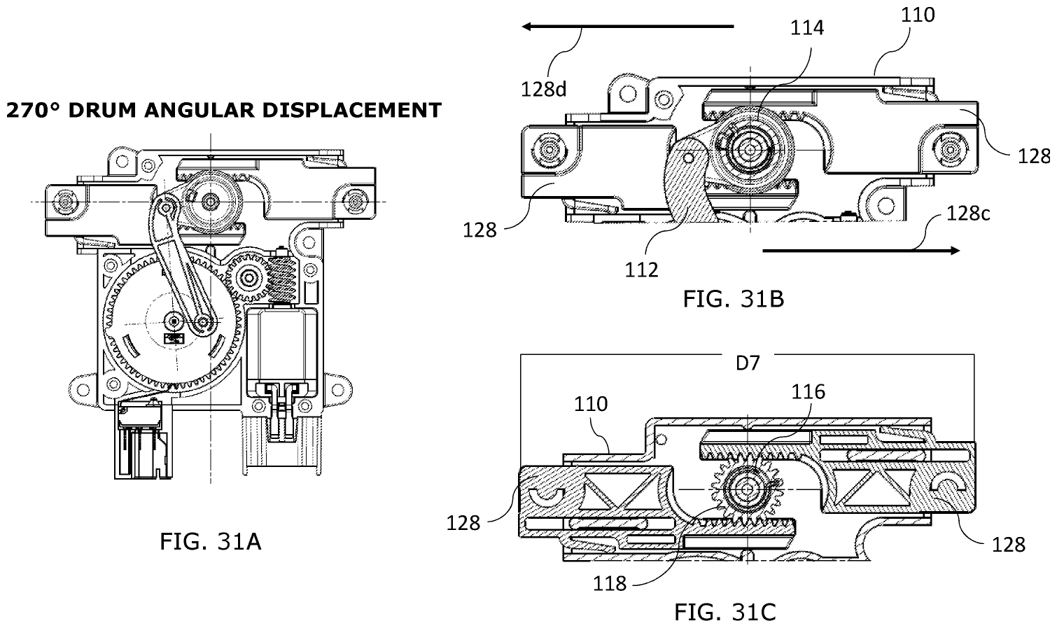

As illustrated in FIGS. 31A-31C, the drum 130 is depicted as traveling an angular displacement 270° in a single direction, e.g., counter-clockwise direction. Similar to the operation described above, the lever 112 moves in response to the angular displacement of the drum 130, and therefore causes driver 114 and gear 118 to move. The teeth 218 on the gear 118 are meshed with both sets of gear teeth 216 of the at least one pawl 128, such that the pawls 128 simultaneously move until an end portion of one of the pawls 128 and another end portion of another of the pawls 128 are in a second extended position relative to the fourth withdrawn position shown in FIG. 29C, for example, for a distance (D7). Specifically, the at least one pawl 128 laterally translates in a direction depicted by the arrows (128c, 128d) in FIG. 31B, for example.

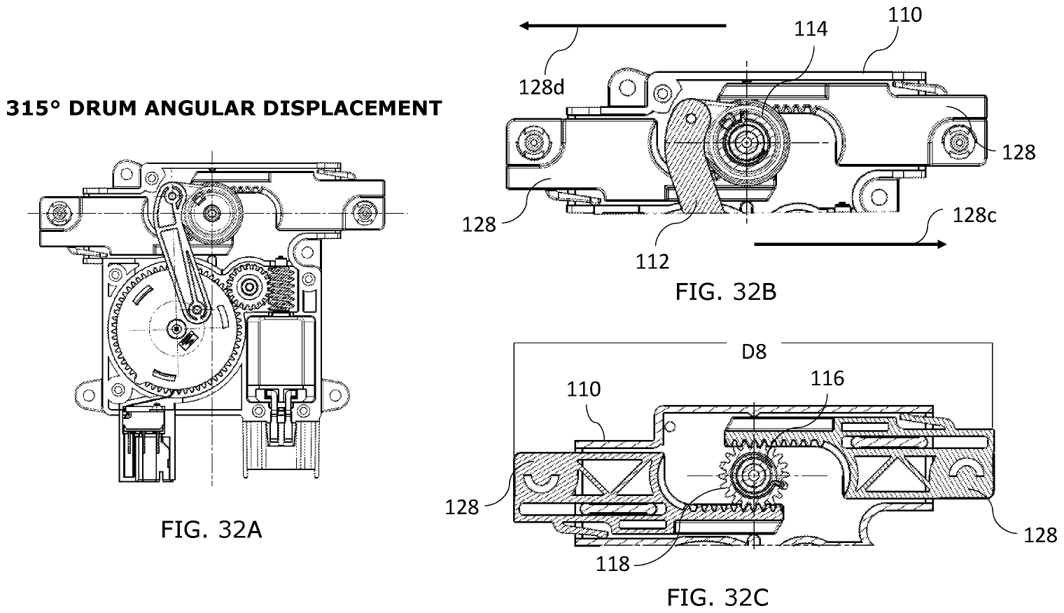

As illustrated in FIGS. 32A-32C, the drum 130 is depicted as traveling an angular displacement 315° a single direction, e.g., counter-clockwise direction. Similar to the operation described above, the lever 112 moves in response to the angular displacement of the drum 130, and therefore causes driver 114 and gear 118 to move. The teeth 218 on the gear 118 are meshed with both sets of gear teeth 216 of the at least one pawl 128, such that the pawls 128 simultaneously move until an end portion of one of the pawls 128 and another end portion of another of the pawls 128 are in a third extended position relative to the fourth withdrawn position shown in FIG. 29C, for example, for a distance (D8). Specifically, the at least one pawl 128 laterally translates in a direction depicted by the arrows (128c, 128d) in FIG. 32B, for example.

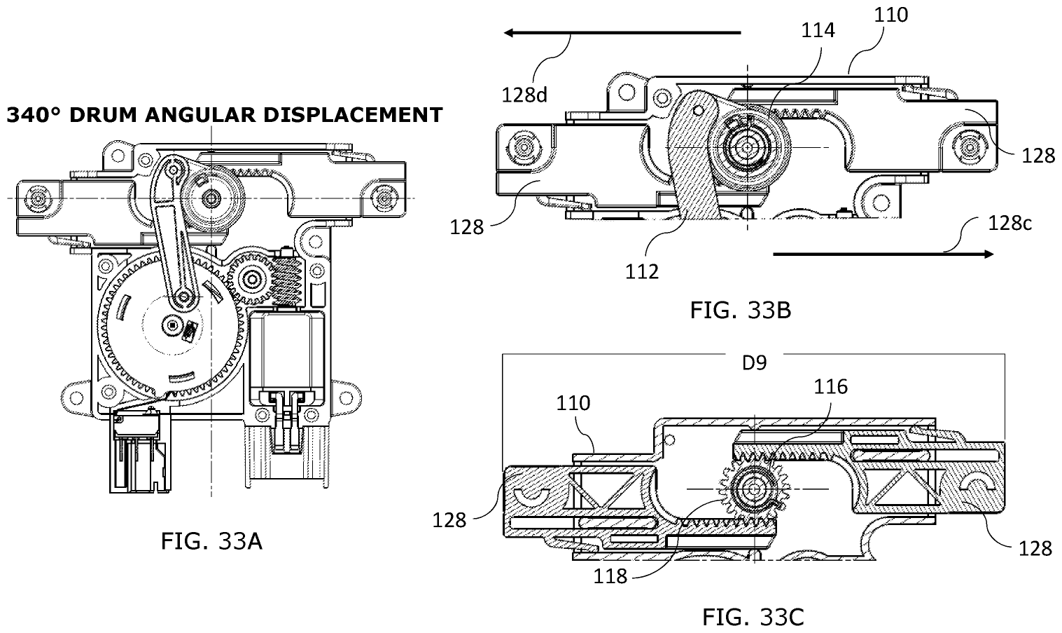

As illustrated in FIGS. 33A-33C, the drum 130 is depicted as traveling an angular displacement 340° in a single direction, e.g., counter-clockwise direction. Similar to the operation described above, the lever 112 moves in response to the angular displacement of the drum 130, and therefore causes driver 114 and gear 118 to move. The teeth 218 on the gear 118 are meshed with both sets of gear teeth 216 of the at least one pawl 128, such that the pawls 128 simultaneously move until an end portion of one of the pawls 128 and another end portion of another of the pawls 128 are in a fourth extended position relative to the fourth withdrawn position shown in FIG. 29C, for example, for a distance (D9). Specifically, the at least one pawl 128 laterally translates in a direction depicted by the arrows (128c, 128d) in FIG. 33B, for example.

The movement of the components of the dissociation assembly 224 (as shown in FIGS. 33A-33C above) corresponds to the movement of the components of the gear assembly 106 (as shown in FIGS. 15J-15P), when the drum 130 has traveled an angular displacement between 335° to 360°. When the angular displacement of the drum 130 is between 335° to 345°, the locker 134 is guided away from the side wall 174 of the wheel 138 and towards the angled surface 176 (FIG. 151) of the wheel 138. In this way, the angled surface 176 of the wheel 138 moves the locker 134 against the biasing means 136 and toward the locked position, in which the locker 134 restricts the ability of the drum 130 to rotate about the wheel axis in response to rotation of the wheel 138. When the angular displacement of the drum 130 is between 345° to 360°, the angled surface 176 moves the locker 134 toward the locked position, such that at least the leg portion 182 of the locker 134 moves within radially displaced portion 186 of the annular surface 184 and toward the stop surface 196. When the leg portion 182 is radially displaced such that it is adjacent the stop surface 196, the locker 134 is in the locked position, in which the locker 134 restricts the ability of the drum 130 to rotate about the wheel axis in response to rotation of the wheel 138.

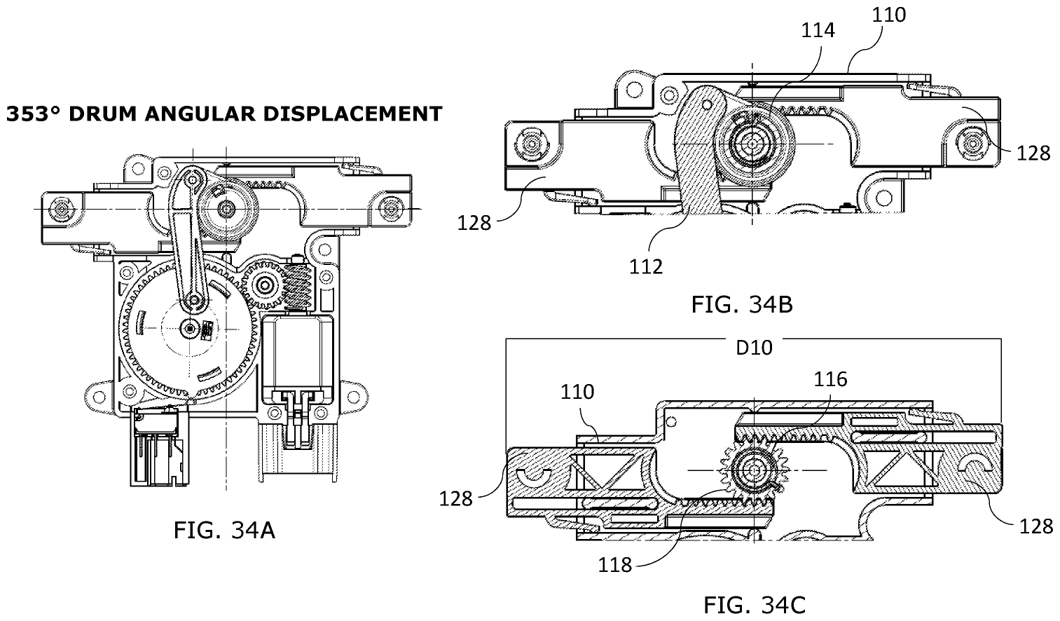

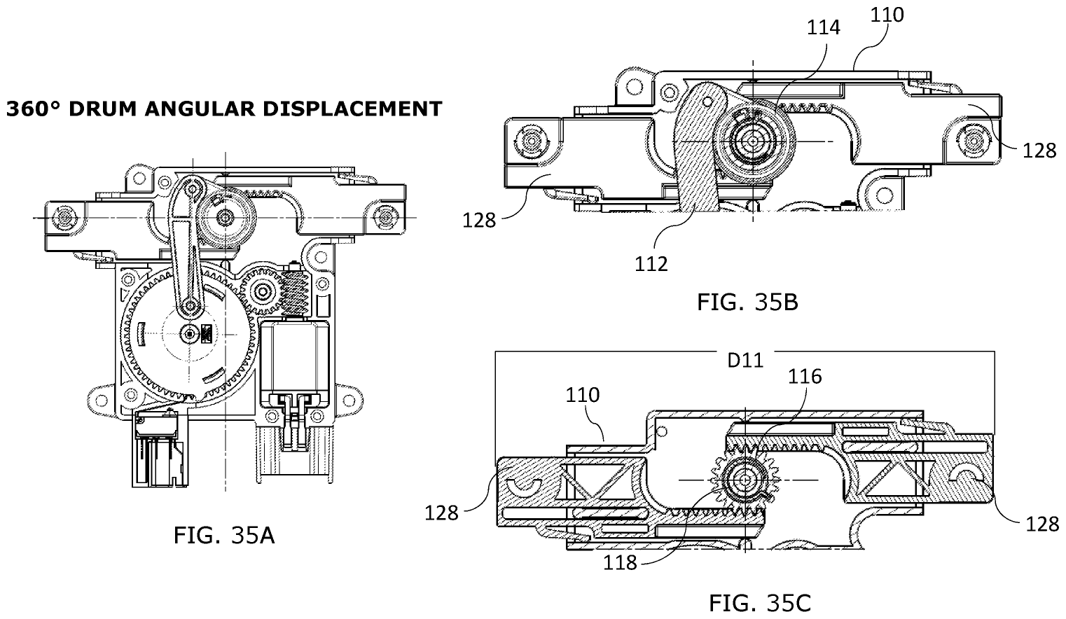

The restriction of the ability of the drum 130 to rotate thereby restricts the movement of lever 112. A comparison among FIGS. 33A-33C, 34A-34C, and 35A-35C, which depict the drum as traveling an angular displacement between 340° to 360° in a single direction, e.g., counter-clockwise direction, show that the at least one pawl 128 is configured to return to the locked position or a “reset” position in preparation for another use cycle of the latch 100, while the latch 100 is still in the unlatched state and the door is in an open state. Further, an end portion of one of the at least one pawl 128 and another end portion of another of the at least one pawl 128 are configured to be respectively displaced for a distance D9 (FIG. 33C), D10 (FIG. 34C), and D11 (FIG. 35C). The distances D9, D10, and D11 show minor differences relative to each other because the angular displacement of the drum 130 between D9 and D11 is just 20° and at the particular angular displacement between 340° to 360°, the micro-switch 124 is triggered (by interaction of the wiper arm 160 and the indexing means or curved portion 162 of drum 130) to deactivate the power supply to motor 104, thereby stopping the motor 104.

It should be understood that the above description of operating the dissociation assembly 224 is not limited to any step or sequence of steps, and may vary from that which is shown and described without departing from the scope and spirit of the invention.

Finally, as stated earlier, motion of the lever 112 in response to motion of the drum 130 causes at least one component of the dissociation assembly 224 to move. In a non-limiting example, movement of the driver 114 in response to motion of the lever 112 results in movement of the gear 118 without opposite rotational movement of the driver 114. In this respect, a gear assembly, such as dissociation assembly 224, is configured to transfer rotational motion of an input into linear motion of an output relative to a rest position and to absorb linear motion of the output relative to the rest position without opposite rotational motion of the input, thereby dissociating the linear motion of the output from the opposite rotational motion of the input. 30

A gear, such as gear 118, may be mounted for rotational motion about a gear axis (FIG. 17B) and coupled to generate the linear motion of the output relative to the rest position (FIG. 22). A driver, such as driver 114, is coupled directly or indirectly to the gear 118 and mounted for rotational motion about the gear axis, such that the driver 114 provides the input of the gear assembly 224. Further, as shown in FIG. 22, a spring, such as spring 116, is disposed in an interface between the gear 118 and the driver 114, such that the spring 116 is configured to bias the gear 118 and the driver 114 toward each other.

The gear 118 and the driver 114 may be biased toward each other, such that the interface between the gear 118 and the driver 114 is at least the “wall to wall” contact between the radial surface 220 of the gear 118 and the stop surface 246 of driver 114. The interface of the driver 114 and the gear 118 is configured such that rotational movement of the driver 114, as the input of the gear assembly 224, transfers to rotational movement of the gear 118 of the gear assembly 224, and rotational movement of the gear 118 of the gear assembly 224 transfers to linear motion of the output relative to the rest position. Additionally, the interface of the driver 114 and the gear 118 is further configured such that opposite linear motion of the output relative to the rest position causes the opposite rotational movement of the gear 118 of the gear assembly 224, but the opposite rotational movement of the gear 118 is not transferred to opposite rotational movement of the driver 114 of the gear assembly 224. In this way, the gear assembly 224 thus absorbs linear motion of the output from the rest position without opposite rotational motion of the driver 114 by dissociating the linear motion of the output from the opposite rotational motion of the driver 114.

In a latch comprising the gear assembly 224, such as latch 100, the output of the gear assembly 224 comprises at least one pawl, such as pawl 128, that is coupled to the gear 118 and configured for the linear motion in response to rotational motion of the gear 118. The at least one pawl 128 is movable between a locked position, in which the latch 100 is in the latched state, and an unlocked position, in which the latch 100 is in the unlatched state. Specifically, movement of the at least one pawl 128 toward the unlocked position by the driver 114 occurs without requiring compression of the biasing means 116, thereby restricting the ability of the driver 114 and the gear 118 to move relative to one another. Latch 100 may further comprise a motor, such as motor 104, that is coupled to drive the driver 114 for rotational movement about the gear axis and a manual movement (discussed below) of the at least one pawl 128 to cause opposite rotational movement of the gear 118 does not require operation of the motor 104.

Referring now to FIGS. 36A-36I, movement of one or more components of the dissociation assembly 224 are shown under manual operation. As stated above, the dissociation assembly 224 may be additionally or optionally configured to facilitate manual actuation of the at least one pawl 128, such that the latch 100 moves toward the latched state. Movement of the latch 100 toward the latched state is achieved by manual actuation of the at least one pawl 128 toward a withdrawn or retracted position relative to the housing 110 until they are back in a position to engage with the strikers (not shown) and subsequently, the biasing force of torsion spring 116 moves the at least one pawl 128 back toward the locked position. When the at least one pawl 128 is in the locked position, the latch 100 is in the latched state and the door is closed. Additional details regarding the manual operation and the components of the dissociation assembly 224 are discussed below.

FIGS. 36A-36C depict one or more components of the dissociation assembly 224 at a home, or rest position. In this rest position, which is similar to what is shown in FIGS. 25A-25C, the driver 114 is in immobilized in a starting or rest position, as determined by the arrangement of the lever 112, which is connected to gear assembly 106, when the motor 104 is inactive (and therefore provides no output from the gear assembly 106). As stated above, the spring 116 is configured for retaining gear 118 in this rest position by exerting a biasing force to maintain “wall-to-wall” contact between at least radial surface 220 of the gear 118 and stop surface 246 of driver 114. In this rest position, the at least one pawl 128 is in an extended position, such that an end portion of one of the at least one pawl 128 and another end portion of another of the at least one pawl 128 are positioned for a distance (D).

FIGS. 36D-36F depict one or more components of the dissociation assembly 224 at a half manual stroke position. A manual application of force or pressure (along displacement directions 128e, 128f shown in FIG. 36B, for example) on at least one pawl 128 causes the gear 118 to rotate against the biasing force of spring 116. Movement of the at least one pawl 128 and the gear 118 compresses the spring 116 with increasing force as the displacement of the at least one pawl 128 increases. In this position, the at least one pawl 128 is moved toward a withdrawn position relative to the rest position shown in FIG. 36A, such that an end portion of one of the at least one pawl 128 and another end portion of another of the at least one pawl 128 are positioned for a distance (D′). The distance (D′) is therefore less than the distance (D).

FIGS. 36G-36I depict one or more components of the dissociation assembly 224 at a full manual stroke position. A manual application of force or pressure (along displacement directions 128e, 128f shown in FIG. 36H, for example) on at least one pawl 128 causes the gear 118 to further rotate against the biasing force of spring 116, thereby further compressing the spring 116 with further increasing force. In this position, the at least one pawl 128 is moved toward a further withdrawn position relative to the rest position shown in FIG. 36A, such that an end portion of one of the at least one pawl 128 and another end portion of another of the at least one pawl 128 are positioned for a distance (D″). In other words, the distance (D″) is less than the distance (D′) because the at least one pawl 128 is in the further withdrawn position relative to the withdrawn position shown in FIG. 36F, for example. Once manual actuation of the at least one pawl 128 toward the fully withdrawn or retracted position is achieved, the at least one pawl 128 is/are returned to a position in which the at least one pawl 128 are configured to engage with the strikers (not shown) and subsequently, the biasing force of torsion spring 116 moves the at least one pawl 128 back toward the extended or locked position.

In an exemplary embodiment, moving the at least one pawl 128 toward the full manual stroke position, corresponds to total displacement of the at least one pawl at approximately 17 mm, which causes the gear 118 to rotate along direction 228 (FIG. 22) within the driver 114 for an angular displacement of up to 125°.

As shown in FIGS. 36D-361, as one or more components of the dissociation assembly 224 move in response to the manual application of force or pressure on at least one pawl 128, movement of one or more components of the latch 100 is restricted, or at least one component of the latch 100 is immobilized. In an exemplary embodiment, as the at least one pawl 128 and gear 118 move in response to the manual application of force or pressure on at least one pawl 128, movement of at least the driver 114, the lever 112, and the gear assembly 106 are restricted, or are the driver 114, the lever 112, and the gear assembly 106 are immobilized.

It should be understood that the above description of manually operating the dissociation assembly 224 is not limited to any step or sequence of steps, and may vary from that which is shown and described without departing from the scope and spirit of the invention.

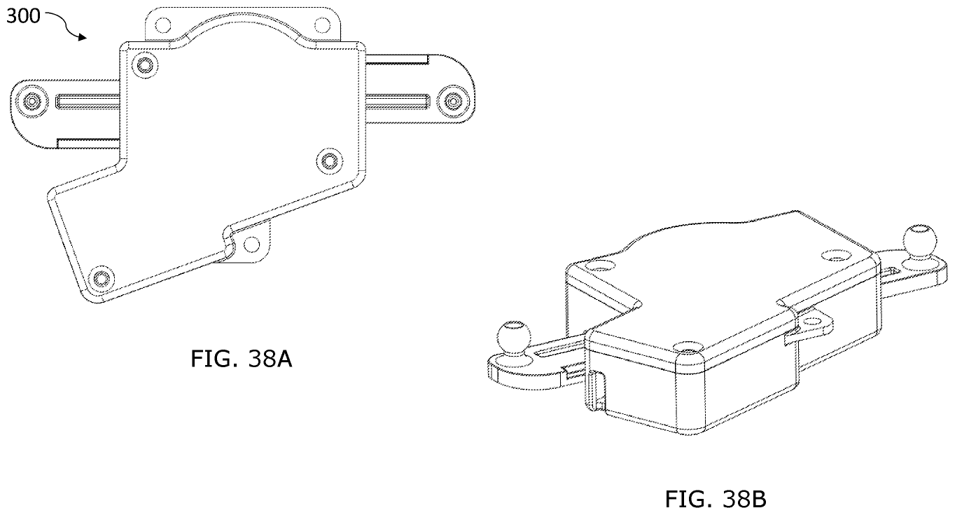

Another embodiment of an assembly having a dissociation assembly made according to the present invention is illustrated in FIGS. 38A-38B, 39A-39B, and 40. The components of this embodiment, such as latch 300, generally correspond to the first embodiment described above.

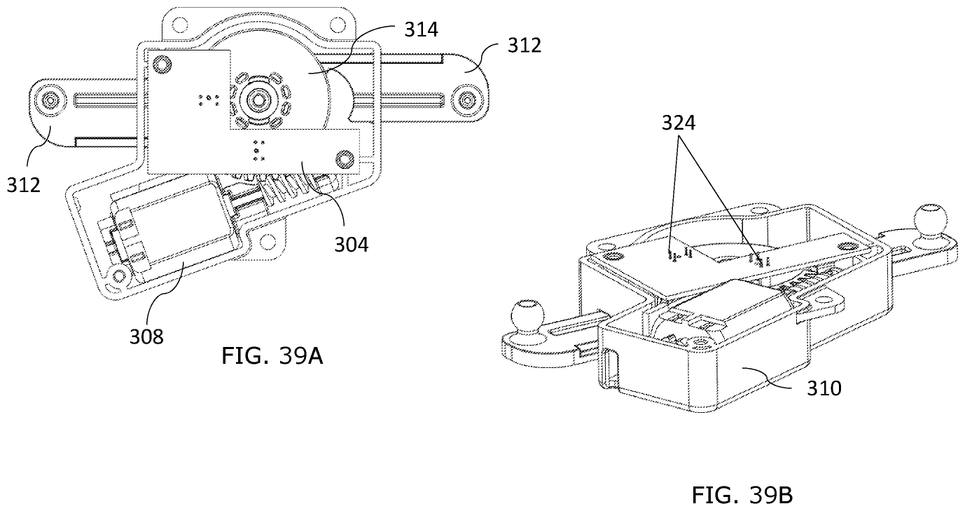

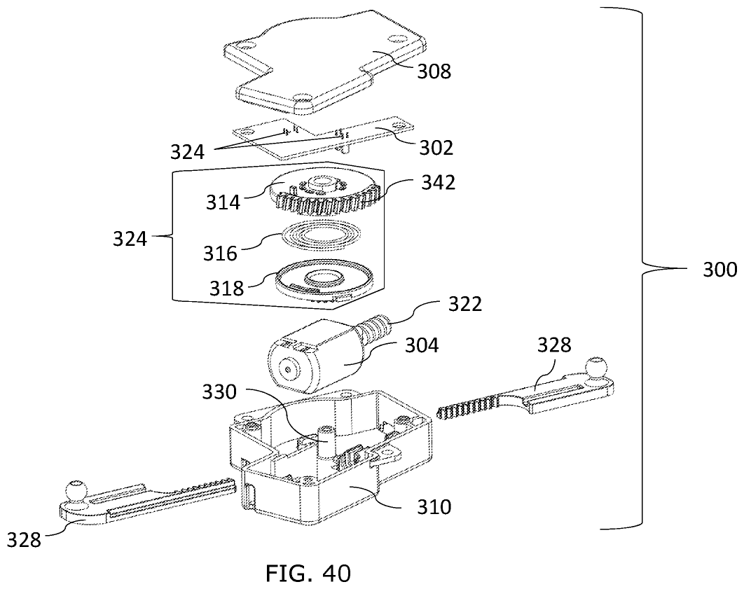

FIGS. 38A-38B depict an assembled latch 300 and FIGS. 39A-39B depict the assembled latch 300 with a cover 308 removed to show arrangement of components therein. As shown in FIG. 40, latch 300 generally includes cover 308 and housing 310; the cover 308 and housing 310 together define an interior configured to enclose one or more components of latch 300 therein. Latch 300 further comprises at least one rack or pawl 328, the details of which generally correspond to the details of the at least one pawl 128 above.

However, this embodiment differs from the first embodiment described above in several respects. In one example, latch 300 includes a motor 304, the details of which generally correspond to the details of the motor 104 discussed above, except that the output shaft of the motor 304 is configured to rotate around two directions (clockwise and counter-clockwise). In another example, the latch 300 includes a PCB, such as PCB 302, to control and drive the motor 304. In other words, the latch 300 uses PCB 302 to create a brief short circuit so that the motor 304 stops almost instantaneously. Further, latch 300 includes at least one switch 324 which may be mounted to PCB 302. The at least one switch 324 is configured to detect rotation of a driver 314, and communicate one or more rotational positions of the driver 314 to a processor and/or controller in the vehicle, for example. In particular, one of the at least one switch 324 is positioned to detect rotation of a driver 314 along one direction (e.g. clockwise) and another of the at least one switch 324 is positioned to detect rotation of the driver 314 along another direction (e.g. counter-clockwise). The at least one switch 324 may be generally referred to as a sensor, and/or may be substituted by a rotary encoder, Hall-effect sensor, a Linear Variable Differential Transformer (LVDT), potentiometer, optical proximity sensor, transducer, eddy-current sensor, or photodiode, for example.

As best illustrated in FIG. 40, latch 300 includes dissociation assembly 324, the details of which and operation thereof generally correspond to those of the dissociation assembly 224, discussed in the first embodiment above. Dissociation assembly 324 generally comprises driver 314, spring 316, and gear 318.

In an exemplary embodiment, the gear 318 is rotatably mounted to the housing 310 by a shaft 330 extending upward from the housing 310. Further, the gear 318 is configured to move about a gear axis (as similarly shown for dissociation assembly 224 in FIG. 17B). A set of teeth extends downwardly from an annular surface of the gear 318, such that the gear 318 is mounted for movement relative to the corresponding teeth of the at least one pawl 328.

The spiral spring 316 includes two free ends. Spring 316 is configured to be received by an annular surface of the gear 318. In particular, the driver 314 and gear 318 together define an interior configured to completely enclose spring 316. The spring 316 is configured for retaining gear 318 in a rest position by exerting a biasing force to maintain contact between the gear 318 and the driver 314.

The driver 314 has a circular body and set of teeth 342. Driver 314 is rotatably mounted to the gear 318 and configured to rotate about the gear axis in response to movement of the rotatable output shaft of motor 304. Driver 314 is engageably coupled directly to the rotatable output shaft of the motor 304. Rotatable output shaft may have a fixed worm screw 322, the details of which generally corresponds to worm screw 122. The teeth of worm screw 322 is non-rotatably connected to and meshes with teeth 342 defined along an outer perimeter of driver 314, such that the driver 314 rotates along with the worm screw 322.

Movement of the driver 314 causes the gear 318 to move, thereby moving the at least one pawl 328 to move between an unlocked position and a locked position. In an assembled form of the latch 300, the teeth on the gear 318 are meshed with both sets of gear teeth of the at least one pawl 328, such that movement of the gear 318 causes simultaneous translation of the pawls 328 between the locked and unlocked positions. Desirably, movement of the at least one pawl 328 toward the unlocked position, when driver 314 rotates in response to activation of motor 304, occurs without requiring compression of spring 316. In other words, movement of the at least one pawl 328 toward the unlocked position occurs while the driver 314 and gear 318 remain immobilized relative to each other, or remain in the rest position.

Conversely, operation of dissociation assembly 324 for moving the at least one pawl 328 toward the locked position is similar to the operation of dissociation assembly 224 under manual operation, as described above. A manual application of force or pressure on at least one pawl 328 causes the gear 318 to rotate (in an opposite direction to the direction of rotation when driver 314 is actuated by motor 304 for opening the latch 300) against the biasing force of spring 316 and causes the gear 318 to move relative to the stationary or immobilized driver 314.

When the at least one pawl 328 is in the unlocked position, the latch 300 is in the unlatched state. When the at least one pawl 328 is in the locked position, the latch 300 is in the latched state. In an exemplary embodiment, when the at least one pawl 328 is in the unlocked position, the at least one pawl 328 is in an extended position relative to housing 310 and are positioned to not interact with strikers (not shown) in the door housing, such that the latch 300 is in the unlatched state and the door is in an open state. Conversely, when the at least one pawl 328 is in the locked position, the at least one pawl 328 is in a withdrawn or retracted position relative to housing 310 and are positioned to interact with strikers (not shown) in the door housing, such that the latch 300 is in the latched state and the door is in a closed state.

However, one of ordinary skill in the art would understand that the above relationship between the extended or withdrawn position of the at least one pawl 328 and the unlatched or latched state of the latch 300 is not so limited, such that the opposite configuration (e.g. when the at least one pawl 328 is in an extended position, the latch 300 is in the latched state and when the at least one pawl 328 is in a withdrawn position, the latch 300 is in the unlatched state) remains within the scope and spirit of the invention.

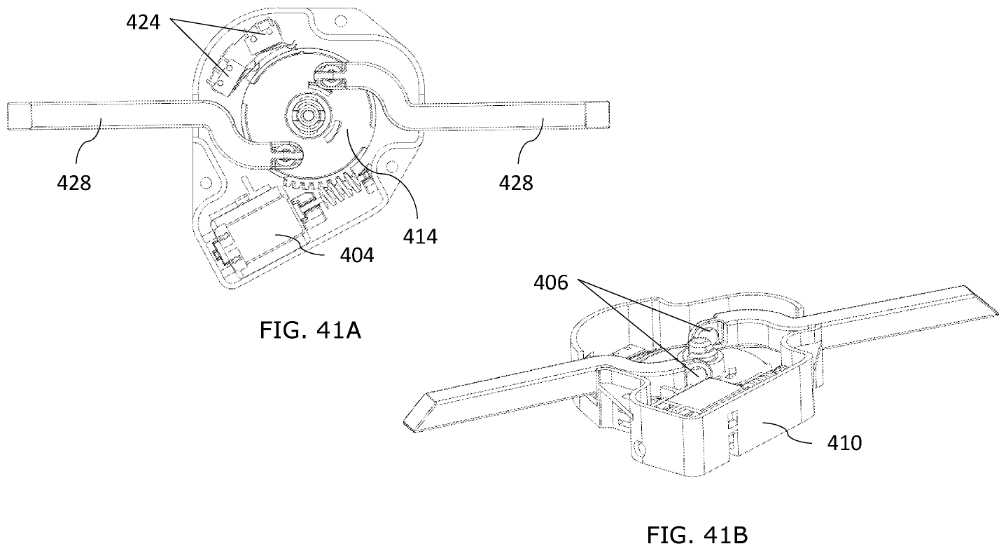

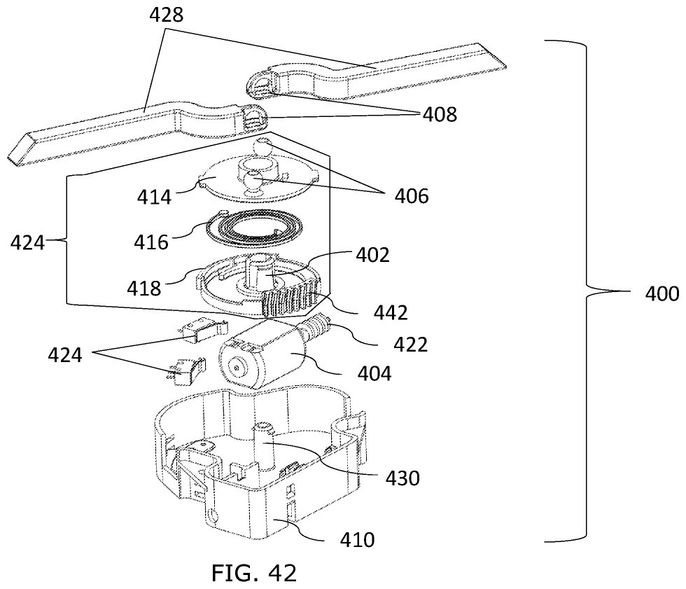

Another embodiment of a motor-driven assembly having a dissociation assembly made according to the present invention is illustrated in FIGS. 41A-41B and 42. The components of this embodiment, such as latch 400, generally correspond to the components of latches 100 and 300.

FIGS. 41A-41B depict an assembled latch 400, showing arrangement of components therein. Latch 400 generally includes a cover (not shown) and housing 410; the cover and housing 410 together define an interior configured to enclose one or more components of latch 400 therein. Latch 400 further comprises at least one pawl 428, the details of which generally correspond to the details of the at least one pawl 128 above.

Latch 400 includes a motor 404, the details of which generally correspond to the details of the motor 304. Further, latch 400 includes a PCB (not shown) to control and drive the motor 404. In other words, the latch 400 uses a PCB to create a brief short circuit so that the motor 404 stops almost instantaneously. Further, latch 400 includes at least one switch 424 which may be mounted to the PCB. The at least one switch 424 is configured to detect rotation of a driver 414 (discussed below), and communicate one or more rotational positions of the driver 414 to a processor and/or controller in the vehicle, for example. In particular, one of the at least one switch 424 is positioned to detect rotation of a driver 414 along one direction and another of the at least one switch 424 is positioned to detect rotation of the driver 414 along another direction. The at least one switch 424 may be generally referred to as a sensor, and/or may be substituted by a rotary encoder, Hall-effect sensor, a Linear Variable Differential Transformer (LVDT), potentiometer, optical proximity sensor, transducer, eddy-current sensor, or photodiode, for example.

As best illustrated in FIG. 42, latch 400 includes a dissociation assembly 424, the details of which and operation thereof generally correspond to those of the dissociation assemblies 224 and 324 discussed above. Dissociation assembly 424 comprises driver 414, spring 416, and gear 418.

In an exemplary embodiment, the gear 418 is rotatably mounted to the housing 410 by a shaft 430 extending upward from the housing 410. Further, the gear 418 is configured to move about a gear axis (as similarly shown for dissociation assembly 224 in FIG. 17B). The gear 418 has a circular body and set of teeth 442. Gear 418 is engageably coupled directly to a rotatable output shaft of the motor 404. Rotatable output shaft may have a fixed worm screw 422, the details of which generally corresponds to worm screw 322. The teeth of worm screw 422 is non-rotatably connected to and meshes with teeth 442 defined along an outer perimeter of gear 418, such that the gear 418 rotates along with the worm screw 422.

The spiral spring 416 generally corresponds to spring 316. Spring 416 includes two free ends. Spring 416 is configured to be received by annular surface of the gear 418. In particular, spring 416 is mounted to the gear 418 by a shaft 402 extending upward from the gear 418. The spring 416 is configured for retaining driver 414 in a rest position by exerting a biasing force to maintain contact between the gear 418 and the driver 414.

Driver 414 is rotatably mounted to the gear 418 and configured to rotate about the gear axis in response to movement of the gear 418. A set of protrusions 406 extend upwardly from a top surface of the driver 414, such that the driver 414 is mounted for movement relative to the at least one pawl 428. Movement of the gear 418 causes the driver 414 to move, thereby moving the at least one pawl 428 to move between an unlocked position and a locked position. In an assembled form of the latch 400, the protrusions 406 are received by apertures 408 defined by each of the at least one pawl 428, such that movement of the driver 414 causes simultaneous translation of the at least one pawl 428 between the locked and unlocked positions.

Desirably, movement of the at least one pawl 428 toward the unlocked position, when driver 414 rotates in response to activation of motor 404, occurs without requiring compression of spring 416. In other words, movement of the at least one pawl 428 toward the unlocked position occurs while the driver 414 and gear 418 remain immobilized relative to each other, or remain in the rest position.

Conversely, operation of dissociation assembly 424 for moving the at least one pawl 428 toward the locked position is similar to the operation of dissociation assemblies 224 and 324 under manual operation, as described above. A manual application of force or pressure on at least one pawl 428 causes the driver 414 to rotate (in an opposite direction to the direction of rotation when gear 418 is actuated by motor 404) against the biasing force of spring 416 and causes the driver 414 to move relative to the stationary or immobilized gear 418.

When the at least one pawl 428 is in the unlocked position, the latch 400 is in the unlatched state. When the at least one pawl 428 is in the locked position, the latch 400 is in the latched state. In an exemplary embodiment, when the at least one pawl 428 is in the unlocked position, the at least one pawl 428 is positioned to not interact with strikers (not shown) in the door housing, such that the latch 400 is in the unlatched state and the door is in an open state. Conversely, when the at least one pawl 428 is in the locked position, the at least one pawl 428 are positioned to interact with strikers (not shown) in the door housing, such that the latch 400 is in the latched state and the door is in a closed state.

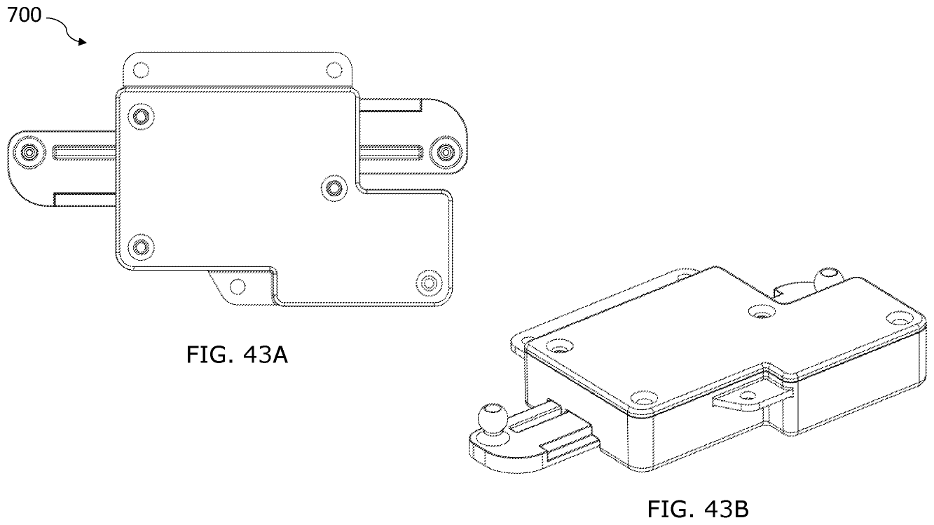

Another embodiment of an assembly having a dissociation assembly made according to aspects of the present invention is illustrated in FIGS. 43A-43B, 44A-44B, and 45. The components of this embodiment, such as latch 700, generally correspond to the latches 300 and 400, as described above.

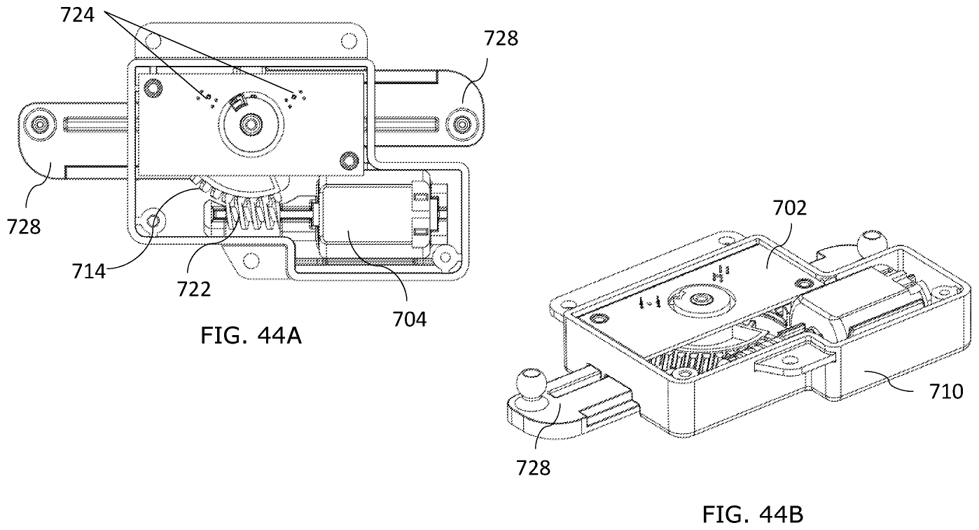

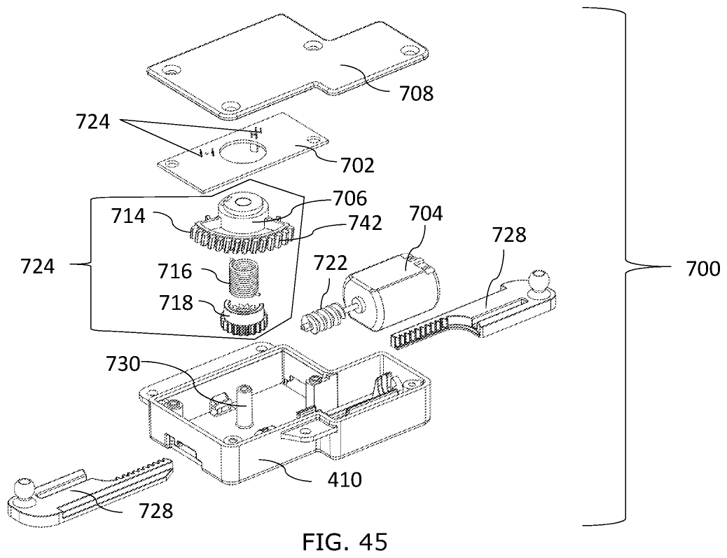

FIGS. 43A-43B depict an assembled latch 700 and FIGS. 44A-44B depict the assembled latch 700 with a cover 708 removed to show arrangement of components therein. As shown in FIG. 45, latch 700 generally includes cover 708 and housing 710; the cover 708 and housing 710 together define an interior configured to enclose one or more components of latch 700 therein. Latch 700 further comprises at least pawl 728, the details of which generally correspond to the details of the at least one pawl 128 above.

However, this embodiment differs from the first embodiment described above in several respects. In one example, latch 700 includes a motor 704, the details of which generally correspond to the details of the motor 104 discussed above, except that the output shaft of the motor 704 is configured to rotate around two directions (clockwise and counter-clockwise). In another example, the latch 700 includes a PCB, such as PCB 702, to control and drive the motor 704. In other words, the latch 700 uses PCB 702 to create a brief short circuit so that the motor 704 stops almost instantaneously.

Further, latch 700 includes at least one switch 724 which may be mounted to PCB 702. The at least one switch 724 is configured to detect rotation of a driver 714, and communicate one or more rotational positions of the driver 714 to a processor and/or controller in the vehicle, for example. In particular, one of the at least one switch 724 is positioned to detect rotation of the driver 714 along one direction (e.g. clockwise) and another of the at least one switch 724 is positioned to detect rotation of the driver 714 along another direction (e.g. counter-clockwise). The at least one switch 724 may be generally referred to as a sensor, and/or may be substituted by a rotary encoder, Hall-effect sensor, a Linear Variable Differential Transformer (LVDT), potentiometer, optical proximity sensor, transducer, eddy-current sensor, or photodiode, for example.

As best illustrated in FIG. 45, latch 700 includes dissociation assembly 724, the details of which and operation thereof generally correspond to those of the dissociation assemblies 224, 324 and 424, as discussed above. Dissociation assembly 724 generally comprises driver 714, spring 716, and gear 718. In particular, torsion spring 716 generally corresponds to torsion spring 116, and gear 718 generally corresponds to gear 118.

In an exemplary embodiment, the gear 718 is rotatably mounted to the housing 710 by a shaft 730 extending upward from the housing 710. Further, the gear 718 is configured to move about a gear axis (as similarly shown for dissociation assembly 224 in FIG. 17B). Gear 718 is mounted for movement relative to the at least one pawl 728 and configured to move about the gear axis. Specifically, a set of teeth extends along a circumferential length of gear 718, such that the gear 718 is mounted for movement relative to the corresponding teeth of the at least one pawl 728.

The driver 714 has a body having two radius lines and a curved edge, with a set of teeth 742 defined along an outer perimeter of the curved edge. Driver 714 further defines a hollow shaft 706 extending upwardly from the body. Driver 714 is configured to rotate about the gear axis in response to movement of the rotatable output shaft of motor 704. Driver 714 is rotatably mounted to the gear 718 and configured to rotate about the gear axis in response to movement motor 704, as will be discussed below.

Driver 714 and gear 718 together define an interior configured to completely enclose spring 716. Specifically, spring 716 is configured to be received by a cavity or interior space defined by the hollow shaft 706. The spring 716 is configured for retaining gear 718 in a home, or rest, position. In particular, the spring 716 exerts a biasing force to maintain “wall-to-wall” contact between the gear 718 and driver 714.

Driver 714 is engageably coupled directly to the rotatable output shaft of the motor 704. The rotatable output shaft may have a fixed worm screw 722, the details of which generally corresponds to worm screw 122. The teeth of worm screw 722 are non-rotatably connected to and mesh with teeth 742, such that the driver 714 rotates along with the worm screw 722. Movement of the driver 714 causes the gear 718 to move, thereby causing the at least one pawl 728 to move between an unlocked position and a locked position.

In an assembled form of the latch 700, the teeth on the gear 718 are meshed with both sets of gear teeth of the at least one pawl 728, such that movement of the gear 718 causes simultaneous translation of the pawls 728 between the locked and unlocked positions. Desirably, movement of the at least one pawl 728 toward the unlocked position, when driver 714 rotates in response to activation of motor 704, occurs without requiring compression of spring 716. In other words, movement of the at least one pawl 728 toward the unlocked position occurs while the driver 714 and gear 718 remain immobilized relative to each other, or remain in the rest position.

Conversely, operation of dissociation assembly 724 for moving the at least one pawl 728 toward the locked position is similar to the operation of dissociation assembly 224 under manual operation, as described above. A manual application of force or pressure on at least one pawl 728 causes the gear 718 to rotate (in an opposite direction to the direction of rotation when driver 714 is actuated by motor 704 for opening the latch 700) against the biasing force of spring 716 and causes the gear 718 to move relative to the stationary or immobilized driver 714.

When the at least one pawl 728 is in the unlocked position, the latch 700 is in the unlatched state. When the at least one pawl 728 is in the locked position, the latch 700 is in the latched state. In an exemplary embodiment, when the at least one pawl 728 is in the unlocked position, the at least one pawl 728 is in a withdrawn or retracted position relative to housing 710 and are positioned to not interact with strikers (not shown) in the door housing, such that the latch 700 is in the unlatched state and the door is in an open state. Conversely, when the at least one pawl 728 is in the locked position, the at least one pawl 728 is in an extended position relative to housing 710 and are positioned to interact with strikers (not shown) in the door housing, such that the latch 700 is in the latched state and the door is in a closed state.

However, one of ordinary skill in the art would understand that the above relationship between the extended or withdrawn position of the at least one pawl 728 and the unlatched or latched state of the latch 700 is not so limited, such that the opposite configuration (e.g. when the at least one pawl 728 is in an extended position, the latch 700 is in the unlatched state; and when the at least one pawl 728 is in a withdrawn position, the latch 700 is in the latched state) remains within the scope and spirit of the invention.

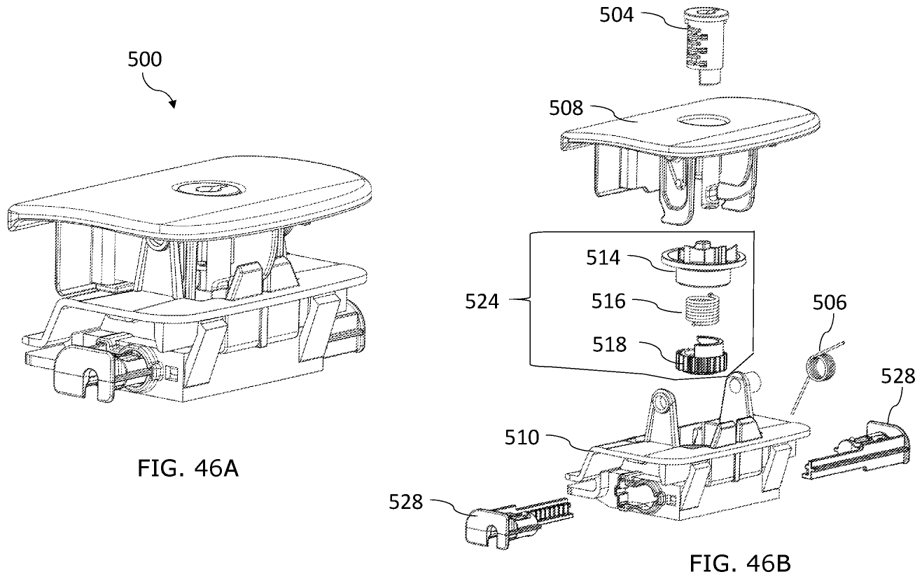

Another embodiment of a dissociation assembly for use in a latch configured for manual operation and made according to the present invention is illustrated in FIGS. 46A-46B, 47A-47B, and 48A-48G. Selected components of this embodiment, such as latch 500, may correspond to components described in U.S. application Ser. No. 16/955,433, filed Jun. 18, 2020, which is incorporated by reference herein in its entirety. However, latch 500 further includes dissociation assembly 524.

FIG. 46A depicts an assembled latch 500 and FIG. 46B is an exploded view of the latch 500, showing dissociation assembly 524. As shown in FIG. 46A, latch 500 generally includes paddle 508 and housing 510; the cover 508 and housing 510 together define an interior configured to enclose one or more components of latch 500 therein. Latch 500 further comprises at least one pawl 528, the details of which generally correspond to the details of the at least one pawl 128 above. Latch 500 also includes paddle spring 506 configured to drive paddle 508 and the at least one pawl 528 back to the start, or rest position, based on the associated friction forces in the system. Optionally, latch 500 includes a paddle lock 504.

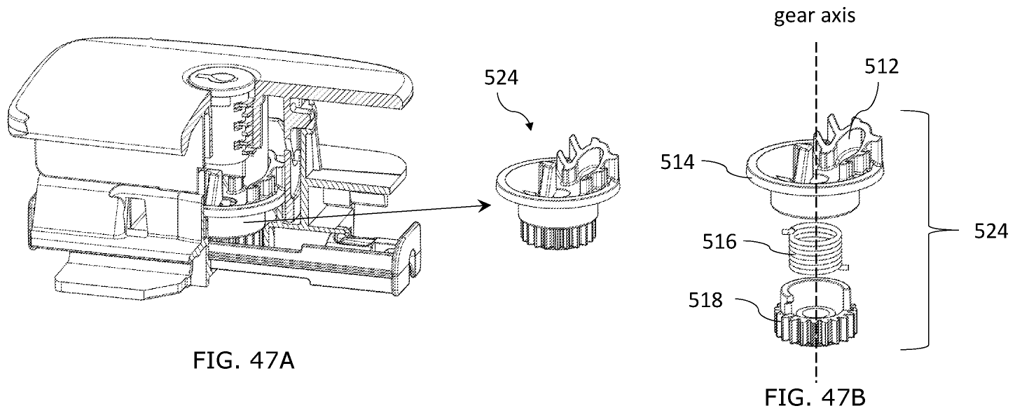

As best illustrated in FIGS. 47A-47B, latch 500 includes dissociation assembly 524, the details of which and operation thereof generally correspond to those of the dissociation assembly 224, discussed in the first embodiment above. Dissociation assembly 524 comprises driver 514, spring 516, and gear 518. In particular, torsion spring 516 generally corresponds to torsion spring 116, and gear 518 generally corresponds to gear 118.

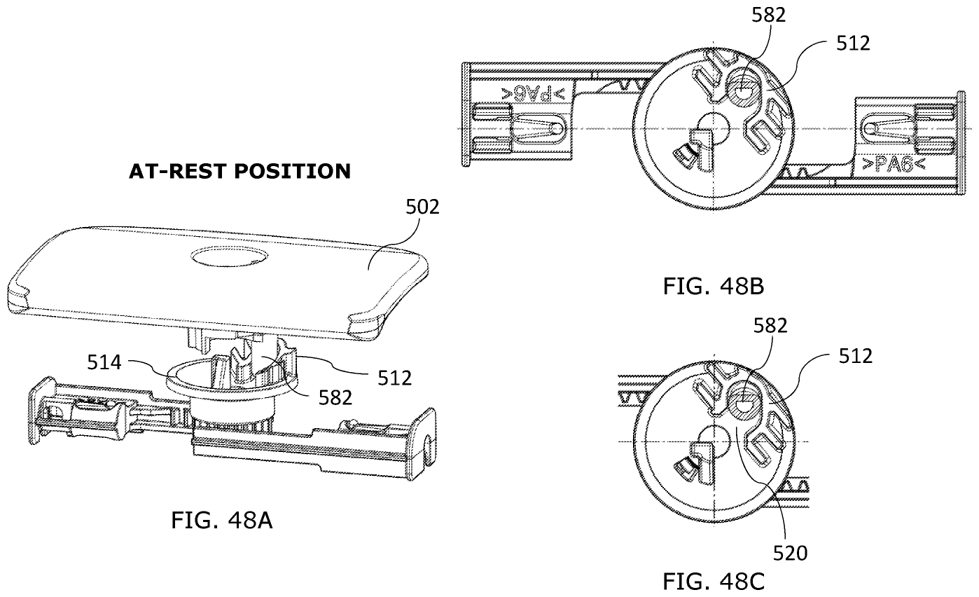

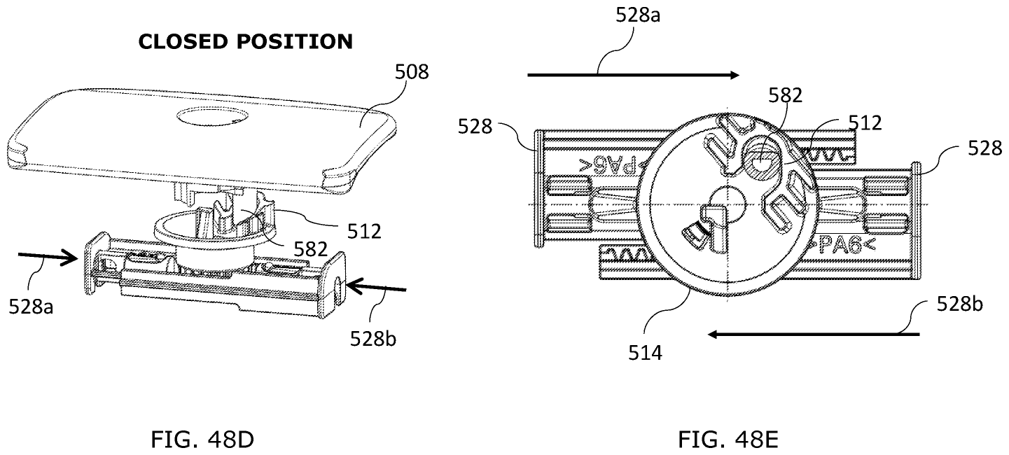

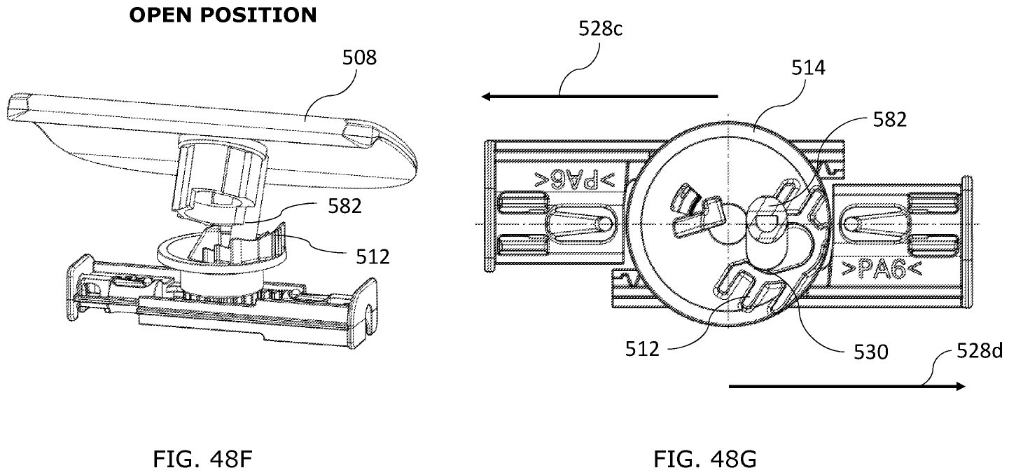

In an exemplary embodiment, the gear 518 is rotatably mounted to the housing 510 and is configured to move about a gear axis (as shown in FIG. 47B). A set of teeth extends downwardly from an annular surface of the gear 518, such that the gear 518 is mounted for movement relative to the corresponding teeth of the at least one pawl 528 (FIGS. 48B, 48E, and 48G). The spring 516 includes a coiled body having two free ends. Spring 516 is configured to be received by annular surface of the gear 518. In particular, the driver 514 and gear 518 together define an interior configured to completely enclose spring 516. The spring 516 is configured for retaining gear 518 in a rest position by exerting a biasing force to maintain contact between the gear 518 and the driver 514.

The driver 514 has a circular body and a cam shape 512 extending upwardly from the driver 514. The cam shape 512 may comprise, for example, irregular raised surfaces based on the shape or surfaces of one or more components of latch 500, such as paddle 508. The cam shape 512 (or at least a portion thereof) is located at a position that is offset from the gear axis (FIG. 47B). Thus a force applied to the cam shape 512 generates a moment that tends to rotate the driver 514 about the gear axis assuming that such force is not oriented along the gear axis and does not directly intersect the gear axis.

As shown in FIGS. 48A-48C, when latch 500 is in a rest position, a leg portion 582 extends downwardly from paddle 508 and is configured to be received by a slot 520 defined by cam shape 512. In this arrangement, leg portion 582 of paddle 508 is configured to restrict rotation of driver 514 having cam shape 512.

As illustrated in FIGS. 48D-48E, when latch 500 is moved toward the latched position, operation of dissociation assembly 524 for moving the at least one pawl 528 toward the locked position is similar to the operation of dissociation assembly 224 under manual operation, as described above. A manual application of force or pressure on at least one pawl 528 causes the at least one pawl 528 to move along displacement directions (528a, 528b) between an unlocked position and a locked position. Specifically, manual application of force or pressure on at least one pawl 528 causes the teeth on the gear 518 to mesh with both sets of gear teeth of the at least one pawl 528, such that movement of the gear 518 causes simultaneous translation of the pawls 528 between the locked and unlocked positions. Desirably, movement of the at least one pawl 528 toward the locked position occurs while the driver 514 remains immobilized relative to the gear 518, or at least restricted from rotation, by the interface between leg portion 582 and cam shape 512.

When the at least one pawl 528 is in the locked position, the latch 500 is in the latched state. In an exemplary embodiment, when the at least one pawl 528 is in the locked position, the at least one pawl 528 are in a withdrawn or retracted position relative to housing 510 and are positioned to interact with strikers (not shown), such that the latch 500 is in the latched state and a door is in a closed state. Movement of the gear 518 further angularly compresses the torsion spring 516 and returns the gear 518 and the at least one pawl 528 back to the rest position (FIGS. 48A-48C) when the door is in the closed state.

Conversely, when latch 500 is moved toward the unlatched position, operation of dissociation assembly 524 for moving the at least one pawl 528 toward the unlocked position under manual operation is illustrated in FIGS. 48F-48G. A manual application of force or pressure on paddle 508 causes the leg portion 582 to exert force or pressure on cam shape 512, such that the ability of driver 514 to rotate is not restricted. Desirably, this is achieved without exercising a force against the torsion spring 516. Rotation of driver 514 causes the at least one pawl 528 to move along displacement directions (528c, 528d) and toward the biasing operation of torsion spring 516, thereby moving the at least one pawl 528 toward the unlocked position. When the at least one pawl 528 is in the unlocked position, the latch 500 is in the unlatched state. In an exemplary embodiment, when the at least one pawl 528 is in the unlocked position, the at least one pawl 528 are in a withdrawn or retracted position relative to when the at least one pawl 528 are in the locked position (as shown in FIG. 48E, for example) and are positioned to not interact with strikers (not shown), such that the latch 500 is in the unlatched state and the door is in an open state.

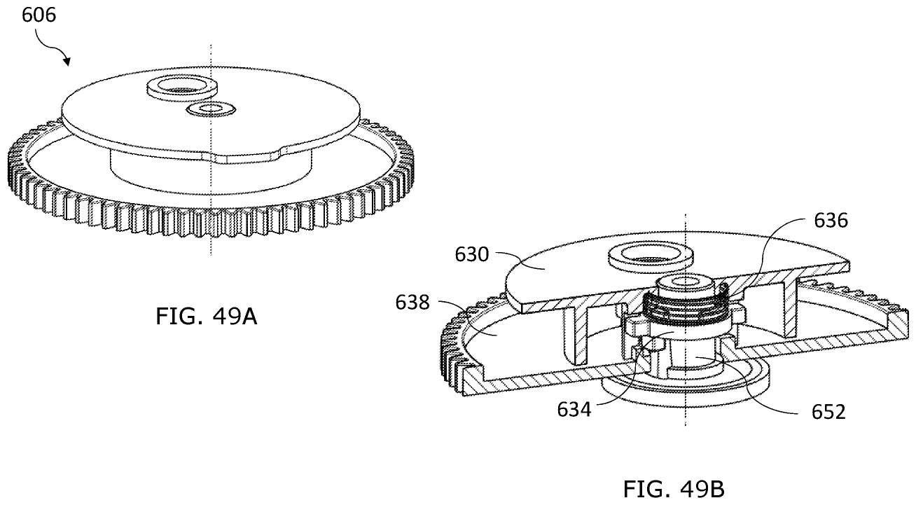

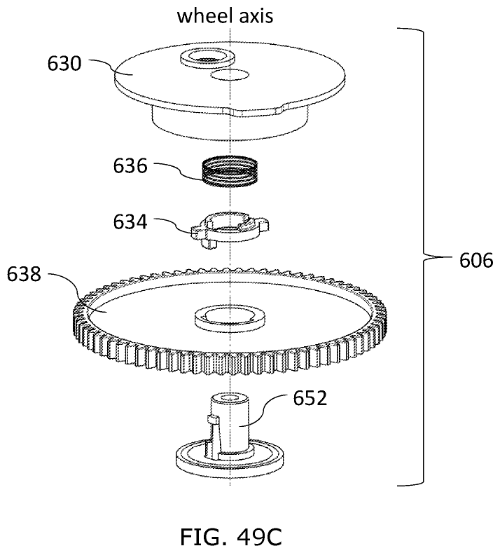

Another embodiment of a gear assembly made according to the present invention is illustrated in FIGS. 49A-49C, 50A-50B, 51A-51C, 52, and 53A-53B. The components of this embodiment, such as gear assembly 606, generally correspond to the components of gear assembly 106. Gear assembly 606 is described with reference to one or more components of latch 100.

FIGS. 49A-49B depict an assembled gear assembly 606 and FIG. 49C is an exploded view, showing arrangement of components therein. Like gear assembly 106, gear assembly 606 is configured to be driven by the output shaft 148 of the motor 104.

Further, similar to gear assembly 106, the gear assembly 606 is configured to desirably reduce or eliminate the effect of inertia of the motor 104 on an output of the gear assembly 606 in a similar fashion.

In general, gear assembly 106 comprises the wheel 638, drum 630, and locker 634. In an exemplary embodiment, as best seen in FIG. 49C, wheel 638 is rotatably mounted with respect to the housing 110 by a shaft 652. Wheel 638 is further configured to rotate about a wheel axis (FIG. 49C) in response to motion of the output shaft 148 of the motor 104. Further, drum 630 is rotatably mounted to the wheel 638 and is configured to rotate about the wheel axis in response to rotation of the wheel 638. Locker 634 is mounted for movement relative to the drum 630.

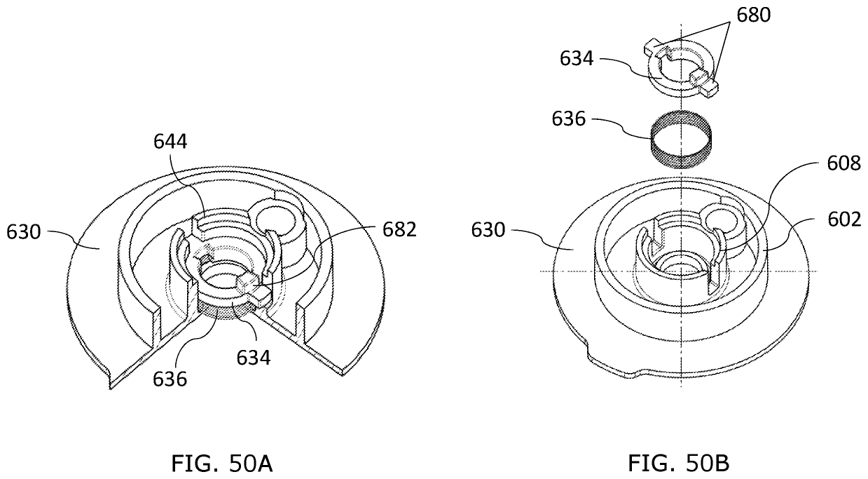

FIGS. 50A-50B depict a portion of the gear assembly 606, showing arrangement of spring 636 and locker 634 within drum 630. The drum 630 has a circular body and a rear surface. The rear surface defines two concentric rings (602, 608). Ring 608 comprises guide walls 644 configured to guide translational movement of locker 634 as wheel 638 rotates in response to movement of output shaft 148 of motor 104. As shown in FIG. 50A, ring 608 is configured to at least partially contain locker 634, such that pins 680 extend radially outward from the center of ring 608. As stated above, the drum 630 is rotatably mounted to the wheel 638, such that the rear surface of drum 630 corresponds to the shape and configuration of the wheel 638, as best illustrated in FIG. 49B.

Still further, shaft 652 is configured to extend through an opening defined by the ring 608 and slot 642 of wheel 638 for rotatably mounting the drum 630 to the wheel 638 and for mounting the drum 630 within the enclosure 102. Although FIGS. 49A-49B show the shaft 652 as a separate component from housing 110, one of ordinary skill in the art wound understand that shaft 652 may be integrally formed with the housing 110 as a single body of unitary construction, as is the case in latch 100.

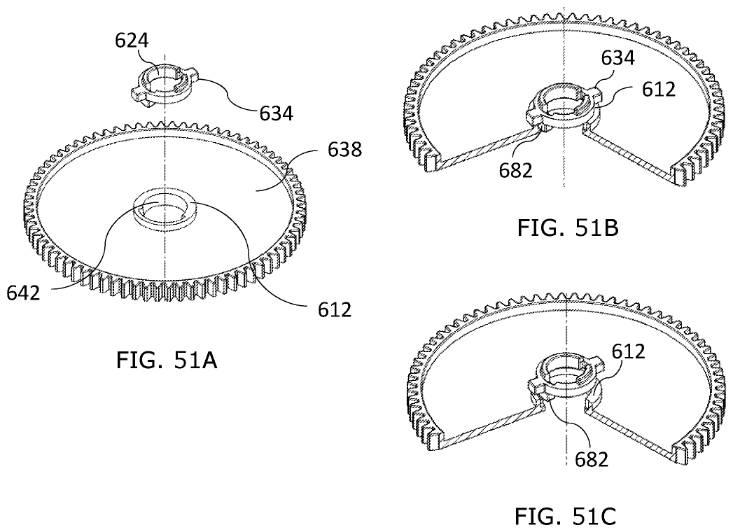

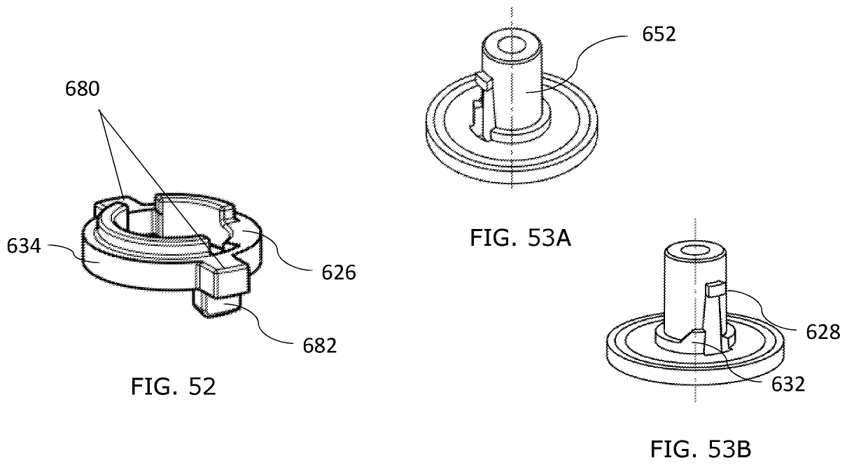

As shown in FIGS. 51A and 52, locker 634 may comprise thru-hole 624 extending through the center of the locker 634 and through its thickness. A pair of guide pins 680 extends radially outward from the center of the locker 634 and are positioned opposite of each other. Locker 634 further comprises a leg portion 682 extending downwardly from a predetermined location along a circumference of locker 634. Locker 134 is configured to rotate around the wheel axis (FIG. 49C) and to translationally move in response to motion of the wheel 638. The locker 634 is further movable translationally between an unlocked position (FIG. 51B), in which the locker 634 does not restrict the ability of the drum 630 to rotate about the wheel axis in response to rotation of the wheel 638, and the locked position (FIG. 51C), in which the locker 634 restricts the ability of the drum 630 to rotate about the wheel axis in response to rotation of the wheel 638. 30

A biasing means, such as spring 636 (FIG. 49C) may be disposed within the drum 630 and may be configured to bias the locker 634 toward the unlocked position and for engagement with the wheel 638. In particular, the leg portion 682 of the locker 634 is disposed within wheel slot 610 (located at the center of wheel 638), such that at least the leg portion 682 travels along an interior surface of wheel slot 610 as it rotates in response to motion of the wheel 638. In other words, motion of wheel 638 is driven by motor 104 when it is activated, and the locker 134 rotates in response to the motion of the wheel 638, thereby causing the drum 630 to rotate in response. Thus, in operation, when the locker 634 is in the unlocked position, locker 634 is engaged by the wheel 638 for rotation of the wheel 638 and the drum 630 together about the wheel axis.

As the locker 634 is guided towards the locked position, locker 634 is disengaged from the wheel 638 for rotation of the wheel 638 relative to the drum 630, thereby allowing inertial motion of the output shaft 148 of the motor 104 and rotation of the wheel 638 without causing rotation of the drum 630, and thereby reducing or eliminating the effect of inertia of the motor 104 on the output of the gear assembly 606. As shown in FIGS. 51B-51C, 52, and 53A-53B, the locker 634 is disengaged from the wheel 638 when stop surface 626 of locker 634 is engaged by a locking surface 640 defined by the shaft 652. As illustrated in FIGS. 53A and 53B, locking surface 640 comprises a locking portion 628 and sloped or angled portion 632.

As angular displacement of the drum 630 reaches 360° (e.g. full rotation or revolution), the locker 634 is moved towards the top surface 612 defined by wheel 638, such that leg portion 682 of locker 634 is raised above top surface 612 and moves away from slot 642. Further, as angular displacement of the drum 630 reaches 360°, the stop surface 626 of the locker 634 is moved towards engagement with locking surface 640 of the shaft 652. In this way, the sloped or angled portion 632 performs a similar function as the angled surface 176 of wheel 138 in gear assembly 106, e.g. guiding the locker 634 toward engagement between stop surface 626 of locker 634 and locking portion 628 of shaft 652. In other words, engagement between stop surface 626 and locking portion 628 is therefore similar to the engagement between leg portion 182 of locker 134 and stop surface 196 of drum 130 in gear assembly 106.

When the locker 634 is thus in the locked position, locker 634 restricts the ability of the drum 630 to rotate about the wheel axis in response to rotation of the wheel 638. Still further, when both the locker 634 and the drum 630 are prevented from moving in response to motion of the wheel 638, the wheel 638 continues to move in response to motion of the motor 104, thereby allowing inertial motion of the output shaft 148 of the motor 104, and thereby reducing or eliminating the effect of inertia of the motor 104 on the output of the gear assembly 606.

When motor 104 is activated for another operation cycle, the locker 634 is configured to be received by slot 642 of the wheel 638, such that leg portion 682 is once more disposed within slot 642 and below top surface 612. This re-engagement between the wheel and the locker 634 is facilitated by spring 636, which is configured to bias locker 634 toward the unlocked position, in which the locker 634 is configured for engagement with wheel 638.

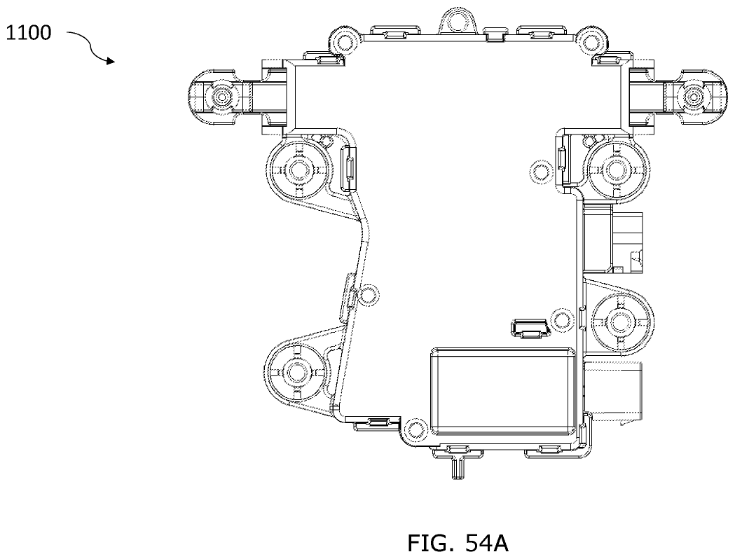

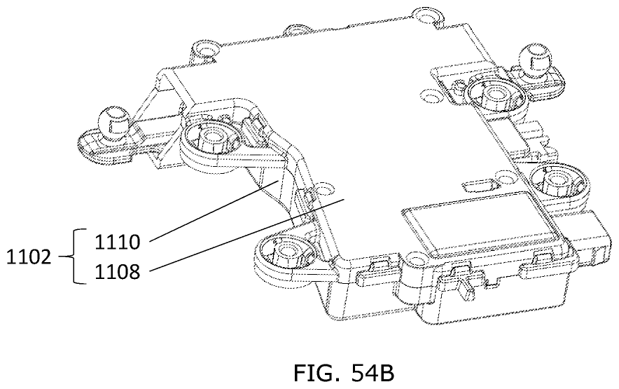

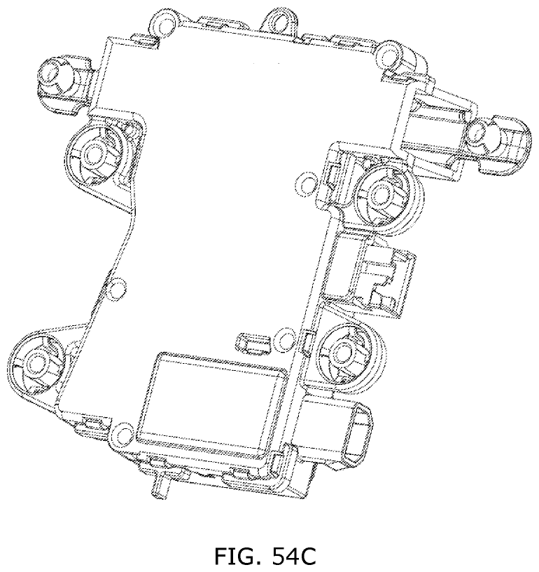

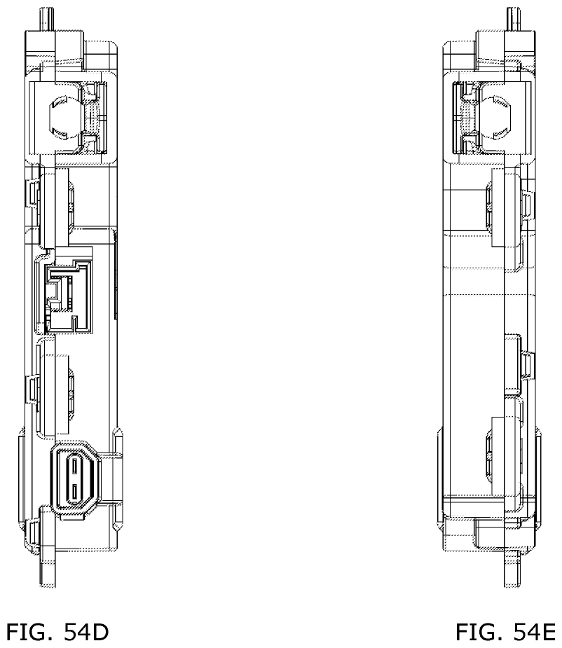

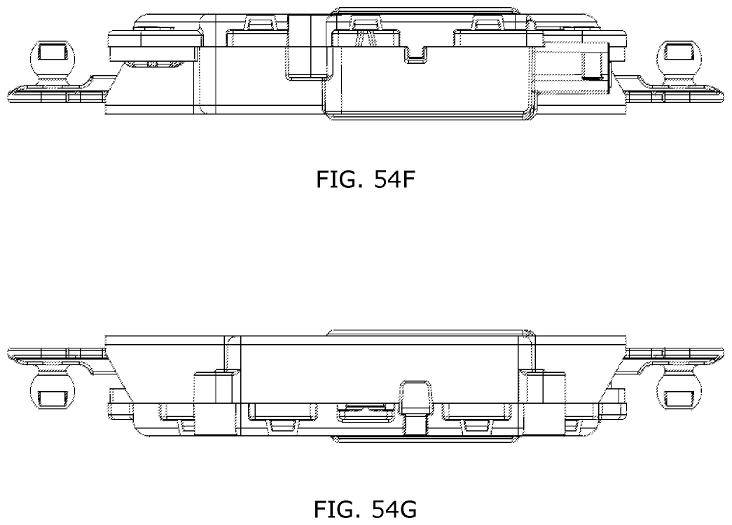

A second embodiment of an assembled latch made according to the present invention is illustrated in FIGS. 54A-54G, 55, and 56A-56C. The components of this embodiment, such as latch 1100, generally correspond to the first embodiment described above. For example, the latch 1100 generally comprises an enclosure 1102, a motor 1104, and an exemplary gear assembly 1224 that permits a partial or complete, direct or indirect disconnection and/or separation of motion of one component from of another component, i.e. a “dissociation assembly.” The components and operation of gear assembly 1224 is similar to the components and operation of the gear assembly 224, as described above. Additionally or optionally, latch 1100 may include an exemplary gear assembly 1106.

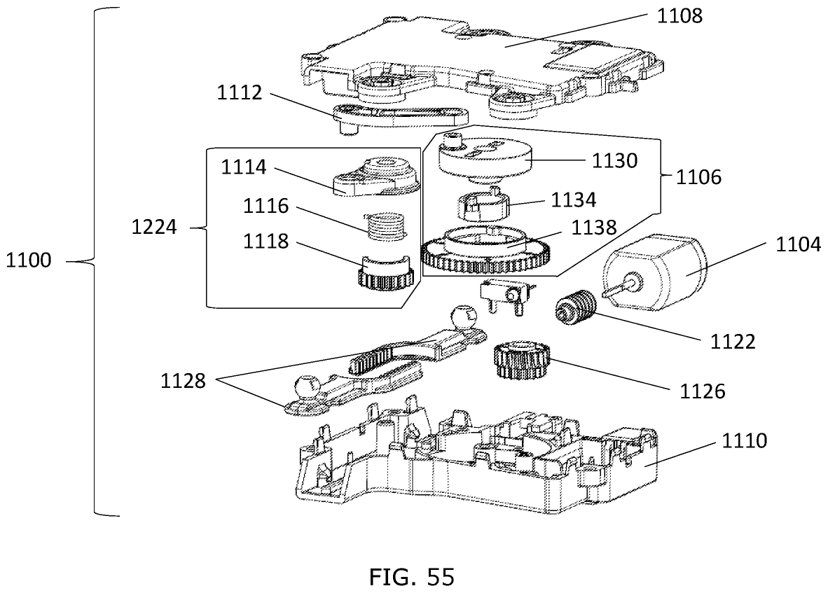

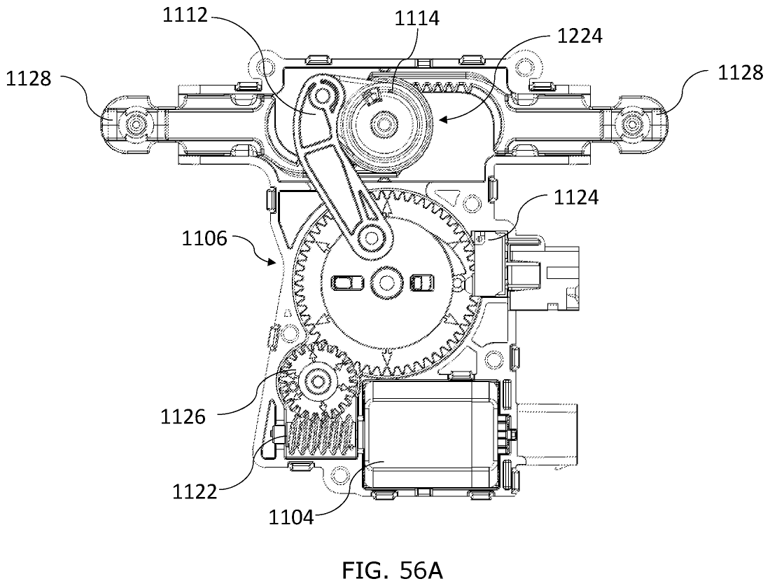

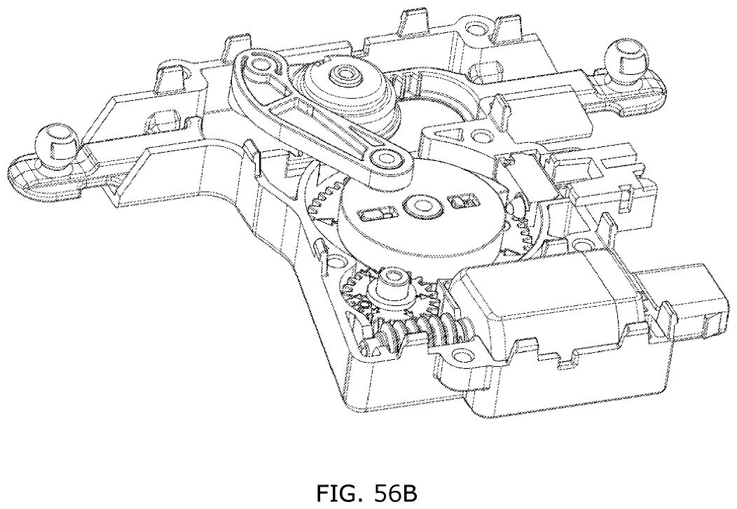

FIGS. 54A-54G depict an assembled latch 1100. FIG. 55 depicts an exploded view to show at least the operational components of the latch 1100 (e.g. the motor 1104 and the gear assembly 1106) and how they are provided or positioned within an interior of enclosure 1102. Further, FIGS. 56A-56C depict the assembled latch 1100 with a cover 1108 removed to show arrangement of components therein.

As shown in FIG. 55, latch 1100 generally includes the cover 1108 and housing 1110; the cover 1108 and housing 1110 together define an interior configured to enclose one or more components of latch 1100 therein. Latch 1100 further comprises at least one rack or pawl 1128, the details of which generally correspond to the details of the at least one pawl 128, as described above.

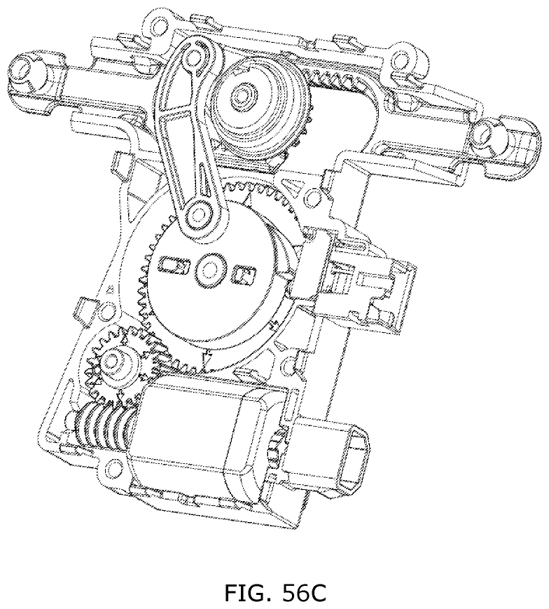

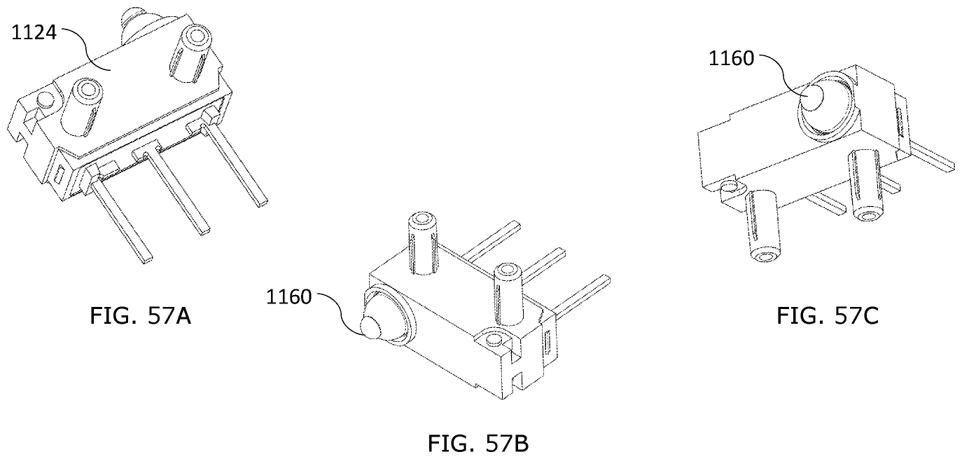

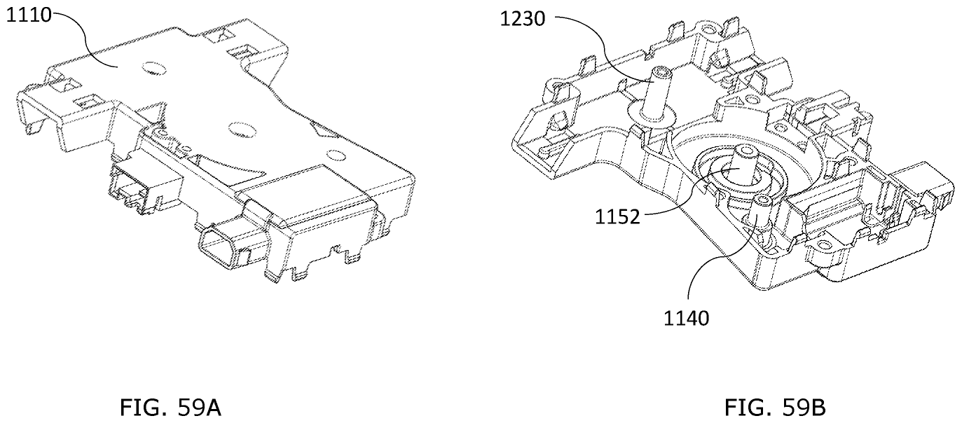

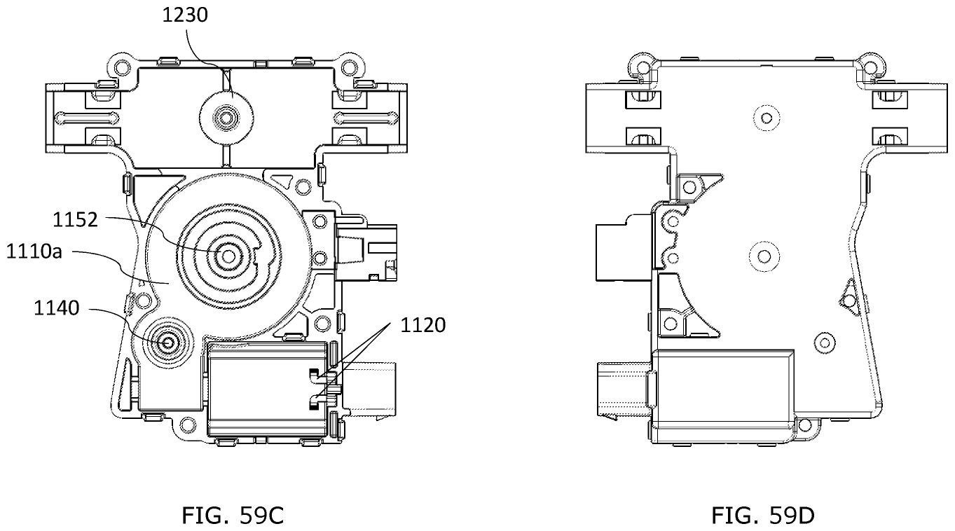

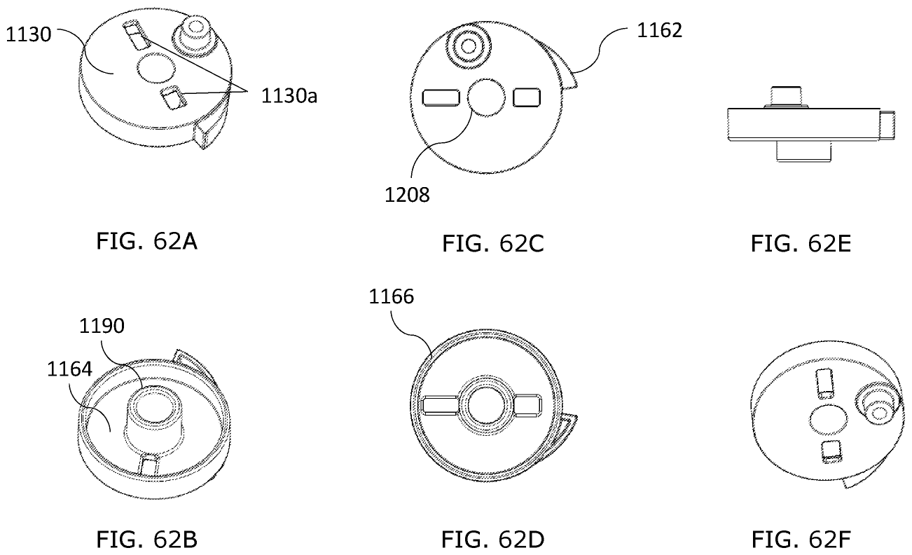

However, this embodiment differs from the first embodiment described above in several respects. In one example, latch 1100 may not require the biasing means or spring 136, which biases locker 134 toward the unlocked position in the first embodiment. In another example, latch 1100 includes two electrically conductive tracks or motor terminals 1120 (FIG. 59C), the details of which generally correspond to the details of the tracks 120, as discussed above, except that tracks 1120 of latch 1100 are integrally formed with the housing 1110, e.g. overmolded as inserts into housing 1110. In another example, as shown in FIGS. 57A-57C, latch 1100 includes micro-switch 1124, the details of which generally correspond to the details of the micro-switch 124 as discussed above, except that micro-switch 1124 does not include wiper arm 160. Nonetheless, micro-switch 1124 is configured to detect rotation of drum 1130, and communicate one or more rotational positions of drum 1130 to a processor and/or controller in the vehicle. The micro-switch 1124 is configured to sense rotation of the drum 1130 based upon the interaction between a dome 1160 and curved portion 1162 (FIG. 62C) of drum 1130. The curved portion 1162 may be referred to herein as an indexing means. As an alternative to the curved portion 1162, those skilled in the art will recognize that the indexing means could be a surface, recess, marking, magnet, circuit, magnetic feature, optical feature, post, slot, pin, or a combination thereof, for example, or any other feature on the drum 1130 that can be used for tracking movement of the drum 1130. Also, the indexing means could be provided on a different or another component of the gear assembly 1106 or of the latch 1100. Finally, the at least one switch 1124 may be generally referred to as a sensor, and/or may be substituted by a rotary encoder, Hall-effect sensor, a Linear Variable Differential Transformer (LVDT), potentiometer, optical proximity sensor, transducer, eddy-current sensor, or photodiode, for example.

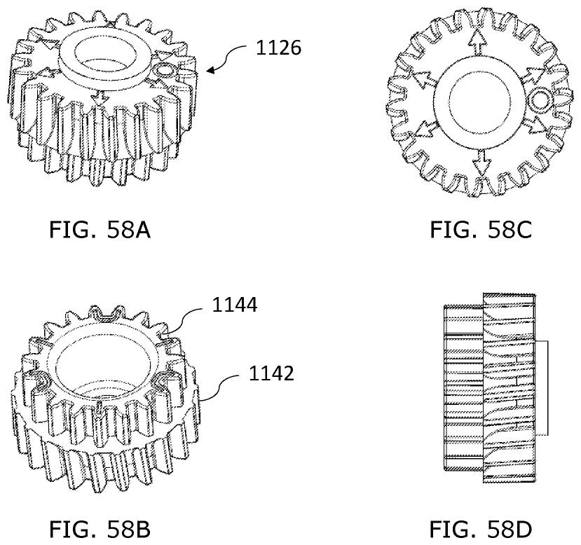

Referring now to FIGS. 58A-58D, 59A-59D, and 60A-60G, latch 1100 includes gear assembly 1106, the details of which and operation thereof generally correspond to those of the gear assembly 106, as discussed in the first embodiment above. However, gear assembly 1106 differs from the gear assembly 106 in several respects. In general, gear assembly 1106 comprises a wheel 1138, the drum 1130, and a locker 1134. Operation of the gear assembly 1106 is generally described below, and additional details of the individual components are described thereafter.

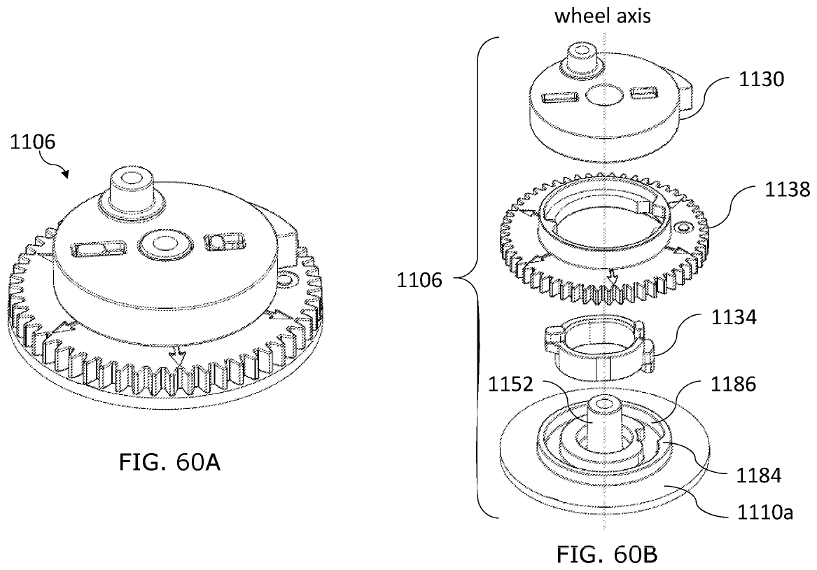

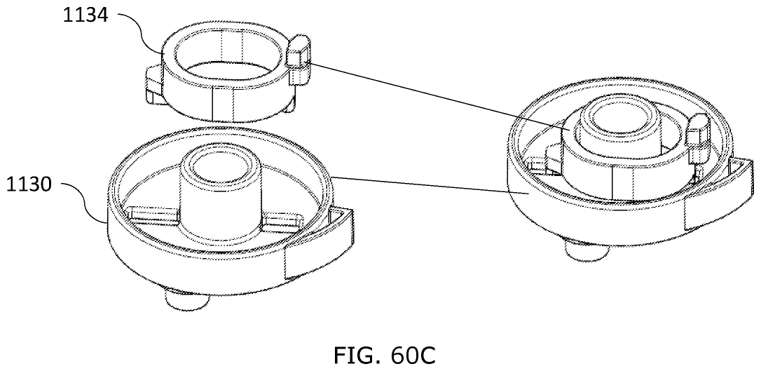

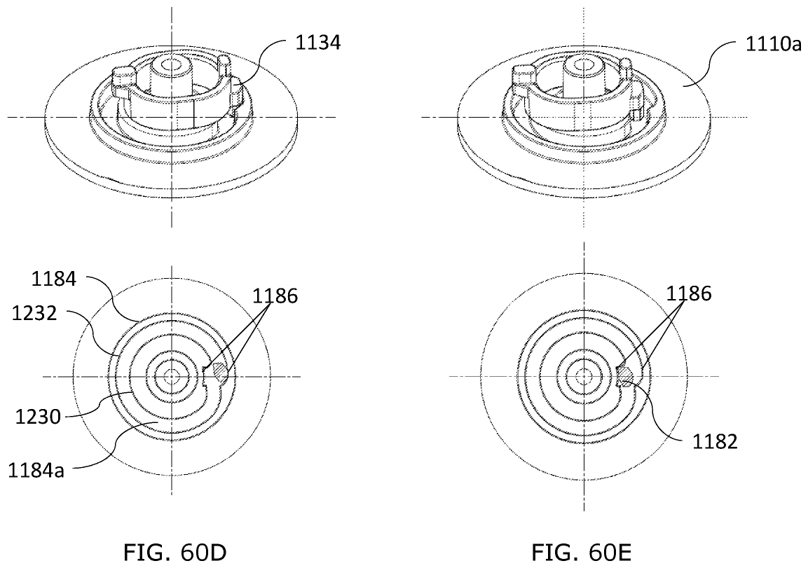

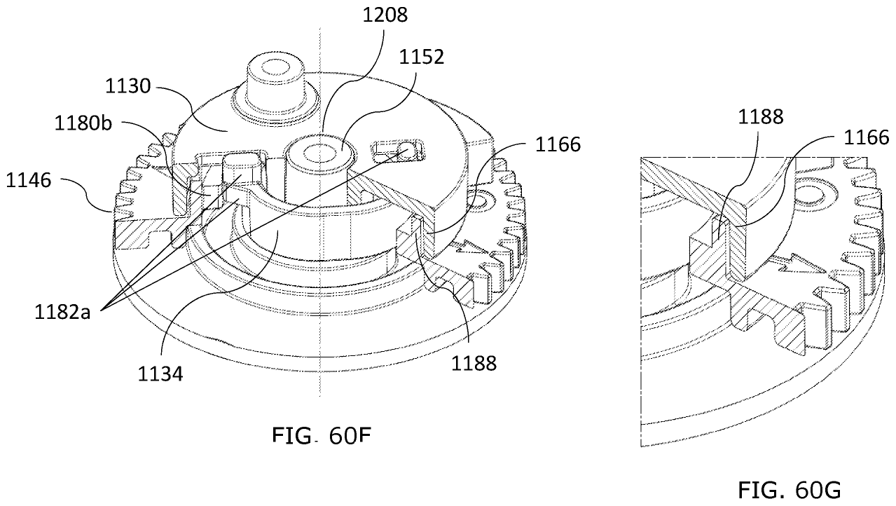

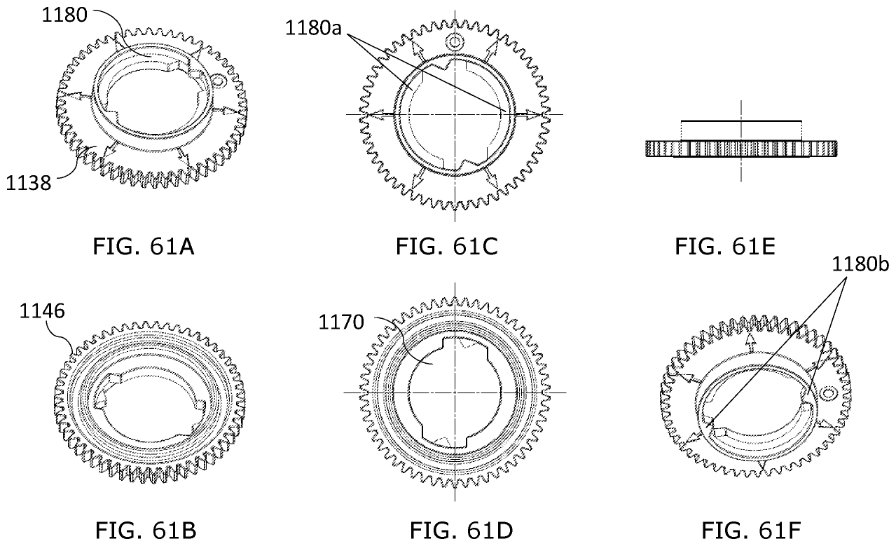

The gear assembly 1106 is configured to be driven by motor 1104. Further, the gear assembly 1106 is configured to desirably reduce or eliminate the effect of inertia of the motor 1104 on an output of the gear assembly 1106. As best illustrated in FIGS. 56A and 60B, the wheel 1138 may be engageably coupled directly or indirectly to an output shaft 1148 (fixed with worm screw 1122) of the motor 1104, the details of which generally correspond to the details of the output shaft 148 of motor 104 as discussed above. In a non-limiting example, when the wheel 1138 is configured to be engageably coupled indirectly to the output shaft 1148, latch 1100 further comprises at least one gear 1126 (FIGS. 58A-58D) interposed between the output shaft 1148 and the wheel 1138. The at least one gear 1126 is configured to be driven by the output shaft 1148. In an exemplary embodiment, worm gear 1126 is rotatably mounted to the housing 1110 by a shaft 1140 (FIG. 59B) extending upward from the housing 1110. An upper set 1142 of teeth on the worm gear 1126 is non-rotatably connected to and meshes with teeth on the worm screw 1122, such that the worm gear 1126 rotates along with the worm screw 1122. The lower set 1144 of teeth on the worm gear 1126 mesh with teeth 1146 (FIG. 61B) of the wheel 1138 (further discussed below).

In one non-limiting example, without the use of a PCB for creating a brief short circuit between the two terminals 1120 of the motor 1104 so that the motor 1104 stops almost instantaneously, the output shaft 1148 continues to rotate, thereby causing wheel 1138 to rotate in response to the motion of the output shaft 1148, for an additional non-negligible rotational amount, such as a partial or plural number of turns, due to the effect of inertia of the motor 1104. The effect of inertia of the motor 1104, e.g., the additional non-negligible number of turns, on an output of the gear assembly 1106, can vary greatly based on operating conditions of gear assembly 1106 or of latch 1100 generally.

As seen in FIGS. 59C and 60B, gear assembly 1106 also includes a housing 1110a defining an annular surface 1184. In an exemplary embodiment, housing 1110 defines annular surface 1184, such that it comprises a generally G-shaped track 1184a (FIG. 60D) having an internal side wall 1230 and an external side wall 1232. The internal and external side walls 1230/1232 may be radially disposed at an internal wall radial distance and an external wall radial distance, respectively, relative to a wheel axis (FIG. 60B), or a center of the drum 1130 (discussed further below). Further, a radially displaced portion 1186 (FIGS. 60D and 60E) of the annular surface 1184 may be displaced radially relative to the wheel axis or the center of the drum 130.

The wheel 1138 is rotatably mounted with respect to the housing 1110 by a second shaft 1152 (FIG. 59B). When the wheel 1138 is engageably coupled indirectly to the output shaft 1148 via at least one gear 1126, the wheel 1138 is configured to rotate about the wheel axis in response to movement of the at least one gear 1126 in response to motion of the output shaft 1148 of the motor 1104. Further, as illustrated in FIG. 60B, drum 1130 is rotatably mounted to the wheel 1138 and is configured to rotate about the wheel axis in response to rotation of the wheel 1138.

In operation, when the locker 1134 is in the unlocked position, locker 1134 is engaged by the wheel 1138 for rotation of the wheel 1138 and the drum 1130 together about the wheel axis. Conversely, when the locker 1134 is in the locked position, locker 1134 is disengaged from the wheel 1138 for rotation of the wheel 1138 relative to the drum 1130, thereby allowing inertial motion of the output shaft 1148 of the motor 1104 and rotation of the wheel 1138 without causing rotation of the drum 1130, and thereby reducing or eliminating the effect of inertia of the motor 1104 on the output of the gear assembly 1106.

Individual details of wheel 1138, drum 1130, and locker 1134 are discussed below and with reference to FIGS. 61A-61F, 62A-62F, and 63A-63J, respectively.

FIGS. 61A-61F depict the wheel 1138, the details of which generally correspond to the details of the wheel 138 described above. The wheel 1138 has a circular body with a set of gear teeth 1146 extending along its outer perimeter. The set of gear teeth 1146 are configured to mesh with lower set 1144 of teeth on the worm gear 1126 (FIG. 58B). A thru-hole 1170 extends through the center of the wheel 1138 and through its thickness. In an assembled form of the gear assembly 1106 (as shown in FIGS. 60A-60B), shaft 1152 passes through the hole 1170 of wheel 1138 and opening 1208 of drum 1130, for mounting the wheel 1138 and the drum 1130 within the enclosure 1102.

However, wheel 1138 differs from the wheel 138 described above in some respects. In one example, wheel 1138 may not require reinforced ribs, such as ribs 168 described above. In another example and as best illustrated in FIGS. 60F-60G, a side wall 1188 of wheel 1138 is configured to engage with an exterior of the rear surface 1166 of drum 1130 when at least side wall 1188 of wheel 1138 is nested within cavity 1164 of the drum 1130. In particular, the smooth interface between wheel 1138 and the drum 1130 via the engagement between side wall 1188 of the wheel 1138 and the exterior of the rear surface 1166 is configured to cause drum 1130 to rotate about the wheel axis in response to motion of the wheel 1138. Additionally or optionally, the smooth interface between wheel 1138 and the drum 1130 via the engagement between side wall 1188 of the wheel 1138 and the exterior of the rear surface 1166 desirably allows the wheel 1138 to continue to rotate relative to the drum 1130, even when the drum 1130 is immobilized (by the locker 1134).

In another respect, the wheel 1138 has a radial surface 1180 defined by hole 1170, and at least a portion of radial surface 1180 is configured to interact with at least protrusion 1182a of the locker 1134 (discussed further below). This interface between the radial surface 1180 and upper ring portion having protrusion 1182a of the locker 1134 facilitates the movement of the locker 1134 between unlocked and locked positions. As best seen in FIGS. 61A and 61F, radial surface 1180 may include a pair of ledges 1180a, each of which extend radially inward from side wall 1188 and along an arc length, such that the ledges 1180a are spaced apart relative to each other. Additionally or optionally, radial surface 1180 may include one or more detents 1180b which extend radially inward from side wall 1188 and disposed diametrically opposite each other. In another example and as best illustrated in FIGS. 60F-60G, a side wall 1188 of wheel 1138 is configured to engage with an exterior of the rear surface 1166 of drum 1130 when at least side wall 1188 of wheel 1138 is nested within cavity 1164 of the drum 1130. In particular, the smooth interface between the locker 1134 and the wheel 1138 via the engagement between detent 1180b of the wheel 1138 and the protrusions 1182a of the locker 1134 is configured to facilitate the rotation of drum 1130 about the wheel axis in response to motion of the wheel 1138. Additionally or optionally, the smooth interface between the locker 1134 and the wheel 1138 via the engagement between detent 1180b of the wheel 1138 and the protrusions 1182a of the locker 1134 desirably permits the drum 1130 to be immobilized by the locker 1134 when the locker 1134 is in the locked position, and the drum 1130 to move in response to the motion of the wheel 1138 when the locker 1134 is in the unlocked position.

The radial surface 1180 further comprises a side wall 1174 that is disposed at a first radial distance relative to the wheel axis, or the center of the shaft 1152. The side wall 1188 is disposed at a second radial distance relative to the wheel axis, or the center of the shaft 1152, such that the first radial distance is greater than the second radial distance. The sidewall 1174 and the side wall 1188 together form at least one recess 1172 formed between a pair of ledges 1180a. At least a portion of protrusion 1182c of the locker 1134 moves within the recess 1172 of the wheel 1138, when the locker 1134 is in the unlocked position. Further, at least a portion of the pin 1182b is positioned adjacent the radially displaced portion 1186 (FIGS. 60D and 60E) of the annular surface 1184, when the locker 1134 is in the unlocked position. Conversely, when the locker 1134 is in the locked position, at least a portion of protrusion 1182c engages with side wall 1188 of the wheel 1138 and thus is positioned outside the recess 1172 of the wheel 1138.

FIGS. 62A-62F depict the drum 1130, the details of which generally correspond to the details of the drum 130 above. The drum 1130 has a circular body and the rear surface 1166 defines a cavity 1164, as shown in FIG. 60C. However, drum 1130 differs from the drum 130 described above in some respects. The rear surface 1166 further defines a shaft 1190 around which the body 1192 of the locker 1134 curves around when the latch 1100 is assembled (as best shown in FIGS. 60B, 60C, and 60F). Further a front surface opposite the rear surface 1166 defines a plurality of openings 1130a. The openings 1130a may be configured to receive a portion of the respective protrusions 1182a of locker 1134 when the latch 1100 is assembled (as best shown in FIGS. 60A and 60F).

As stated above, the drum 1130 is rotatably mounted to the wheel 1138, such that the rear surface 1166 generally corresponds to the shape and configuration of the wheel 1138. As best illustrated in FIG. 60F, at least side wall 1188 of the wheel 1138 is configured to be nested within cavity 1164 defined by drum 1130. Still further, the center of the drum 1130 defines an opening 1208, through which shaft 1152 may pass for rotatably mounting the drum 1130 to the wheel 1138 and for mounting the drum 1130 within the enclosure 1102.

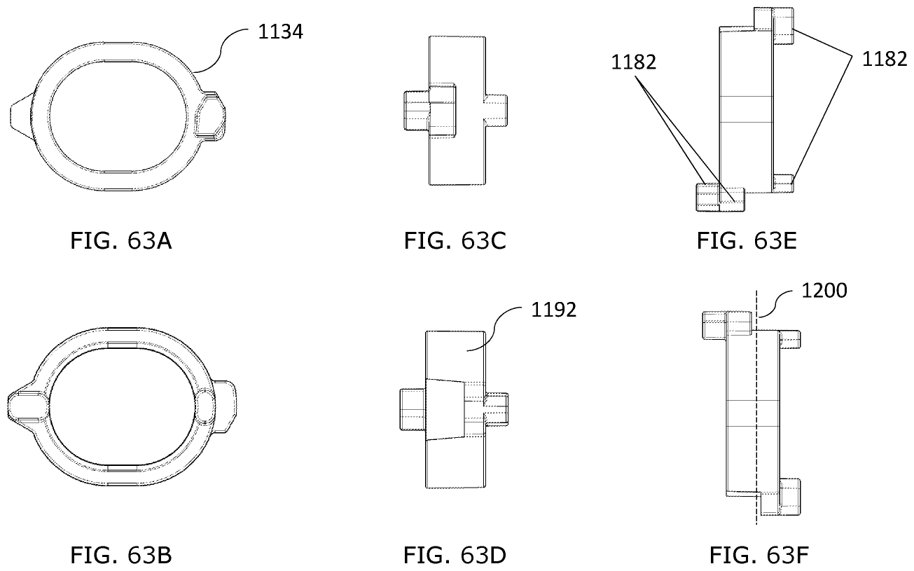

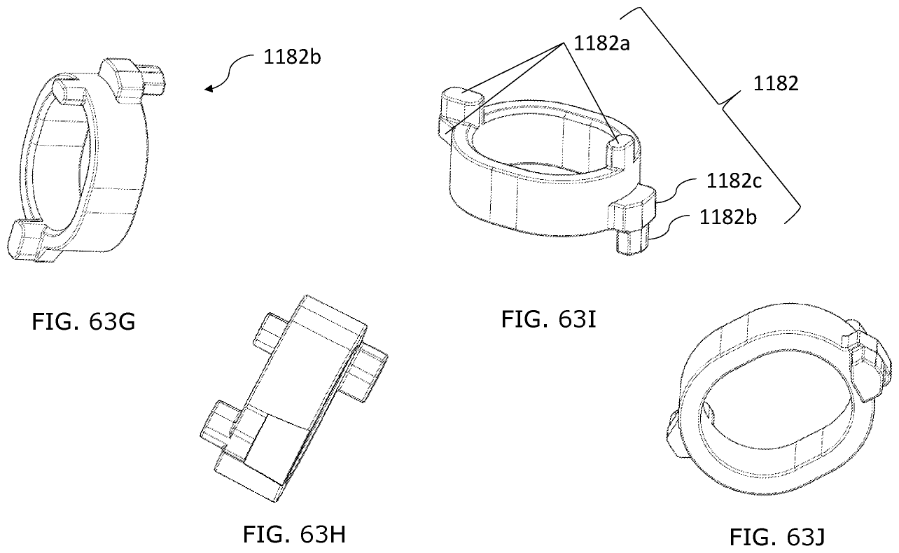

FIGS. 63A-63J depict the locker 1134. The locker 1134 is mounted for movement relative to the drum 1130. As best shown in FIGS. 63A-63J, the locker 1134 may generally comprise a ring-shaped body 1192 configured to curve around or surround the shaft 1152. However, when the gear assembly 1106 is assembled, the ring-shaped body 1192 loosely curves around the shaft 1152, such that as the drum 1130 rotates around the wheel axis, the ring-shaped body 1192 of the locker 1134 both rotates and is moveable radially relative to the shaft 1152. The locker 1134 further comprises a plurality of protrusions 1182, which may extend upward relative to the ring-shaped body 1192 and/or radially outward relative to the ring-shaped body 1192. Further, relative to each other, the plurality of protrusions 1182 may be positioned and extend in opposing directions from the ring-shaped body. The plurality of protrusions 1182 may comprise protrusions 1182a, pin 1182b, and protrusion 1182c. One skilled in the art would understand from the description herein that locker 1134 may have a different size and geometry based on one or more components of the gear assembly 1106 or of the latch 1100.

Likewise, one skilled in the art would understand from the description herein that the size, shape, and placement of the protrusions 1182 may correspond to the shape and geometry of one or more component of the latch 1100. The plurality of protrusions 1182 may be irregularly shaped, and/or may have surfaces or portions thereof that correspond or conform to the shape, size, and surface of one or more of the components of the latch 1100 (e.g. the drum 1130, the wheel 1138, etc.). Similarly, the locations of protrusions 1182 as shown in FIGS. 63A-63J are not intended to be limiting, such that the locations of the plurality of protrusions 1182 may depend on the shape of, size of, surface of, and/or interfaces between one or more of the components of the latch 1100 (e.g. the drum 1130, the wheel 1138, etc.).

Further, with reference to FIG. 63F and for the purposes of explanation, a dashed line 1200 may form a bisection along a full circumference of the ring-shaped body 1192 of locker 1134, thereby creating an upper ring portion of the locker 1134 with protrusions 1182a and a lower ring portion of the locker 1134 with protrusion 1182c and pin 1182b (FIG. 631). It should be noted here that the term “bisect” is intended to mean that the dashed line divides the locker 1134 into two sections, but those sections are not necessarily equal in size. Finally, although FIGS. 63A-63J show the ring-shaped body 1192 and protrusions 1182 as being integrally formed, one of ordinary skill in the art wound understand that the protrusions 1182 may be separate components from body 1192 and/or may be integrally formed with another component of the gear assembly 1106 and latch 1100.

In one non-limiting example, pin 1182b extends downwardly from protrusion 1182c (as shown in FIG. 63I). Additionally, the pin 1182b is positioned adjacent the annular surface 1184 of the housing 1110a. As seen in FIG. 60C, at least a portion of locker 1134 is positioned within the cavity 1164 (FIG. 62B) defined by the rear surface 1166 (FIG. 62D) of the drum 1130. In particular, as seen in FIG. 60D and 60E, locker 1134 is configured to rotate about the wheel axis in response to motion of the wheel 1138. More specifically, at least a portion of locker 1134 is configured to travel along the annular surface 1184 of the housing 1110a. In addition, the locker 1134 is movable between the unlocked position (FIG. 60D), in which the locker 1134 does not restrict the ability of the drum 1130 to rotate about the wheel axis in response to rotation of the wheel 1138, and the locked position (FIG. 60E), in which the locker 1134 restricts the ability of the drum 1130 to rotate about the wheel axis in response to rotation of the wheel 1138. Movement of the locker 1134 between the unlocked and locked positions is facilitated by the radially displaced portion 1186 of the annular surface 1184 (discussed below).

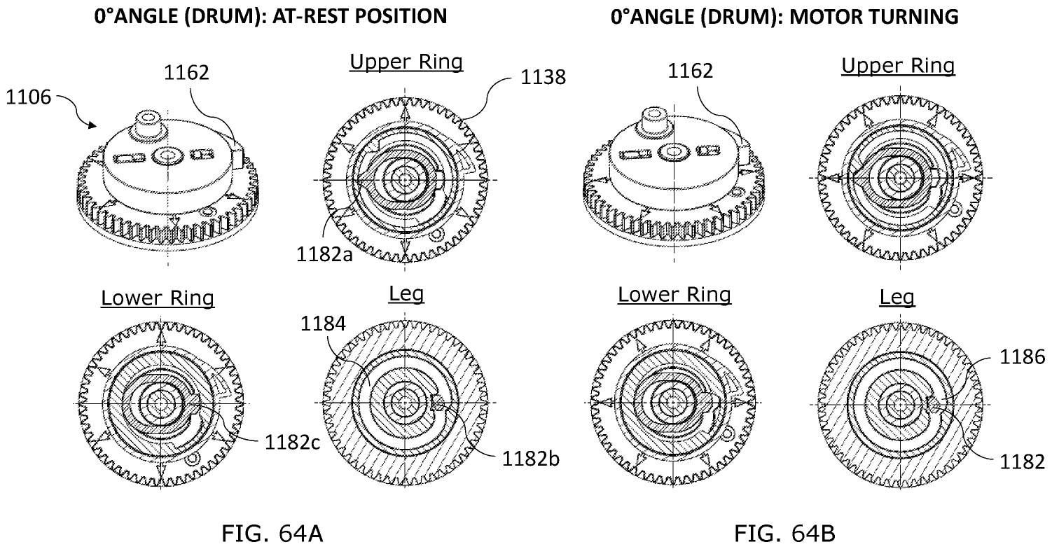

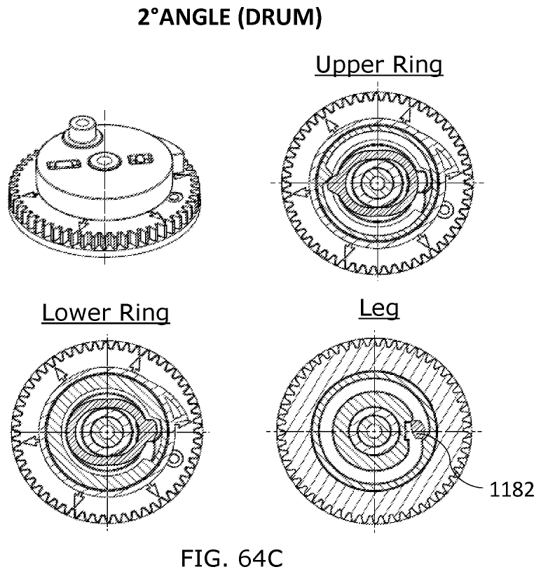

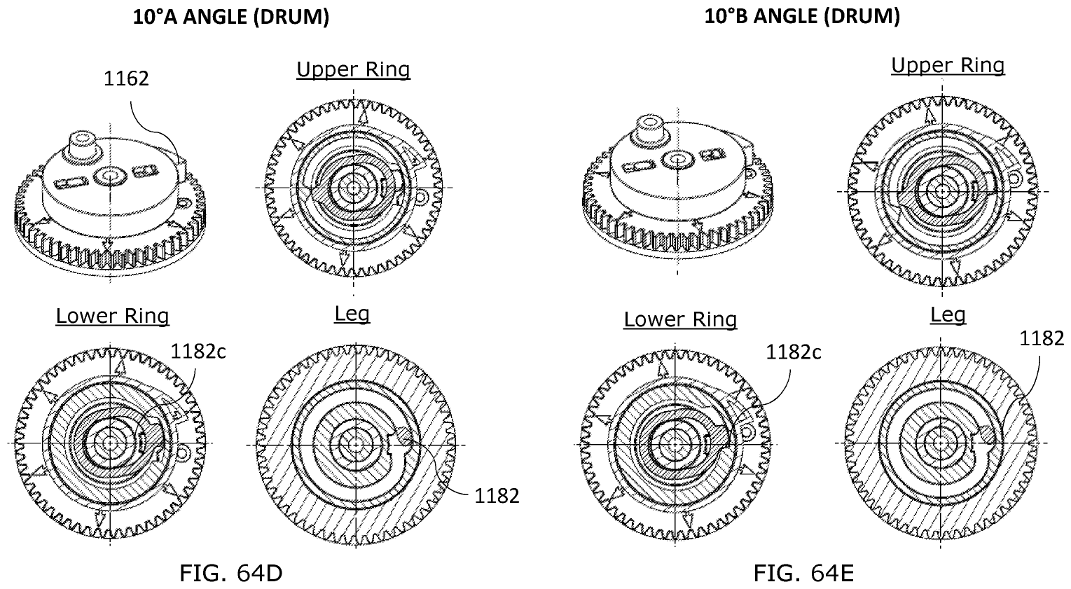

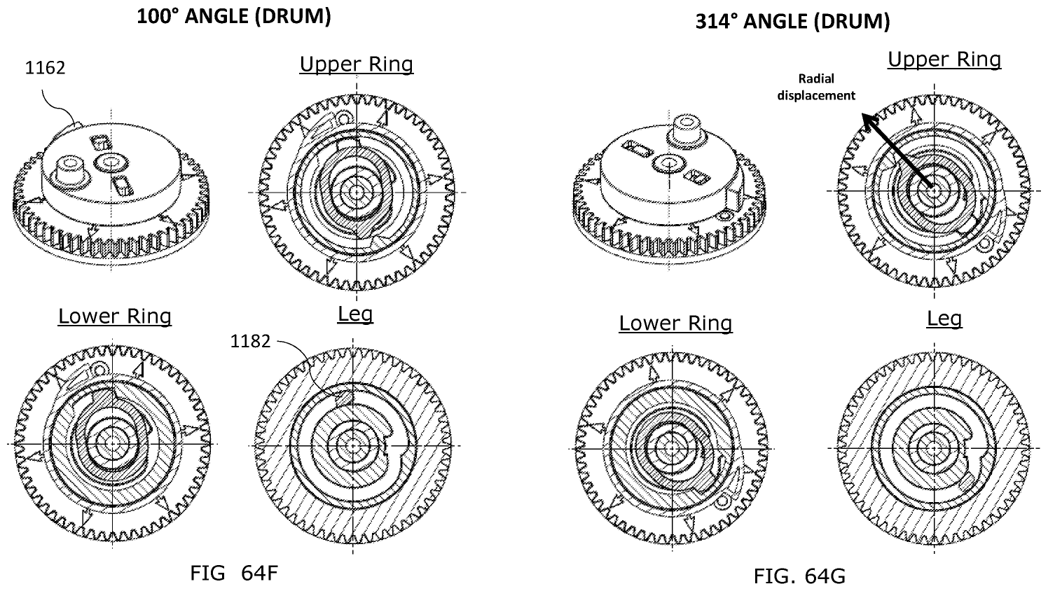

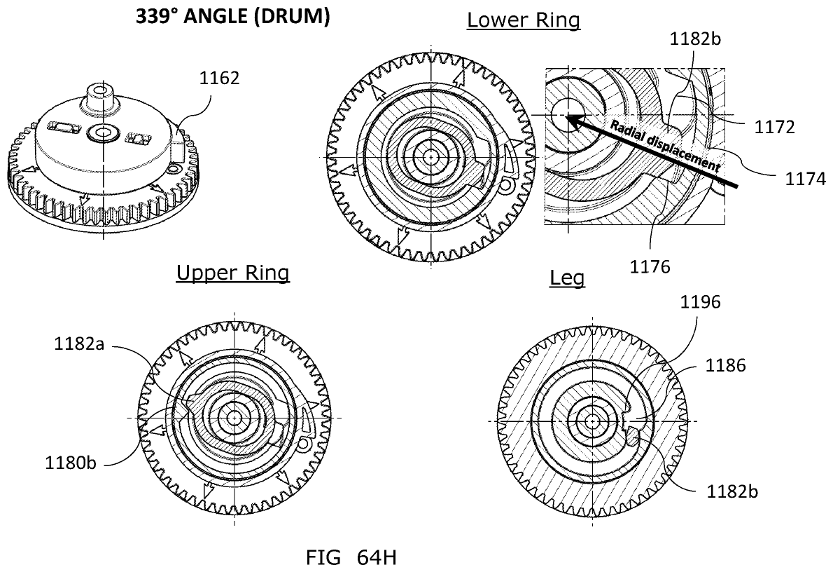

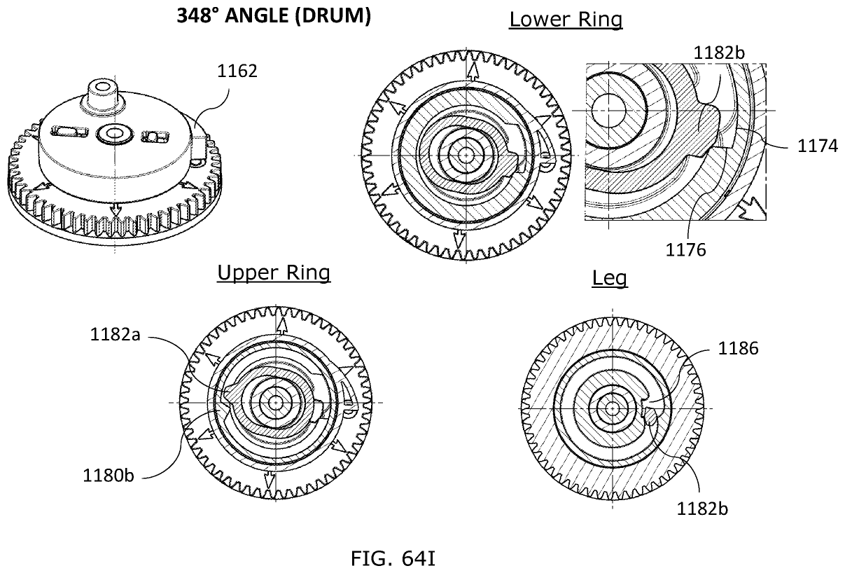

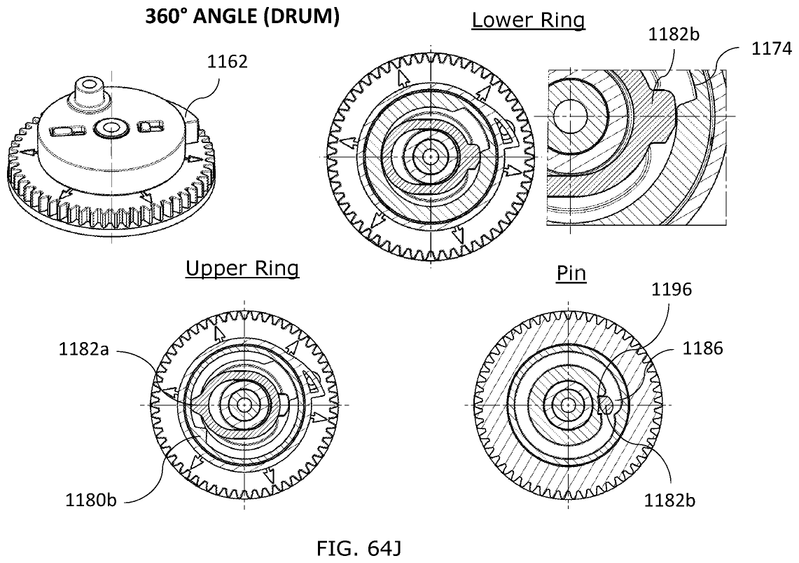

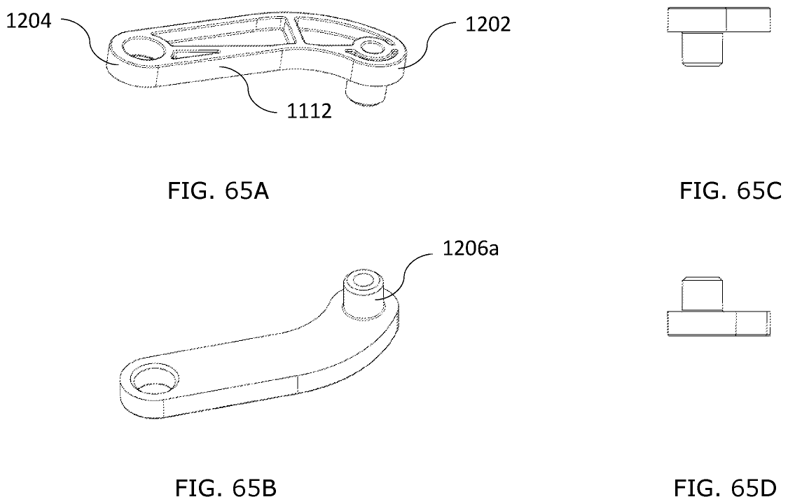

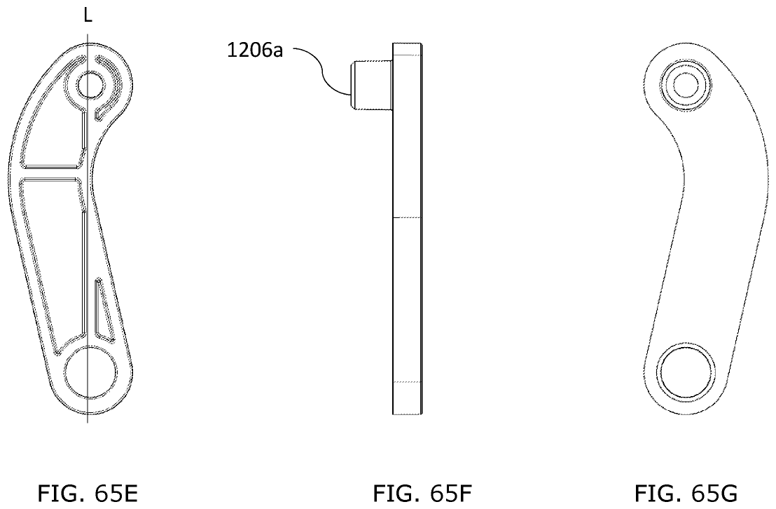

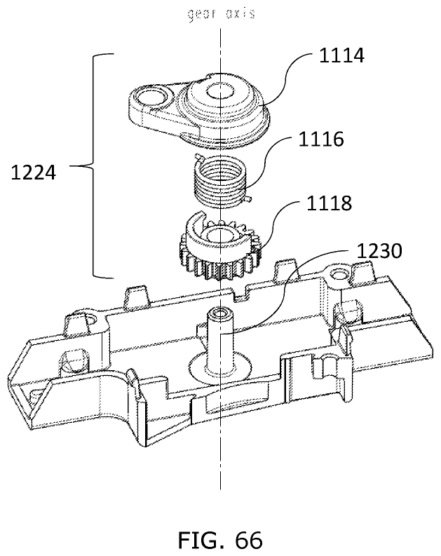

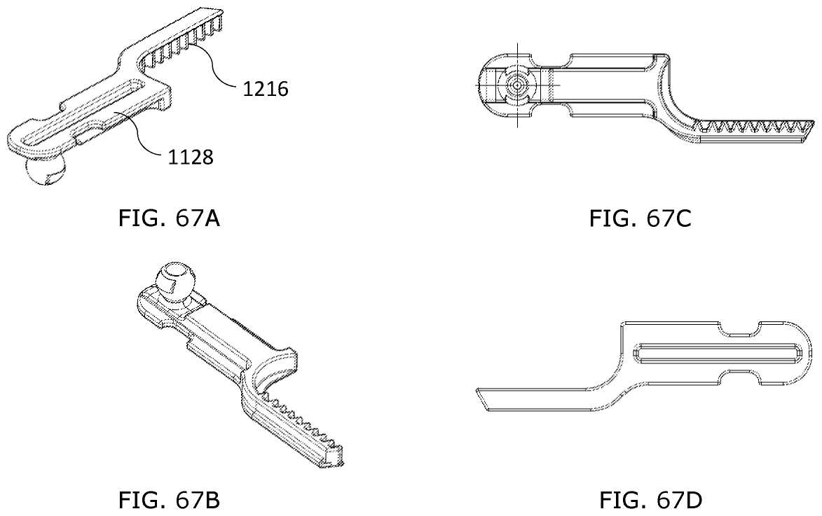

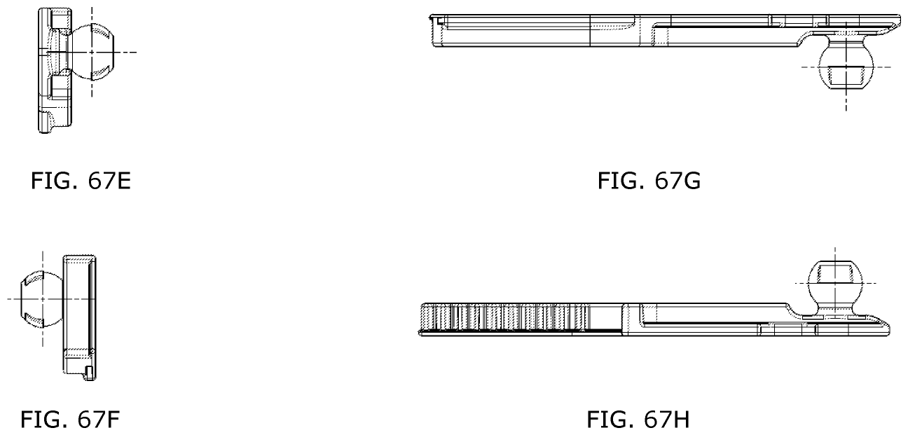

Turning now to FIGS. 64A-64J, the operation of the gear assembly 1106 is illustrated. The operation of the gear assembly 1106 is generally similar to the operation of gear assembly 106, as described above, except for some differences which are discussed below. The operation of the gear assembly 1106 is discussed with respect to the drum 1130 being angularly displaced for a full revolution (360°), but one skilled in the art would understand that the drum 1130, may rotate for a partial (e.g. a half turn, ⅓ turn, etc.) revolution.

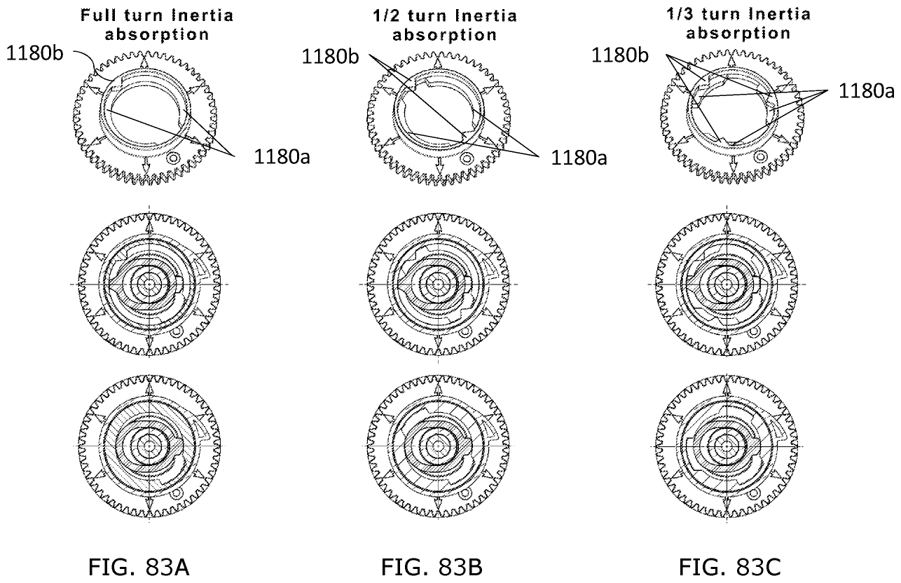

When motor 1104 is activated for opening the latch 1100, for example, the rotatable output shaft 1148 is actuated. This motion may be transferred to one or more components of the gear assembly 1106, such as for example, causing wheel 1138 to rotate around the wheel axis. In response to this motion of the wheel 1138 caused by the activation of the motor 1104, the drum 1130 is also configured to rotate about the wheel axis because it is rotatably mounted to the wheel 1138. The rotation of the drum 1130 is sensed by micro-switch 1124 based upon the interaction between the dome 160 and curved portion 1162 (FIG. 62C) of drum 1130. Specifically, the motor 1104 rotates the drum 1130 by full revolution and along a single direction (counter-clockwise or clockwise), as sensed and permitted by the switch 1124. As shown in FIGS. 83A-83C, the variable power of the motor 1104 may require adjustment of one or more components of latch 1100, such as the radial surface 1180 of the wheel 1138. As shown in FIG. 83A, gear assembly 1106 having a drum 1130 that is angularly displaced for a full revolution in one use cycle, may include a wheel 1138 having a radial surface 1180 having a detent 1180b and a pair of ledges 1180a. Once the dome 1160 of the switch 1124 engages with the curved portion 1162 of drum 1130 and therefore detects a full revolution of the drum 1130, the switch 1124 consequently deactivates the supply of power to the motor 1104. However, the output shaft 1148 of the motor 1104 may continue to rotate, thereby causing wheel 1138 of FIG. 83A to rotate in response to the motion of the output shaft 1148, for partial or plural number of turns, due to the effect of inertia of the motor 104. In particular, the wheel 1138 of FIG. 83A may rotate for an additional full revolution due to the effect of inertia of the motor 104. For a gear assembly 1106 having a drum 1130 that is angularly displaced for a full revolution in one use cycle, as shown in FIG. 83B, the wheel 1138 may include a radial surface 1180 having a pair of detents 1180b and a pair of ledges 1180a. Once the dome 160 of the switch 1124 engages with the curved portion 1162 of drum 1130 and therefore detects a full revolution of the drum 1130, the switch 1124 consequently deactivates the supply of power to the motor 1104. However, the output shaft 1148 of the motor 1104 may continue to rotate, thereby causing wheel 1138 of FIG. 83B to rotate in response to the motion of the output shaft 1148, for partial or plural number of turns, due to the effect of inertia of the motor 104. In particular, the wheel 1138 of FIG. 83B may rotate for an additional partial revolution (e.g. half turn) due to the effect of inertia of the motor 104. For a gear assembly 1106 having a drum 1130 that is angularly displaced for full revolution in one use cycle, as shown in FIG. 83C, the wheel 1138 may include the radial surface 1180 having three detents 1180b and three corresponding ledges 1180a. Once the dome 160 of the switch 1124 engages with the curved portion 1162 of drum 1130 and therefore detects a full revolution of the drum 1130, the switch 1124 consequently deactivates the supply of power to the motor 1104. Additionally or optionally, the output shaft 1148 of the motor 1104 may continue to rotate, thereby causing wheel 1138 of FIG. 83C to rotate in response to the motion of the output shaft 1148, for partial or plural number of turns, due to the effect of inertia of the motor 104. In particular, the wheel 1138 of FIG. 83C may rotate for an additional partial revolution (e.g. ⅓ turn) due to the effect of inertia of 20 the motor 104.

However, the wheel 1138 is allowed to continue rotate without causing rotation of the drum 1130, thereby allowing inertial motion of the output shaft 1148 of the motor 1104 and thereby reducing or eliminating the effect of inertia of the motor 1104 25 on the output of the gear assembly 1106. As will be discussed in further detail below, the wheel 1138 is allowed to rotate without causing rotation of the drum 1130, based on the arrangement or interface of the locker 1134 and its interactions with one or more components of the gear assembly 1106, e.g. wheel 1138 and drum 1130.

As stated above, the locker 1134 is mounted for movement relative to at least the drum 1130. As shown, for example, in FIGS. 64A-64J, the locker 1134 is configured to travel for an angular displacement of the drum 1130 in response to motion of the wheel 1138. In particular, as illustrated in FIGS. 64A-64G, the radial distance of the annular surface 184, relative to the wheel axis or the center of the shaft 1152, is constant. Therefore, the radial distance of the pin 1182b relative to the wheel axis or the center of the shaft 1152 is constant, as the locker 1134 moves within a range of angular displacement between 0° to 314°.

Movement of the locker 1134 is illustrated in FIGS. 64A-64J by way of showing a cross-section of various portions of the locker 1134, including the upper ring portion having protrusions 1182a and a portion of protrusion 1182c, as well as lower ring portion having a portion of protrusion 1182c and the pin 1182b, as the locker 1134 travels along the annular surface 1184 of the housing 1110a. However, when the gear assembly 1106 is assembled, the ring-shaped body 1192 loosely curves around the shaft 1152, such that as the drum 1130 rotates around the wheel axis, the ring-shaped body 1192 of the locker 1134 both rotates around the wheel axis and is moveable radially relative to the shaft 1152.

In particular, the movement of locker 1134 between locked and unlocked positions is facilitated by the rotatable and radially moveable ring-shaped body 1192 of the locker 1134. The movement of the radially moveable ring-shaped body 1192 is facilitated by partial engagement, full engagement, and/or non-engagement between two or more components of the locker 1134, the drum 1130, and/or the wheel 1138. More specifically, the movement of the radially moveable ring-shaped body 1192 is facilitated by the interaction between the radial surface 1180 of the wheel 1138 and one or more components of the locker 1134. Details of the operation of the gear assembly 1106 are discussed further below.

Referring now to FIG. 64A, when the drum 1130 is at rest position (e.g. the angular displacement of the drum 1130 is at 0°), the protrusion 1182a abuts a portion of the side wall 1188 of the wheel 1138 and sits adjacent one of the pair of ledges 1180a of the wheel 1138. When the protrusion 1182a is in this position, the pin 1182b is adjacent stop surface 1196 (FIG. 64H) and the protrusion 1182c abuts another portion of the side wall 1188 of the wheel 1138. When the pin 1182b is radially displaced such that it is adjacent the stop surface 1196, the locker 1134 is in the locked position, in which the locker 1134 restricts the ability of the drum 1130 to rotate about the wheel axis in response to rotation of the wheel 1138. For example, the locker 1134 reaches this locked position just before the drum 1130 is angularly displaced by a full revolution, e.g. between 350° and 360°. Turning now to FIG. 64B, when the drum 1130 is at rest position (e.g. the angular displacement of the drum 1130 is at 0°) and the motor 1104 is activated, the wheel 1138 rotates around the wheel axis along one direction (e.g. counter-clockwise), which causes the drum 1130 to rotate around the wheel axis in the same direction. The rotation of the wheel 1138 moves detent 1180b toward partial or full engagement with protrusion 1182a of locker 1134. As can be seen by comparing FIGS. 64B and 64C, as the protrusion 1182a starts to engage (partially or completely) with a surface of detent 1180b, the ring-shaped body 1192 of the locker 1134 starts to move radially relative to the shaft 1152. As the ring-shaped body 1192 is moved by the interface between protrusion 1182a and detent 1180b, protrusion 1182c is pushed toward side wall 1174 of the wheel 1183. Simultaneously, as the ring-shaped body 1192 moves, pin 1182b starts to be guided away from stop surface 1196 and starts to travel within radially displaced portion 1186.

Referring now to FIGS. 64D and 64E, when the drum 1130 reaches an angular displacement of the drum 1130 at 10°, the protrusion 1182a abuts a peak portion of detent 1180b. The peak portion of detent 1180b extends radially inward, so when protrusion 1182a abuts the peak portion of detent 1180b, the ring-shaped body 1192 of the locker 1134 moves radially relative to the shaft 1152, such that protrusion 1182c abuts a portion of side wall 1174 of the wheel 1183 and then moves within the space defined by recess 1172 (FIG. 64H), until protrusion 1182c abuts both another portion of side wall 1174 and another portion of side wall 1188 (e.g. surface 1176 in FIG. 64H). Simultaneously, as the ring-shaped body 1192 moves, pin 1182b starts to be guided away from radially displaced portion 1186 so it can travel along track 1184 of housing 1110a defined by the internal side wall 1230 and external side wall 1232 (FIG. 60D), as the drum 1130 rotates around the wheel axis. In this way, the locker 1134 moves radially relative to the shaft 1152 toward the unlocked position, such that at least the pin 1182b of the locker 1134 moves away from the radially displaced portion 1186 of the annular surface 1184 and starts to travel along track 1184 of housing 1110a.

Referring now to FIGS. 64F-64G, the pin 1182b of the locker 1134 is maintained at a constant radial distance relative to the wheel axis, or the center of the shaft 1152. More specifically, FIGS. 64F-64G show the pin 1182b is at a constant radial distance relative to the wheel axis, or the center of the shaft 1152, when the locker 1134 is moved (in response to motion of the drum 1130) for an angular displacement between 10° and 314°.

Turning now to FIGS. 64H-64I, as the locker 1134 moves within a range of angular displacement between 330° to 355°, such as between 339° to 348° more specifically, the locker 1134 is guided away from the side wall 1174 of the wheel 1138. In particular, the surface 1176 (FIG. 64H) of the wheel 1138 causes the protrusion 1182c to be moveable axially and along a radial displacement direction for a distance toward the locked position. The distance may be up to 1.5 mm, for example, along the radial displacement direction relative to the sidewall 174 of the wheel 1138, as shown in FIG. 64H. When the locker 1134 is in the locked position, the locker 1134 restricts the ability of the drum 1130 to rotate about the wheel axis in response to rotation of the wheel 1138. In this way, the G-shaped track 1184 of housing 1110a guides the movement of the locker 1134, such that as locker 1134 moves within a range of angular displacement between 339° to 348°, the locker 1134 is guided toward the locked position.

As shown in FIG. 64J, when the locker 1134 is in the locked position, the pin 1182b of the locker 1134 is prevented by stop surface 1196 of the radially displaced portion 1186 from moving in response to motion of the wheel 1138. When the locker 1134 is prevented from moving in response to motion of the wheel 1138, the drum 1130 is thereby prevented from moving and the wheel 1138 is allowed to continue to rotate in response to the inertial motion of the motor 1104, without causing the drum 1130 to rotate. This thereby reduces or eliminates the effect of inertia of the motor 1104 on an output of the gear assembly 1106.

Then, after the wheel 1138 is prevented from moving in response to inactivation of the motor 1104, for example, and when the motor 1104 is subsequently activated for a subsequent use cycle, the locker 1134 is configured to move back toward the unlocked position, in which the locker 1134 does not restrict the ability of the drum 1130 to rotate about the wheel axis in response to rotation of the wheel 1138. Thus, when rotation of wheel 1138 stops, in response to inactivation of the motor 1104, for example, the locker 1134 is retained in the locked position, and when the motor 1104 is subsequently actuated to begin a new use cycle, the wheel 1138 rotates in response to the activation of the motor 1104 and the locker 1134 is moved toward the unlocked position in response to movement of the wheel 1138, as discussed above.

It should be understood that the above description of operating the gear assembly 1106 is not limited to any step or sequence of steps, and may vary from that which is shown and described without departing from the scope and spirit of the invention.

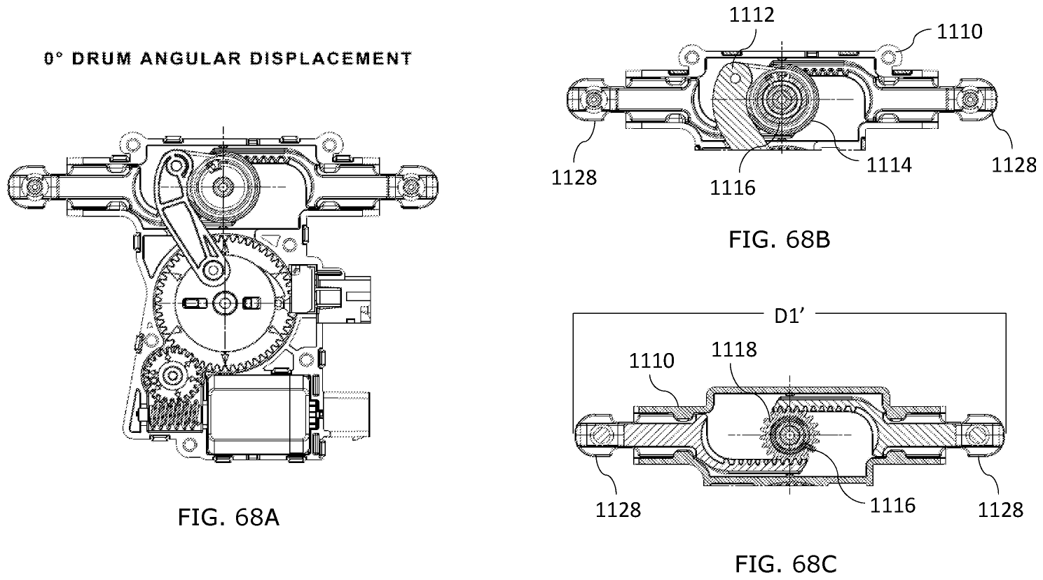

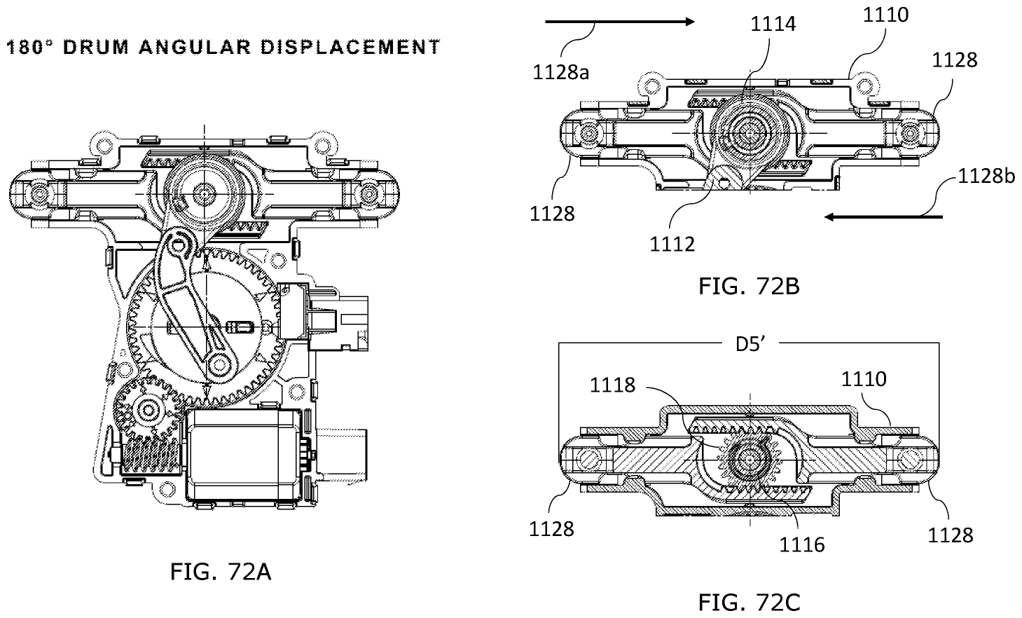

At a particular angular displacement of the drum 1130 (discussed below with reference to FIGS. 68A-68C, 69A-69C, 70A-70C, 71A-71C, and 72A-72C), movement of a lever 1112, the details of which and operation thereof are generally similar to those of lever 112 discussed above, causes the at least one pawl 1128 to move toward the withdrawn or retracted position relative to the housing 1110 or enclosure 1102. The at least one pawl 1128 is withdrawn or retracted until the at least one pawl 1128 reaches the unlocked position, at which point the latch 1100 is in the unlatched state and a door, such as a glove box door, can be opened. In particular, as illustrated in FIGS. 72A-72C, the latch 1100 is in the unlatched state when the angular displacement of the drum reaches 180, because at this degree of angular displacement, the at least one pawl 1128 is configured to be disengaged from the strikers (not shown) and another component, such as a bumper in the glove box, for example, pushes the door or lid open. The degree of angular displacement at which the latch 1100 reaches the unlatched state may vary, based on one or more components of the latch 1100, such as motor 1104. The details of the operation of the latch 1100 toward the unlatched state based on the relationship between the angular displacement of the drum 1130, the movement of the lever 1112, and the movement of the at least one pawl 1128, is similar to that discussed above regarding the operation of the latch 100 based on movement of the drum 130, the lever 112, and the at least one pawl 128. However, differences in several respects are discussed below, including the relationship between the one or more components of at least the dissociation assembly 1224 and movement of the one or more components of at least the dissociation assembly 1224 based on angular displacement of drum 1130.

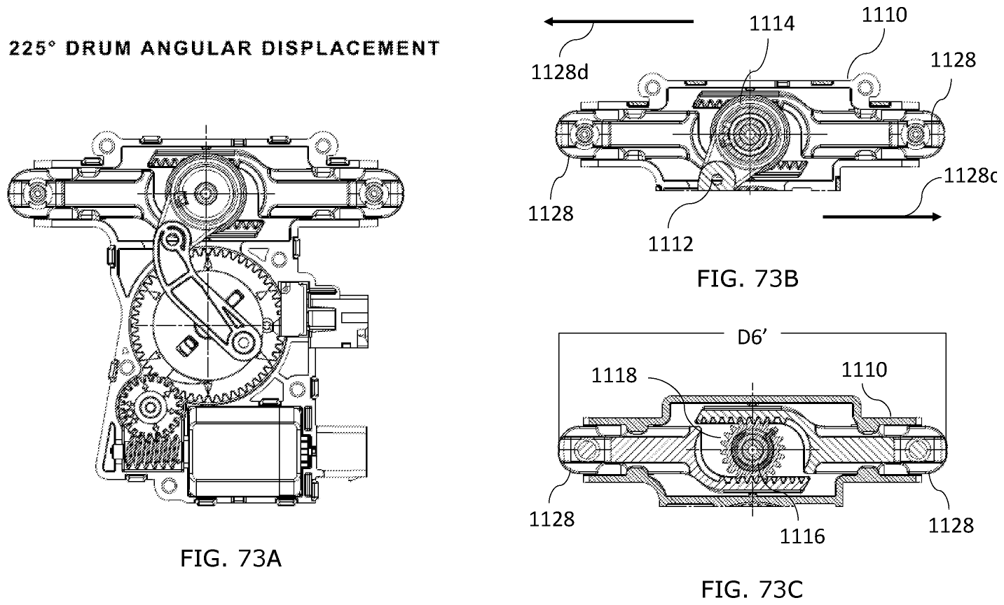

While the latch 1100 is still in this unlatched state, continued angular displacement of the drum 1130 from 180° until 360° (discussed below with reference to FIGS. 73A-73C, 74A-74C, 75A-75C, 76A-76C, 77A-77C, and 78A-78C) causes the at least one pawl 1128 to return to the locked position, which places them in a “reset” condition in preparation for another use cycle of latch 1100, such as for moving the latch 1100 back to the latched state from the unlatched state. The details of the relationship of the angular displacement of the drum 1130, the movement of the lever 1112, and the movement of the at least one pawl 1128, is similar to that discussed above regarding drum 130, lever 112, and at least one pawl 128. The details of the operation of the latch 1100 toward the “reset” condition based on the relationship between the angular displacement of the drum 1130, the movement of the lever 1112, and the movement of the at least one pawl 1128, is similar to that discussed above regarding the operation of the latch 100 based on movement of the drum 130, the lever 112, and the at least one pawl 128.

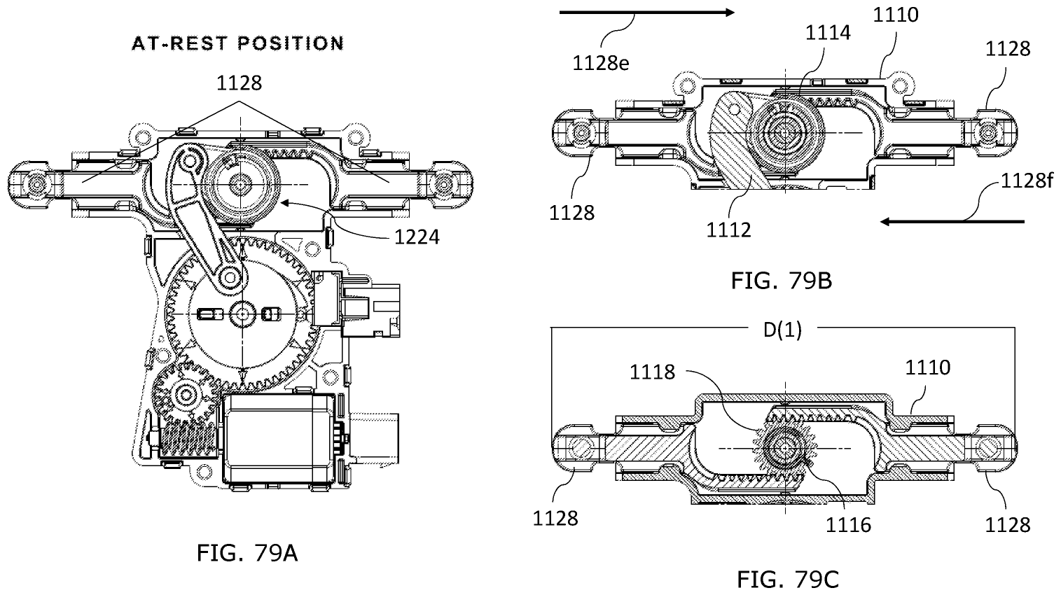

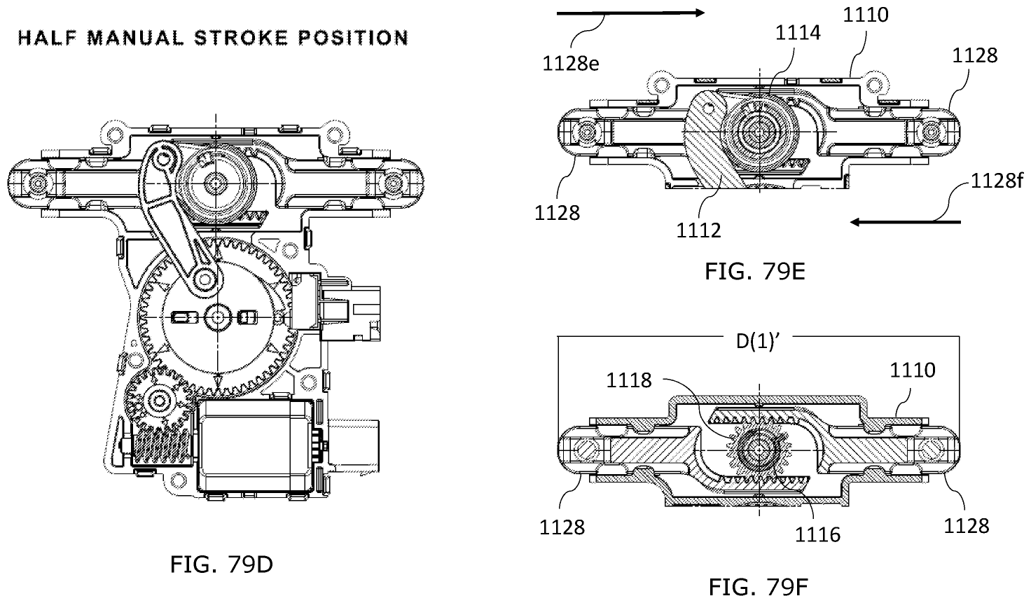

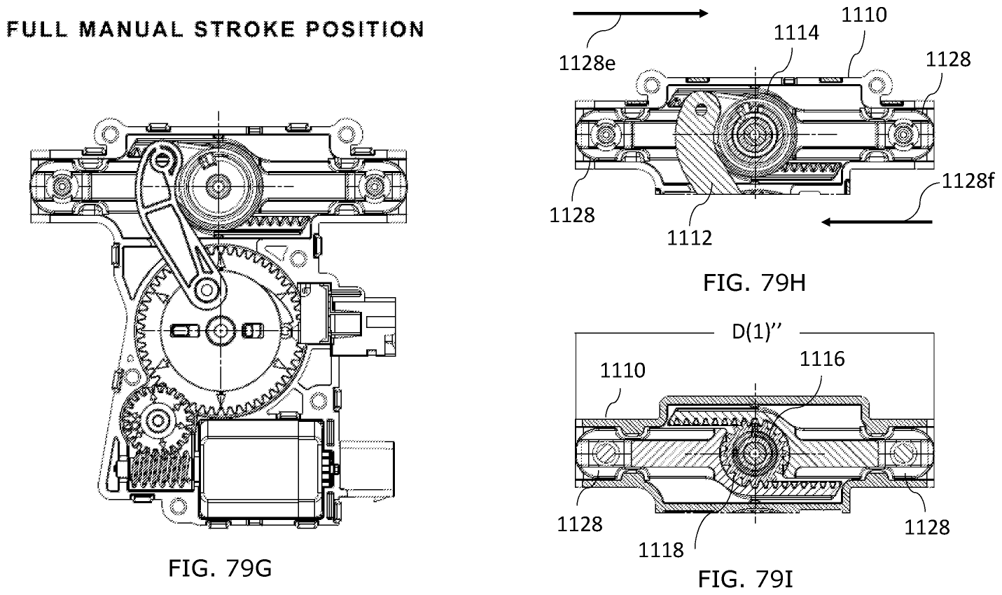

Movement of the latch 1100 toward the latched state (discussed below with reference to FIGS. 79A-79I) is achieved by manual actuation of the at least one pawl 1128 toward a withdrawn or retracted position relative to the housing 1110 until they are back in a position to engage with the strikers (not shown) and subsequently, the biasing force of torsion spring 1116, the details of which and operation therefore are generally similar to those of spring 116 discussed above, moves the at least one pawl 1128 back toward the locked position. When the at least one pawl 1128 is in the locked position, the latch 1100 is thus in the latched state. The details of the operation of the latch 1100 toward the latched state by manual actuation of the at least one pawl 1128 is similar to that discussed above regarding the operation of the latch 100 based on manual actuation of the at least one pawl 128.

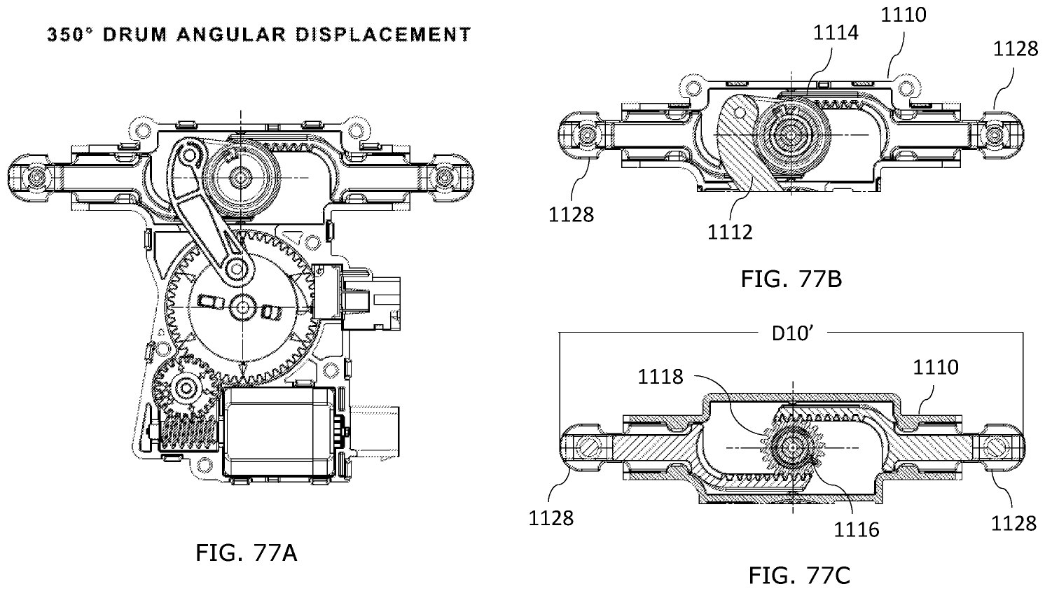

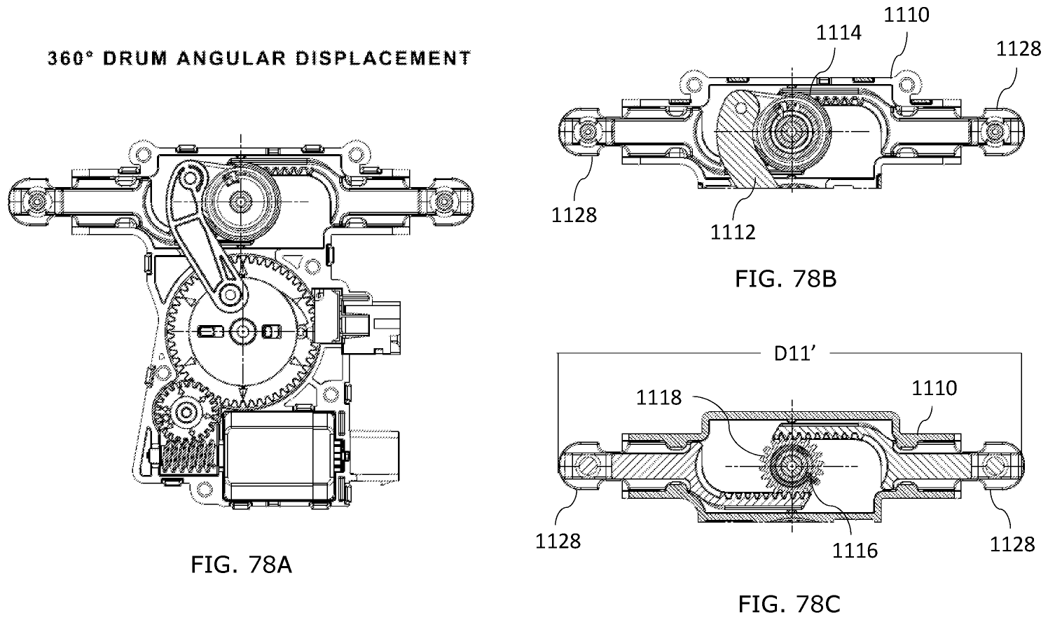

Various latch designs may require the motor to have sufficient power to overcome the biasing force of the torsion spring 1116. However, the arrangement of the dissociation assembly 1224, the details of which is similar to the dissociation assembly 224 as discussed above, allows for a motor-driven assembly, such as gear assembly 1106, to move latch 1100 to the unlatched state, by desirably requiring less power (e.g. less powerful, cheaper, thinner, and/or lighter motor 1104). This is achieved because as a driver 1114 moves in response to lever 1112, the driver 1114 causes a gear 1118 to rotate via the “wall to wall” contact between a radial surface of the gear 1118 (e.g. radial surface 220 discussed above) and a stop surface of driver 1114 (e.g. stops surface 246 discussed above). This “wall to wall” contact causes the gear 1118 to move in response to motion of the driver 1114. In this embodiment of latch 1100, the movement of gear 1118 in response to motion of driver 1114 is desirably achieved with a pre-compression of spring 1116 while it is at rest position (discussed further below with reference to FIGS. 77A-77C and 78A-78C).

Turning now to FIGS. 68A-68C, 69A-69C, 70A-70C, 71A-71C, 72A-72C, 73A-73C, 74A-74C, 75A-75C, 76A-76C, 77A-77C, and 78A-78C. these figures depict movement of components of the dissociation assembly 1224, in response to an output, e.g. motion, of the gear assembly 1106. As stated above, the dissociation assembly 1224 may be configured to facilitate the motor-driven opening of the at least one pawl 1128, such that motion of the lever 1112 in response to motion of the drum 1130 causes the driver 1114 to move, thereby moving the at least one pawl 1128 to move toward an unlocked position and therefore moving latch 1100 toward the unlatched state.

As stated above, the drum 1130 is configured to travel for an angular displacement in response to motion of the wheel 1138. As shown in FIGS. 68A-68C, the driver 1114 is immobilized in a locked or rest position, as determined by the arrangement of the lever 1112, which is connected to gear assembly 1106, when the motor 1104 is inactive (and therefore provides no output from the gear assembly 1106). Further, an end portion of one of the at least one pawl 1128 and another end portion of the another of the at least one pawl 1128 are in an extended position relative to housing 1110 for a distance (D1′). In an exemplary embodiment, D1′ is 129.08 mm.

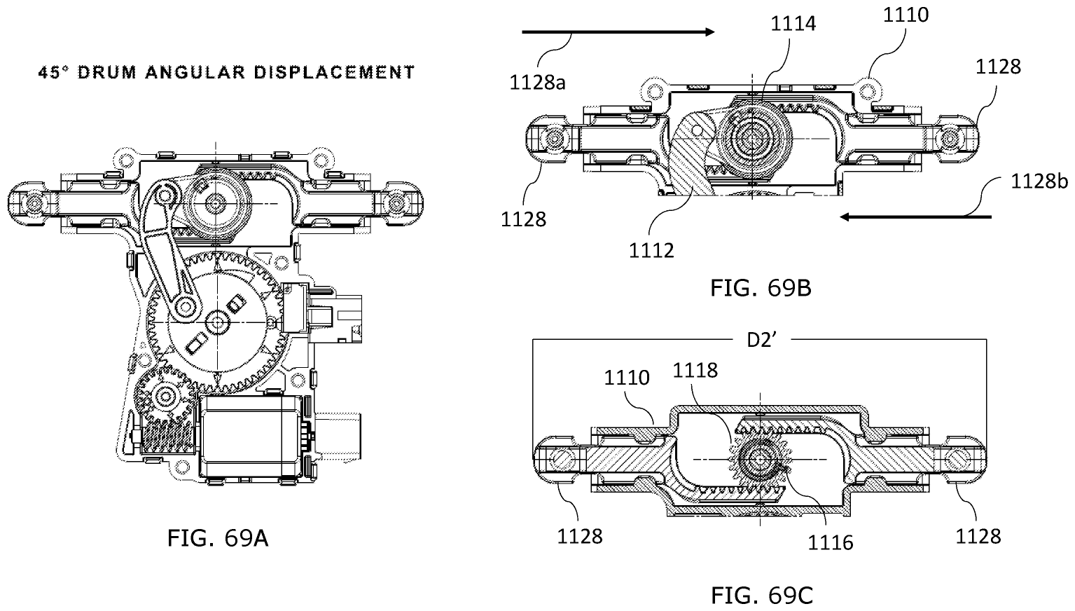

As shown in FIGS. 69A-69C, the drum 1130 is depicted as traveling an angular displacement of 4520 in a single direction, e.g., counter-clockwise direction. In response to the motion and angular displacement of the drum 1130, the lever 1112 moves and therefore causes driver 1114 and gear 1118 to move. The movement is similar to that described between the gear 118 and at least one pawl 128, as described above. The at least one pawl 1128 simultaneously moves until an end portion of one of the at least one pawl 1128 and another end portion of another of the at least one pawl 1128 are in a first withdrawn position relative to the rest position shown in FIG. 68C, for example, for a distance (D2′). In an exemplary embodiment, D2′ is 125.8 mm. Specifically, the at least one pawl 1128 laterally translates in a direction depicted by the arrows (1128a, 1128b) in FIG. 69B, for example.

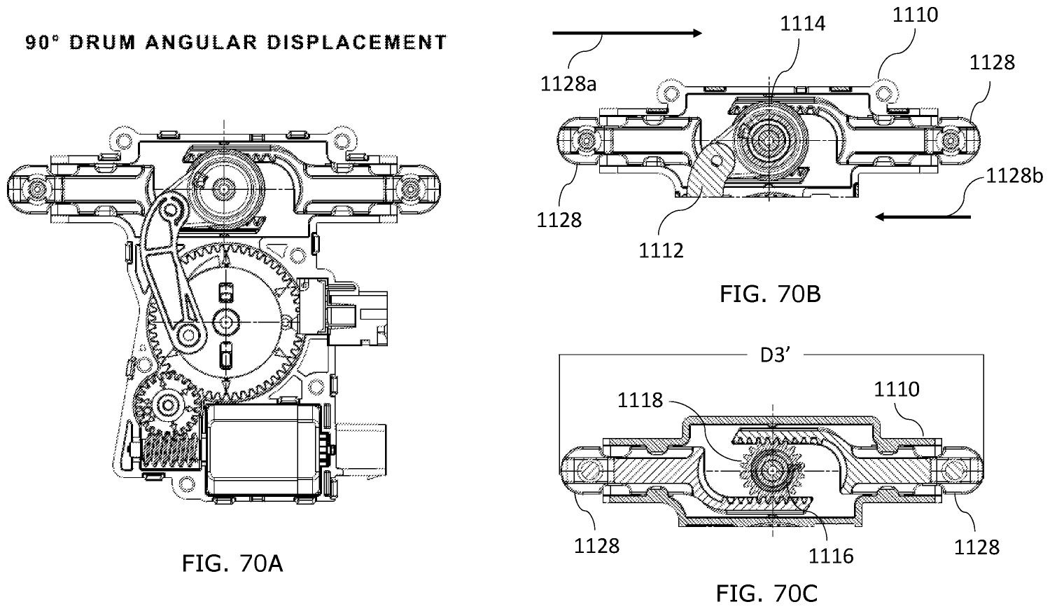

As illustrated in FIGS. 70A-70C, the drum 1130 is depicted as traveling an angular displacement 90° in a single direction, e.g., counter-clockwise direction. As described above, the at least one pawl 1128 simultaneously moves until an end portion of one of the at least one pawl 1128 and another end portion of another of the at least one pawl 1128 are in a second withdrawn position relative to the rest position shown in FIG. 68C, for example, for a distance (D3′). In an exemplary embodiment, D3′ is 117.2 mm. Specifically, the at least one pawl 1128 laterally translates in a direction depicted by the arrows (1128a, 1128b) in FIG. 70B, for example.

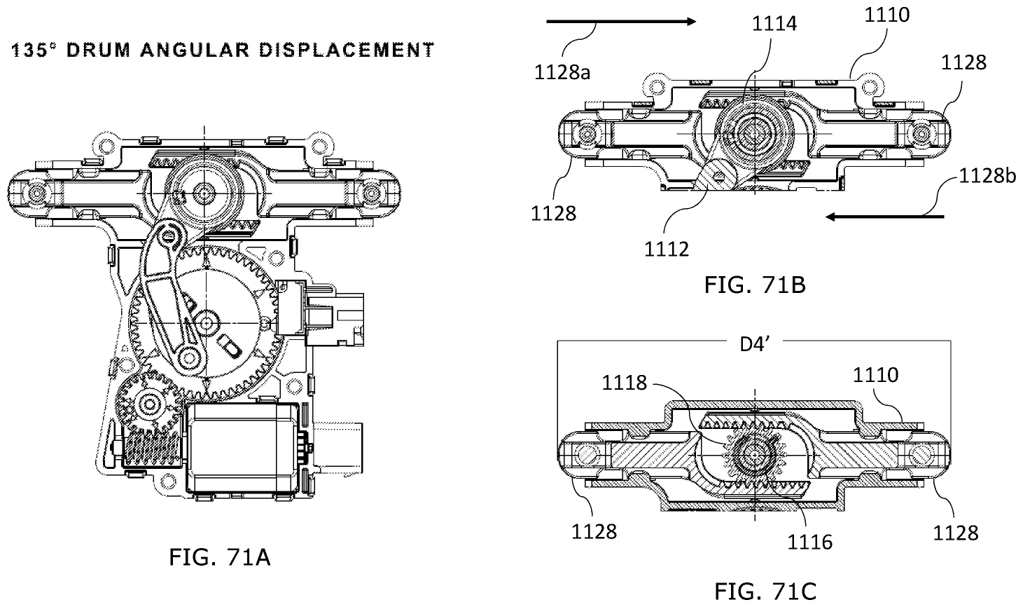

As illustrated in FIGS. 71A-71C, the drum 1130 is depicted as traveling an angular displacement 135° in a single direction, e.g., counter-clockwise direction. The pawls 1128 simultaneously move until an end portion of one of the pawls 1128 and another end portion of another of the pawls 1128 are in a third withdrawn position relative to the rest position shown in FIG. 68C, for example, for a distance (D4′). In an exemplary embodiment, D4′ is 108.88 mm. Specifically, the at least one pawl 1128 laterally translates in a direction depicted by the arrows (1128a, 1128b) in FIG. 71B, for example.

As illustrated in FIGS. 72A-72C, the drum 1130 is depicted as traveling an angular displacement 180° a single direction, e.g., counter-clockwise direction. The pawls 1128 simultaneously move until an end portion of one of the pawls 1128 and another end portion of another of the pawls 1128 are in a fourth withdrawn position relative to the rest position shown in FIG. 68C, for example, for a distance (D5′). In an exemplary embodiment, D5′ is 105.24 mm. Specifically, the at least one pawl 1128 laterally translates in a direction depicted by the arrows (1128a, 1128b) in FIG. 72B, for example. At this degree of angular displacement, e.g. 180°, the at least one pawl 1128 is in the fully withdrawn or retracted position, e.g. the unlocked position, such that the at least one pawl 1128 is configured to be disengaged from the strikers. When the at least one pawl 1128 is disengaged from the strikers, the latch 1100 is thus in the unlatched state and a door, such as a glove box door, can be opened.

As illustrated in FIGS. 73A-73C, while the latch 1100 is still in the unlatched state, the drum 1130 is depicted as traveling an angular displacement 225° in a single direction, e.g., counter-clockwise direction. When the drum 1130 has traveled an angular displacement of at least 180° and/or while the latch 1100 is in the unlatched state, the at least one pawl 1128 begin to move or return to the rest or locked position.

In particular, the movement of the at least one pawl 1128 to the locked position while the latch 1100 is in the unlatched state desirably places them in a “reset” condition in preparation for another use cycle of latch 1100, such as for moving the latch 1100 back to the latched state from the unlatched state. The at least one pawl 1128 simultaneously move until an end portion of one of the pawls 1128 and another end portion of another of the pawls 1128 are in a first extended position relative to the fourth withdrawn position shown in FIG. 72C, for example, for a distance (D6′). In an exemplary embodiment, D6′ is 107.86 mm. Specifically, the at least one pawl 1128 laterally translates in a direction depicted by the arrows (1128c, 1128d) in FIG. 73B, for example.

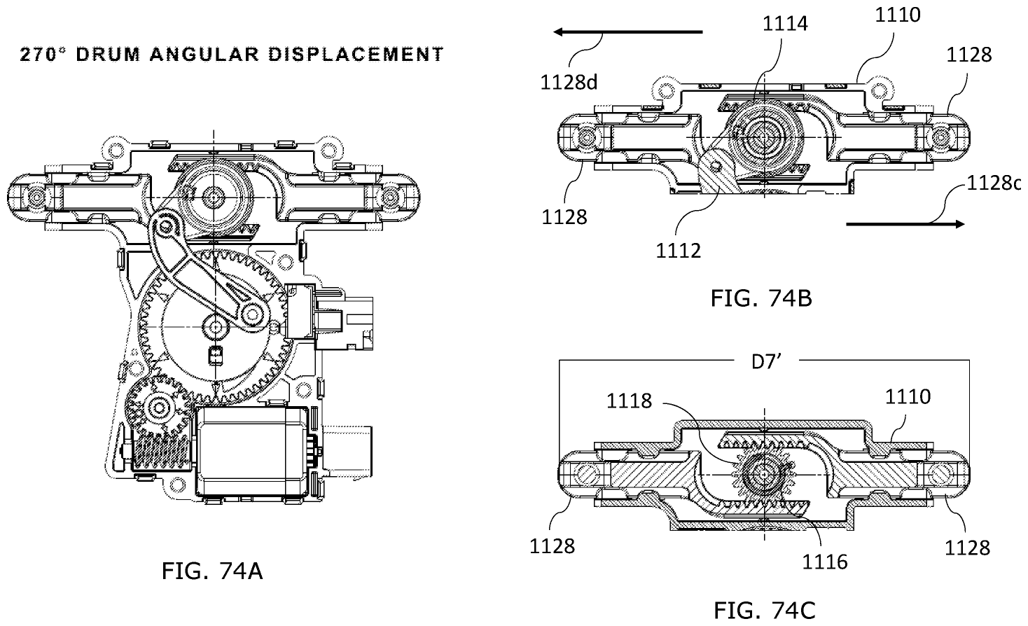

As illustrated in FIGS. 74A-74C, the drum 1130 is depicted as traveling an angular displacement 270° in a single direction, e.g., counter-clockwise direction. The pawls 1128 simultaneously move until an end portion of one of the pawls 1128 and another end portion of another of the pawls 1128 are in a second extended position relative to the fourth withdrawn position shown in FIG. 72C, for example, for a distance (D7′). In an exemplary embodiment, D7′ is 114.28 mm. Specifically, the at least one pawl 1128 laterally translates in a direction depicted by the arrows (1128c, 1128d) in FIG. 74B, for example.

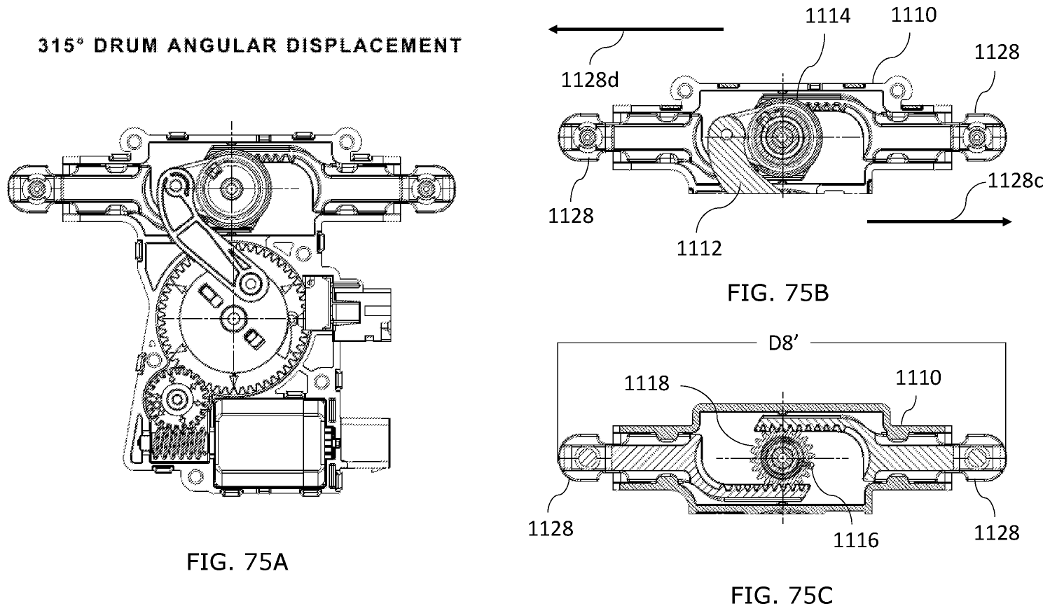

As illustrated in FIGS. 75A-75C, the drum 1130 is depicted as traveling an angular displacement 315° a single direction, e.g., counter-clockwise direction. The pawls 1128 simultaneously move until an end portion of one of the pawls 1128 and another end portion of another of the pawls 1128 are in a third extended position relative to the fourth withdrawn position shown in FIG. 72C, for example, for a distance (D8′). In an exemplary embodiment, D8′ is 124.2 mm. Specifically, the at least one pawl 1128 laterally translates in a direction depicted by the arrows (1128c, 1128d) in FIG. 75B, for example.

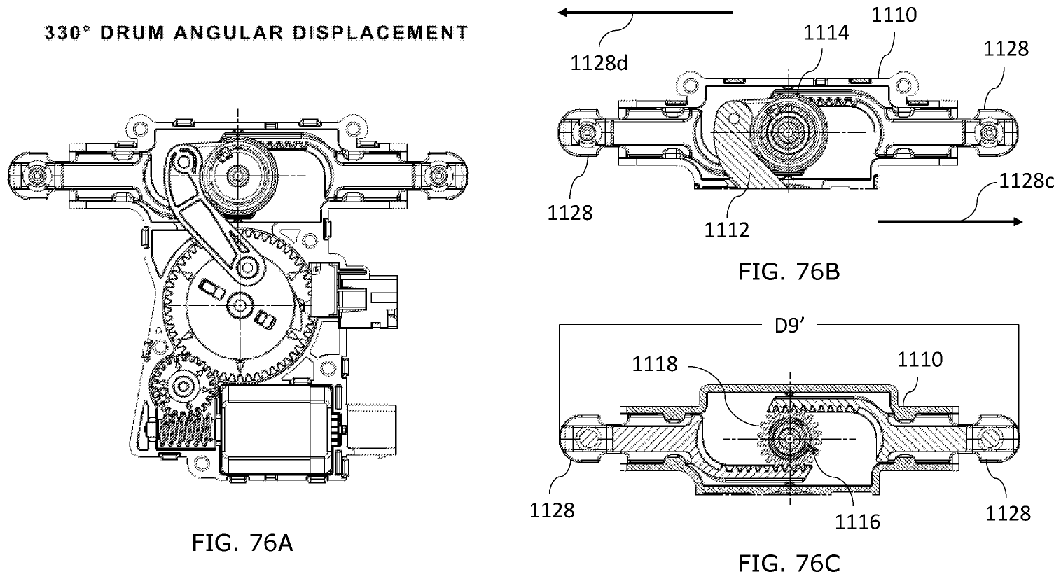

As illustrated in FIGS. 76A-76C, the drum 1130 is depicted as traveling an angular displacement 330° in a single direction, e.g., counter-clockwise direction. The pawls 1128 simultaneously move until an end portion of one of the pawls 1128 and another end portion of another of the pawls 1128 are in a fourth extended position relative to the fourth withdrawn position shown in FIG. 72C, for example, for a distance (D9′). In an exemplary embodiment, D9′ is 127.46 mm. Specifically, the at least one pawl 1128 laterally translates in a direction depicted by the arrows (1128c, 1128d) in FIG. 76B, for example.

The movement of the components of the dissociation assembly 1224 (as shown in FIGS. 76A-76C and 77-77C above) corresponds to the movement of the components of the gear assembly 1106 (as shown in FIGS. 64H-64I), when the drum 1130 has traveled an angular displacement between 330° to 350°. When the angular displacement of the drum 130 is between 325° to 355°, the upper ring portion having protrusion 1182c of locker 1134 is guided away from the side wall 1174 of the wheel 1138 and towards the side wall 1188 of the wheel 1138. In this way, when the protrusion 1182c of the locker 1134 is guided away from the side wall 1174, the pin 1182b is moved toward the locked position, in which the locker 1134 restricts the ability of the drum 1130 to rotate about the wheel axis in response to rotation of the wheel 1138. When the angular displacement of the drum 130 is between 325° to 355°, the protrusion 1182a engages the detent 1180b of the wheel 1138, such that protrusion 1182c of the locker 1134 is guided away from the side wall 1174. In this way, the locker 1134 moves radially relative to the shaft 1152 toward the locked position, such that at least the pin 1182b of the locker 1134 moves within radially displaced portion 1186 of the annular surface 1184 and toward the stop surface 1196. When the pin 1182b is radially displaced such that it is adjacent the stop surface 1196, the locker 1134 is in the locked position, in which the locker 1134 restricts the ability of the drum 1130 to rotate about the wheel axis in response to rotation of the wheel 1138.

The restriction of the ability of the drum 1130 to rotate thereby restricts the movement of lever 1112. A comparison among FIGS. 76A-76C, 77A-77C, and 78A-78C, which depict the drum 1130 as traveling an angular displacement between 330° to 360° in a single direction, e.g., counter-clockwise direction, show that the at least one pawl 1128 is configured to return to the locked position or a “reset” position in preparation for another use cycle of the latch 1100, while the latch 1100 is still in the unlatched state and the door is in an open state. Further, an end portion of one of the at least one pawl 1128 and another end portion of another of the at least one pawl 1128 are configured to be respectively displaced for a distance D9′ (FIG. 76C), D10′ (FIG. 77C), and D11′ (FIG. 78C). The distances D9′, D10′, and D11′ show minor differences relative to each other because the angular displacement of the drum 130 between D9 and D11 is just 30°. Further, at the particular angular displacement between 330° to 350°, the micro-switch 1124 is about to be or triggered (by interaction of dome 1160 and the indexing means or curved portion 1162 of drum 1130) to deactivate the power supply to motor 1104, thereby stopping the motor 1104.

It should be understood that the above description of operating the dissociation assembly 1224 is not limited to any step or sequence of steps, and may vary from that which is shown and described without departing from the scope and spirit of the invention.

Referring now to FIGS. 79A-791, movement of one or more components of the dissociation assembly 1224 are shown under manual operation. As stated above, the dissociation assembly 1224 may be additionally or optionally configured to facilitate manual actuation of the at least one pawl 1128, such that the latch 1100 moves toward the latched state. The movement of the latch 1100 toward the latched state is achieved by similar operation of the latch 100 toward the latched state, as described above. Namely, movement toward the latched state involves manual actuation of the at least one pawl 1128 toward a withdrawn or retracted position relative to the housing 1110 until they are back in a position to engage with the strikers (not shown). Subsequently, the biasing force of torsion spring 1116 moves the at least one pawl 1128 back toward the locked position. When the at least one pawl 1128 is in the locked position, the latch 1100 is in the latched state and the door is closed.

FIGS. 79A-79C depict one or more components of the dissociation assembly 1224 at a home, or rest position. In this rest position, which is similar to what is shown in FIGS. 68A-68C, the driver 1114 is immobilized in a starting or rest position, as determined by the arrangement of the lever 1112, which is connected to gear assembly 1106, when the motor 1104 is inactive (and therefore provides no output from the gear assembly 1106). As stated above, the spring 1116 is configured for retaining gear 1118 in this rest position by exerting a biasing force to maintain “wall-to-wall” contact between the radial surface of the gear 1118 and the stop surface of driver 1114. Further, the spring 1116 is “pre-compressed” for a nominal degree, such as for up to 5° and more particularly, for up to 4.7°. In this arrangement, the pre-compression of the spring 116 at rest position helps reduce noise (e.g. rattle, vibration, etc.) generated by one or more of the components of latch 1100 while it is in rest position and/or while a vehicle having the latch 1100 is in motion. Additionally, in this rest position, the at least one pawl 1128 is in an extended position, such that an end portion of one of the at least one pawl 1128 and another end portion of another of the at least one pawl 1128 are positioned for a distance (D(1)).

FIGS. 79D-79F depict one or more components of the dissociation assembly 1224 at a half manual stroke position. A manual application of force or pressure (along displacement directions 1128e, 1128f shown in FIG. 79B, for example) on at least one pawl 1128 causes the gear 1118 to rotate against the biasing force of spring 1116. Movement of the at least one pawl 1128 and the gear 1118 compresses the spring 1116 with increasing force as the displacement of the at least one pawl 1128 increases. In this position, the at least one pawl 1128 is moved toward a withdrawn position relative to the rest position shown in FIG. 79A, such that an end portion of one of the at least one pawl 1128 and another end portion of another of the at least one pawl 1128 are positioned for a distance (D(1)'). The distance (D(1)′) is therefore less than the distance (D(1)).

FIGS. 79G-79I depict one or more components of the dissociation assembly 1224 at a full manual stroke position. A manual application of force or pressure (along displacement directions 1128e, 1128f shown in FIG. 79H, for example) on at least one pawl 1128 causes the gear 1118 to further rotate against the biasing force of spring 1116, thereby further compressing the spring 1116 with further increasing force. In this position, the at least one pawl 1128 is moved toward a further withdrawn position relative to the rest position shown in FIG. 79A, such that an end portion of one of the at least one pawl 1128 and another end portion of another of the at least one pawl 1128 are positioned for a distance (D(1)″). In other words, the distance (D(1)″) is less than the distance (D(1)′) because the at least one pawl 1128 is in the further withdrawn position relative to the withdrawn position shown in FIG. 79F, for example. Once manual actuation of the at least one pawl 1128 toward the fully withdrawn or retracted position is achieved, the at least one pawl 1128 is/are returned to a position in which the at least one pawl 1128 are configured to engage with the strikers (not shown) and subsequently, the biasing force of torsion spring 1116 moves the at least one pawl 1128 back toward the extended or locked position.

In an exemplary embodiment, moving the at least one pawl 1128 toward the full manual stroke position, corresponds to total displacement of the at least one pawl 1128 at approximately 17.5 mm, which causes the gear 1118 to rotate along a counter-clockwise or clockwise direction within the driver 1114, for an angular displacement of up to 125°.

It should be understood that the above description of manually operating the dissociation assembly 1224 is not limited to any step or sequence of steps, and may vary from that which is shown and described without departing from the scope and spirit of the invention.

Finally, the latch 1100 also differs from latch 100 in that it comprises a plurality of isolator or isolator features. In existing/current state of the art designs, a rubber material may be fitted between portions of housing 1110 and corresponding portions of cover 1108 for attachment of latch 1100 to a panel 2010 via a fastening means 2004 (e.g. a screw). In this arrangement, the rubber material is configured to reduce noise and vibration because neither the portion of the housing 1110 nor the corresponding portion of cover 1108 are in contact with the panel 2010.

Generally, according to one aspect of the invention, the latch assembly has at least one isolator or isolator feature, which is part of the latch assembly, such as the latch cover itself, configured to be engaged to a support, which may comprise a panel. The at least one isolator feature has a mounting portion configured to be mounted to the support along a mounting axis, a perimeter portion spaced radially outwardly from the mounting portion relative to the mounting axis, and connectors extending between and connecting the mounting portion to the perimeter portion. The connectors are configured to support the perimeter portion relative to the mounting portion and inhibit the transmission of vibration between the mounting portion and the perimeter portion. The at least one isolator feature at least partially isolates the latch assembly from the support such that at least some of the vibration associated with the latch assembly or the support are not transmitted to the other of the latch assembly or the support.

The at least one isolator feature can further comprise a mounting aperture defined in the mounting portion and the connectors can comprise a plurality of mounting arms configured to couple portions of the mounting portion to the perimeter portion. Also, the at least one isolator feature and the latch assembly can be formed integrally. The at least one isolator feature and the latch assembly can be formed from the same material, or the at least one isolator feature and the latch assembly can be formed from different materials.

The at least one isolator feature can have at least three connectors extending between and connecting the mounting portion to the perimeter portion. For example, the at least one isolator feature can have four connectors extending between and connecting the mounting portion to the perimeter portion. The connectors can be equally spaced relative to one another, and the connectors can extend radially outwardly relative to the mounting axis.

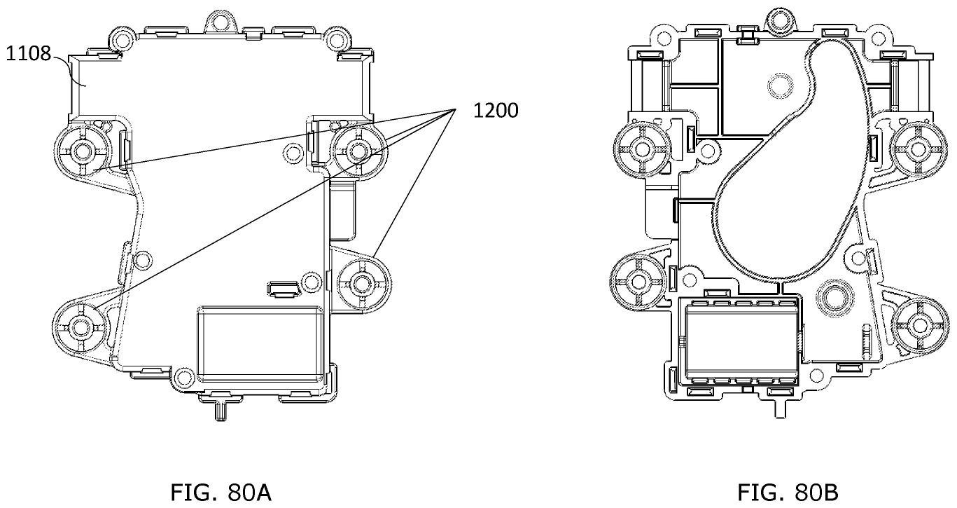

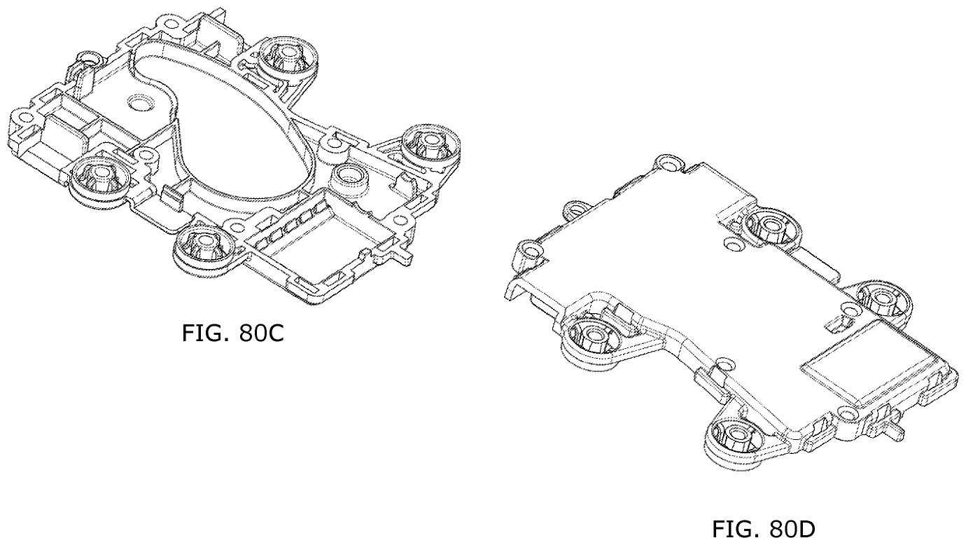

Referring specifically to FIGS. 80A-80D, 81A-81D, and 82A-82F, the 1100, includes a plurality of isolator features 2000 that may be integrally formed with the latch assembly, which includes the cover 1108, as a single body of unitary construction. Additionally or optionally, the isolator features 2000 may comprise similar or different materials relative to that of the latch assembly, which includes cover 1108. For example, the latch assembly, which includes cover 1108, and/or the isolator features 2000 may be made from flexible plastic material (e.g. polypropylene). The housing 1110 may be made of a more durable or rigid plastic material (e.g. nylon with reinforcing glass fiber) relative to the more flexible material of the latch assembly, which includes cover 1108 and/or the isolator features 2000. The relative durability of the material of housing 1110 desirably provides stability and structure to the latch 1100, which maintains one or more components housed within enclosure 1102 in their proper positions relative to each other.

The isolator features 2000 provide an improved mounting means or surfaces for attaching the latch 1100 to the panel 2010 via fastening means 2004. As shown in FIGS. 80A-80D, the plurality of isolator features 2000 are disposed around at certain points along a perimeter of the latch assembly, such as a perimeter of cover 1108. In an exemplary embodiment, the isolator features 2000 are spaced apart from each other and are symmetrically positioned along a full length or width of at least the cover 1108, or the latch 1100. For example, a pair of isolator features 2000 may be positioned along a left or right side of the latch 1100, and another pair of isolator features 2000 may be positioned along the other of the left or right side of the latch 1100. One skilled in the art would understand that the illustrated position and number of isolator features 2000 in FIGS. 80A-80D are not intended to be limiting, such that the position and number of isolator features 2000 may depend on the size and shape of one or more components of the latch 1100 (e.g. cover 1108) or a characteristic of the support, which includes panel 2010.

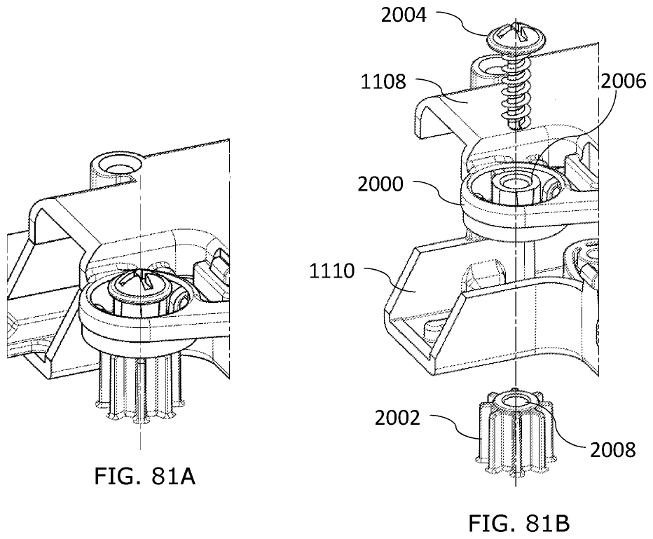

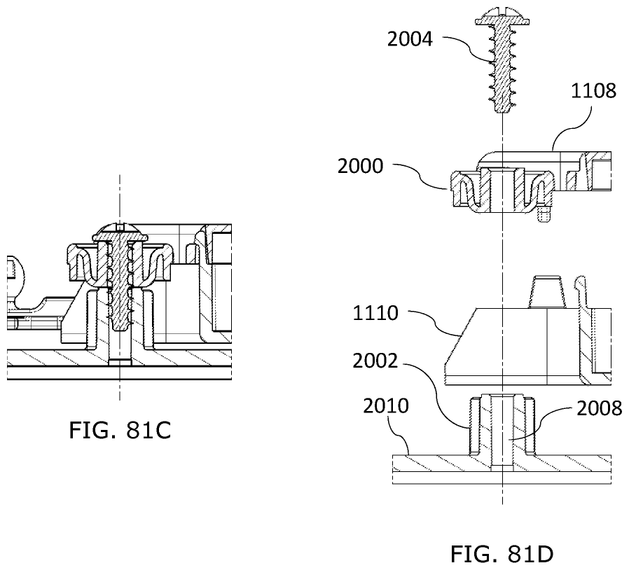

Turning now to FIGS. 81A-81D, the latch assembly including cover 1108 interacts with a support comprising panel 2010 via a flexible link, e.g. isolator features 2000. To assemble the latch 1100, a corresponding structure (e.g. shaft 2002) of the support, which includes panel 2010, is configured to abut a respective mounting aperture 2006 defined by each isolator feature 2000. As best shown in FIGS. 81C and 81D, the shaft 2002 of a panel 2010 of the support, has an opening 2008 which corresponds to a mounting aperture 2006 of isolator feature 2000, such that when the shaft 2002 is in contact with the isolator feature 2000, the mounting aperture 2006 and opening 2008 together form a hole through which screw 2004 extends, thereby attaching the latch 1100 to the panel 2010 of the support. Further, as best seen in FIGS. 81A-81B, the housing 1110 is “anchored” or coupled to the latch assembly comprising cover 1108 via isolator features 2000, without a portion of housing 1110 contacting a surface of the support comprising panel 2010.

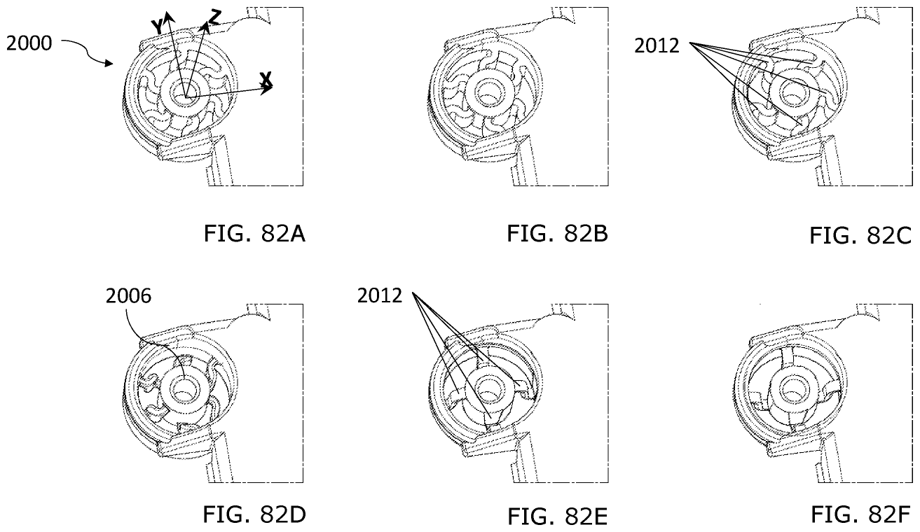

Referring now to FIGS. 82A-82F, the isolator features 2000 comprise the mounting aperture 2006, a plurality of mounting arms 2012 connecting the mounting aperture 2006 to an outer circumference of isolator feature 2002. The shape, size, and number of mounting arms 2012 may vary to accommodate motions associated with attachment of latch 1100 to support comprising panel 2010. For example, the isolator features 2000 of FIGS. 82A and 82B are designed to accommodate motions in the X and/or Y direction(s). The isolator features of FIGS. 82C-82D are designed to accommodate motions in the X, Y, and/or Z directions. The isolator feature of FIG. 82F is designed to accept some angular misalignment (e.g. between 5° and 10°) between tooling direction of latch assembly comprising cover 1108 and tooling direction of support comprising panel 2010.

Additionally or optionally, incorporation of the isolator features 2000 to latch 1100, particularly to cover 1108 of latch 1100, can reduce cost of manufacture or installation of latch 1100.

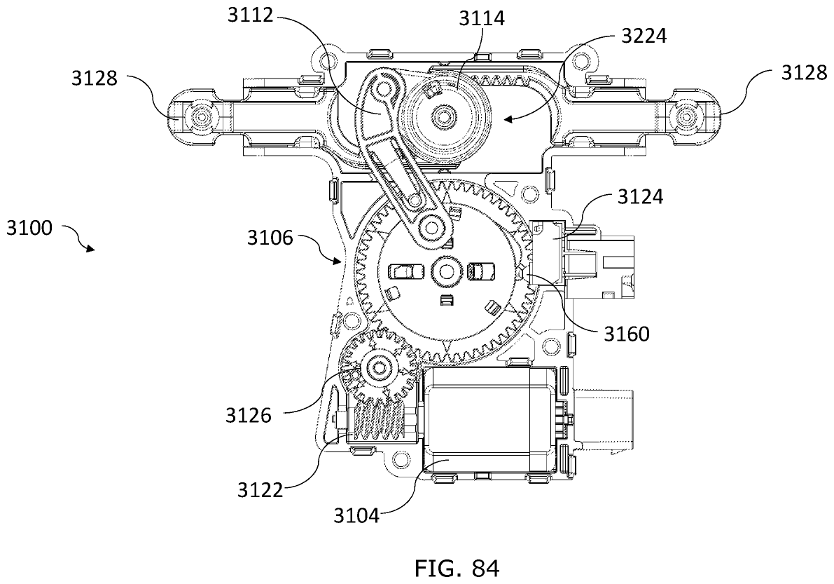

Another embodiment of an assembled latch made according to the present invention is illustrated in FIGS. 84 to 88G. The components of this embodiment, such as latch 3100, generally correspond to the embodiments described above. For example, latch 3100 generally comprises an enclosure, a motor 3104, and an exemplary gear assembly 3224 that permits a partial or complete, direct or indirect disconnection and/or separation of motion of one component from of another component, e.g. a “dissociation assembly.” The components and operation of gear assembly 3224 are similar to the components and operation of gear assembly 1224, as described above.

FIG. 84 depicts a latch 3100 with a cover 3108 (not shown) removed to show arrangement of components therein. Latch 3100 comprises a motor 3104 having a rotatable output shaft with a fixed worm screw 3122; at least one gear 3126 driven by the output shaft of the motor 3104; and a micro-switch 3124, the details of each of which generally correspond to the details of the motor 1104, screw 1122, at least one gear 1126, and micro-switch 1124, respectively, as described above.

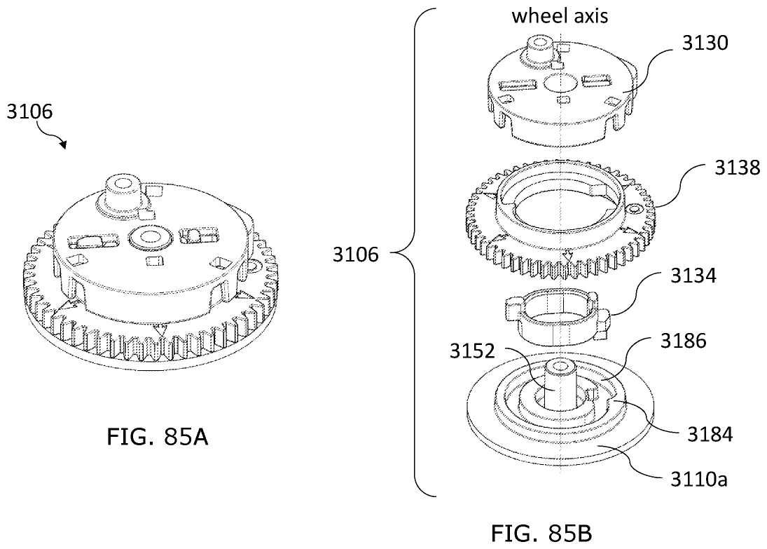

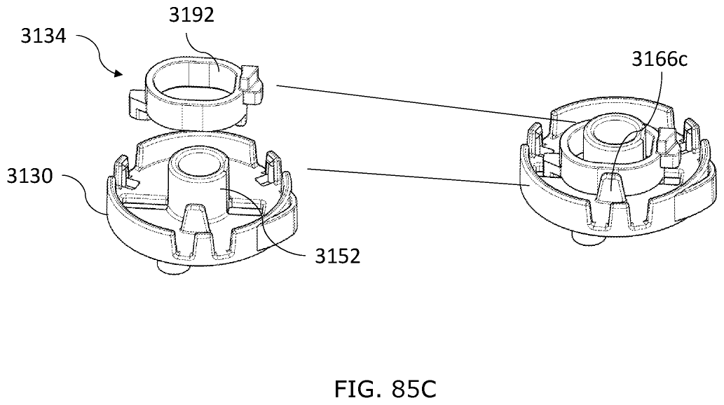

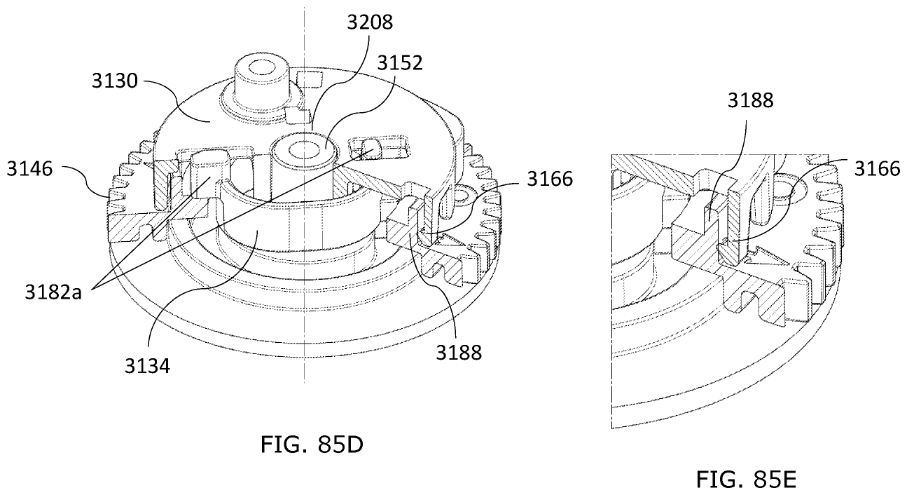

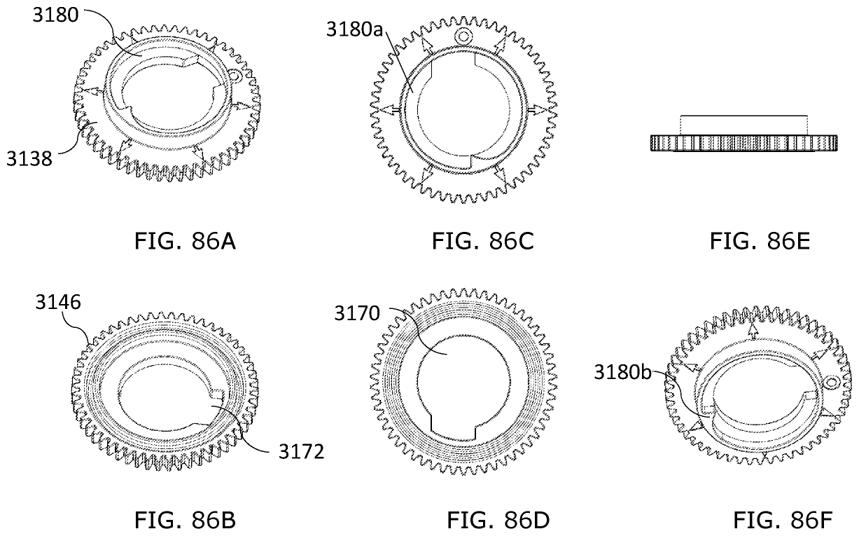

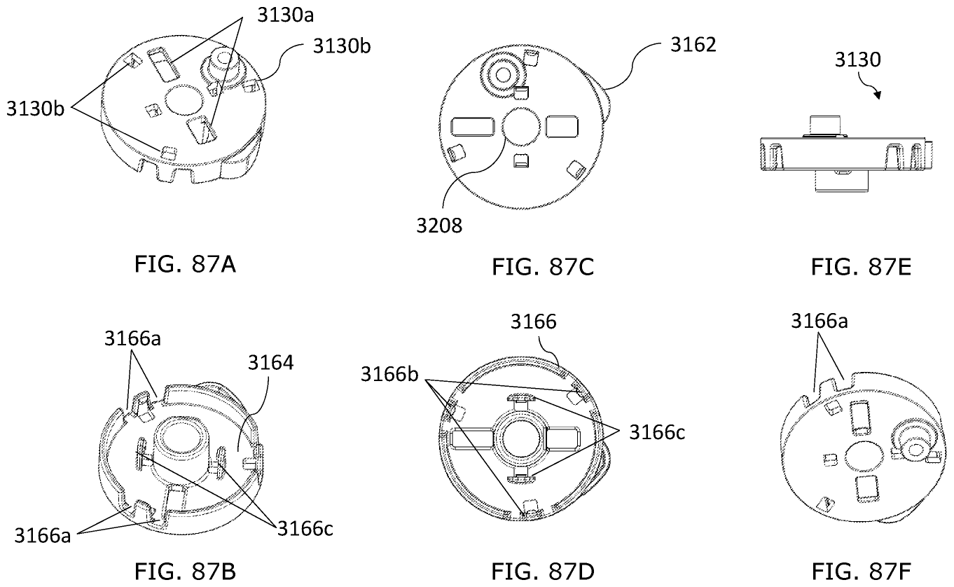

However, this embodiment differs from the embodiments described above in several respects. In one example and with reference to FIGS. 85A-85E, latch 3100 includes an exemplary gear assembly 3106, the details of which generally correspond to the details of the gear assembly 1106, as discussed above. Gear assembly 3106 comprises a wheel 3138, a drum 3130, and a locker 3134. The gear assembly 3106 also includes a housing 3110a defining an annular surface 3184 having a radially displaced portion 3186 that is displaced radially relative to the wheel axis or the center of the drum 3130, the details of all of which generally correspond to the respective details of the locker housing 1110a, annual surface 1184, and radially displaced portion 1186, as discussed above. Likewise, the details of locker 3134 generally correspond to the details of the locker 1134, as discussed above. Individual details of wheel 3138 and drum 3130 are now discussed below and with reference to FIGS. 86A-86F and 87A-87F, respectively.

FIGS. 86A-86F depict the wheel 3138, the details of which generally correspond to the details of the wheel 1138, as described above. However, wheel 3138 differs from the wheel 1138 described above in some respects. In one example, the wheel 1138 has a radial surface 3180 defined by hole 3170, and at least a portion of radial surface 3180 is configured to interact with at least protrusion 3182a of the locker 3134 (FIG. 85D). This interface between the radial surface 3180 and upper ring portion having protrusion 3182a of the locker 3134 facilitates the movement of the locker 3134 between unlocked and locked positions. As best seen in FIGS. 85A and 85F, radial surface 3180 may include a ledge 3180a extending radially inward from side wall 1188 and along an arc length.

Additionally or optionally, radial surface 3180 may include at least one detent 3180b extending radially inward from a side wall 3188 of wheel 3138. In particular, the smooth interface between the locker 3134 and the wheel 3138 via the engagement between detent 3180b of the wheel 3138 and the protrusions 3182a of the locker 3134 desirably facilitates the rotation of drum 3130 about the wheel axis in response to motion of the wheel 3138, e.g. permits the drum 3130 to be immobilized by the locker 3134 when the locker 3134 is in the locked position, and permits the drum 3130 to move in response to the motion of the wheel 3138 when the locker 3134 is in the unlocked position.

The smooth interface between the locker 3134 and the wheel 3138 via the engagement between detent 3180b of the wheel 3138 and the protrusions 3182a of the locker 3134 is further configured to mitigate or prevent noise and/or vibration caused by interaction of various components of gear assembly 3106, such as during operation of latch 3100, for example. As best shown in FIGS. 85D and 86C, the detent 3180b has a curved geometry that permits a smoother contact point or surface between the detent 3180b of wheel 3138 and protrusions 3182a of the locker 3134, thereby reducing the noise and/or vibration caused by interaction between wheel 3138 and locker 3134. Further, mitigation or prevention of noise and/or vibration caused by interaction of various components of gear assembly 3106 is desirable, particularly during operation of latch 3100 when the wheel 3138 is allowed to rotate for an additional partial or plural number of turns, due to the effect of inertia of the motor 3104.

FIGS. 87A-87F depict the drum 3130, the details of which generally correspond to the details of the drum 1130 above. The drum 3130 has a circular body and the rear surface 3166 defines a cavity 3164, as shown in FIG. 86B. Still further, the center of the drum 1130 defines an opening 3208, through which shaft 3152 may pass for rotatably mounting the drum 3130 to the wheel 3138 and for mounting the drum 3130 within the enclosure. However, drum 3130 differs from the drum 1130 described above in some respects. In one respect, drum 3130 includes a curved portion 3162, the details of which generally correspond to those of curved portion 1162 described above, except that curved portion 3162 has a relatively more rounded geometry that permits curved portion 3162 to have a smoother contact point with dome 3160 of micro-switch 3124, the details of which generally correspond to those of dome 1160 as described above. This smoother interface between the curved portion 3162 portion of the drum 3130 and dome 1160 reduces or prevents noise and/or vibration as the drum 3130 rotates in response to motion of wheel 3138, for example.

In another respect, drum 3130 includes a discontinuous outer perimeter. Namely, drum 3130 includes a plurality of clips 3166b disposed equidistant relative to each other and along the outer perimeter of drum 3130. A plurality of gaps 3166a may also be disposed along the outer perimeter of drum 3130, such that one of the plurality of clips 3166b may be disposed therebetween. In another respect, a front surface opposite the rear surface 3166 further defines another set of openings 3130b configured to receive a portion of side wall 3188 of wheel 3138, when the at least side wall 3188 of the wheel 3138 is nested within cavity 3164 of drum 3130 (as best shown in FIGS. 85D and 85E).

Notably, the interface between the drum 3130 and the wheel 3138 via the engagement between side wall 3188 of the wheel 3138 and clips 3166b of the drum 3130 is configured to mitigate or prevent noise and/or vibration caused by operation of latch 3100, for example. The clips is able to withstand multiple use cycles of latch 3100 without breaking or malfunctioning, such that clips 3166b act as flexible connection points between surfaces of drum 3130 and surfaces of wheel 3138. This flexible connection point mitigates or prevents horizontal displacement that causes undesirable noise and/or vibration, e.g. horizontal displacement of the drum 3130 relative to wheel 3138, as the drum 3130 rotates in response to motion of wheel 3138 during operation of latch 3100. Further, mitigation or prevention of noise and/or vibration caused by interaction of various components of gear assembly 3106 is desirable, particularly when latch is at rest to prevent rattling noises during vehicle drive, and during operation of latch 3100 when the wheel 3138 is allowed to rotate for an additional partial or plural number of turns, due to the effect of inertia of the motor 3104.

Similarly, with reference to FIGS. 85A-85C, the interface between the drum 3130 and the locker 3134 via the engagement between a plurality of clips 3166c of drum 3130 and a ring-shaped body 3192 of locker 3134, is further configured to mitigate or prevent noise and/or vibration caused by operation of latch 3100, for example. The plurality of clips 3166c are disposed diametrically opposed each other with the shaft 3152 positioned there between. The plurality of clips 3166c is able to withstand multiple use cycles of latch 3100 without breaking or malfunctioning, such that the clips 3166c act as flexible connection points between surfaces of drum 3130 and surfaces of locker 3134. In one non-limiting example, the clips 3166c are made of flexible polymeric material (e.g. polypropylene). This flexible connection point mitigates or prevents horizontal displacement that causes undesirable noise and/or vibration, e.g. horizontal displacement of the locker 3134 relative to drum 3130, as the drum 3130 moves in response to the motion of the wheel 3138 when the locker 3134 is in an unlocked position. Further, mitigation or prevention of noise and/or vibration (e.g. rattling) caused by interaction of various components of gear assembly 3106 is desirable, particularly when latch is at rest (e.g. during non-operation of latch 3100) during vehicle drive, and/or during operation of latch 3100, when the ring-shaped body 3192 both rotates and is moveable radially relative to the shaft 3152 as the drum 3130 rotates around the wheel axis.

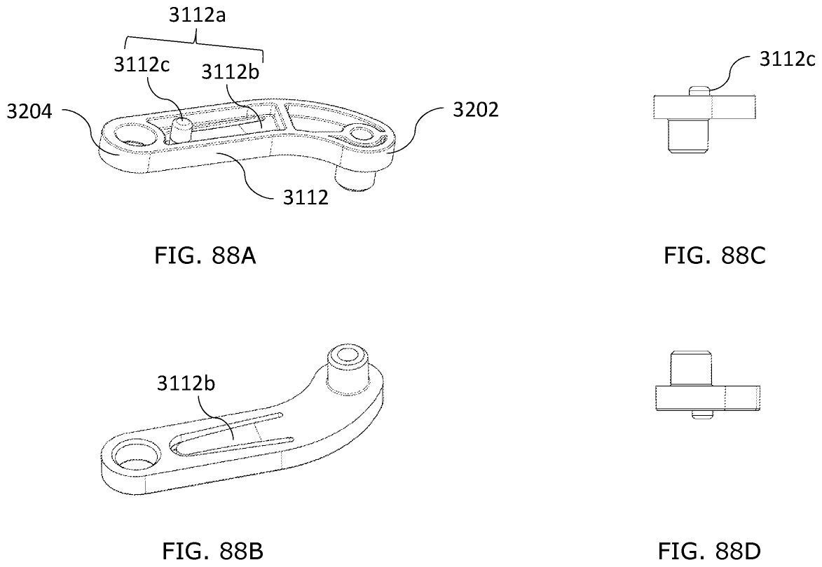

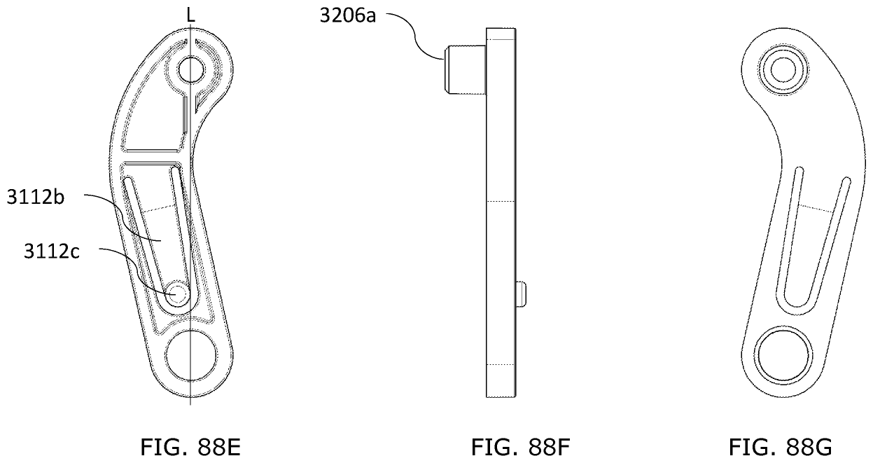

Turning now to FIGS. 88A to 88G, latch 3100 comprises a lever 3112. The details of lever 3112 generally correspond to the details of the lever 1112, as described above. Generally, lever 3112 is coupled to the drum 3130 and configured to move in response to motion of the drum 3130. The lever 3112 is an elongated body having a length “L” between a top end 3202 and a bottom end 3204. Disposed between the top end 3202 and bottom end 3204 of lever 3112 is a moveable connector 3112a that is able to withstand multiple use cycles of latch 3100 without breaking or malfunctioning, such that moveable connector 3112a acts as a flexible connection point between surfaces of lever 3112 and surfaces of a cover 1308 (not shown), the details of which generally correspond to those of the cover 1108 described above, or drum 3130. In one non-limiting example, the moveable connector 3112a is made of flexible polymeric material (e.g. polypropylene). This flexible connection point mitigates or prevents vertical displacement that results in undesirable noise and/or vibration, e.g. vertical displacement of the lever 3112 relative to drum 3130 or the cover 1308, as the drum 3130 rotates in response to the rotation of the wheel 3138.

In particular, moveable connector 3112a comprises an elongated leg 3112b. Additionally or optionally, moveable connector 3112a comprises a post 3112c mounted on or attached to a portion of elongated leg 3112b. One skilled in the art would understand from the description herein that the location or placement of post 3112c as illustrated in FIGS. 88A to 88G is not intended to be limiting, such that post 3112c may be disposed relatively more distal or proximal to the bottom end 3204. In this configuration, lever 3112 comprising moveable connector 3112a mitigates or prevents the noise and/or vibration (e.g. rattling) caused by various components of latch 3100, particularly when lever 3112 moves in response to an output of the gear assembly 3106, such as the motion of drum 3130, and/or when latch is at rest (e.g. during non-operation of latch 3100) during vehicle drive.

While preferred embodiments of the invention have been shown and described herein, it will be understood that such embodiments are provided by way of example only. Numerous variations, changes and substitutions will occur to those skilled in the art without departing from the spirit of the invention. For example, the latches described herein may be used for any compartment, and are not limited to a vehicle glove box. Additionally, variations, changes and substitutions among the different embodiments discussed above may fall within the spirit and scope of the invention. Accordingly, it is intended that the appended claims cover all such variations as fall within the spirit and scope of the invention.

What is claimed:

1. A gear assembly configured to be driven by an output shaft of a motor and to reduce or eliminate the effect of inertia of the motor on an output of the gear assembly, the gear assembly comprising:
a wheel configured to be engageably coupled directly or indirectly to the output shaft of the motor and to rotate about a wheel axis in response to motion of the output shaft of the motor;
a drum rotatably mounted to the wheel and configured to rotate about the wheel axis in response to rotation of the wheel; and
a locker configured to move relative to the wheel axis in response to motion of the wheel, the locker being movable between an unlocked position, in which the locker does not restrict the ability of the drum to rotate about the wheel axis in response to rotation of the wheel, and a locked position, in which the locker restricts the ability of the drum to rotate about the wheel axis in response to rotation of the wheel;
the locker in the unlocked position being engaged by the wheel for rotation of the wheel and the drum together about the wheel axis, and the locker in the locked position being disengaged from the wheel for rotation of the wheel relative to the drum, thereby allowing inertial motion of the output shaft of the motor and rotation of the wheel without causing rotation of the drum, and thereby reducing or eliminating the effect of inertia of the motor on the output of the gear assembly.

2. The gear assembly of claim 1, further comprising a housing defining an annular surface, a radially displaced portion of the annular surface being displaced radially relative to the wheel axis.

3. The gear assembly of claim 2, wherein the locker is mounted for movement relative to the drum, the locker comprising a body and a leg portion positioned adjacent the annular surface of the housing and the locker being configured to move radially relative to the wheel axis, the radially displaced portion of the annular surface being positioned to radially move the locker from the unlocked position to the locked position.

4. The gear assembly of claim 3, wherein the gear assembly further comprises a biasing means disposed within the drum and configured to bias the locker toward the unlocked position.

5. The gear assembly of claim 4, wherein the wheel defines a radial surface configured to move the locker against the biasing means, such that the leg portion of the locker is positioned adjacent the annular surface of the housing.

6. The gear assembly of claim 5, wherein the radial surface includes a side wall disposed at a first radial distance and another side wall disposed at a second radial distance relative to the center of the drum, and the first radial distance is greater than the second radial distance.

7. The gear assembly of claim 6, wherein the first and second radial distances are both greater than that of the annular surface of the housing.

8. The gear assembly of claim 5, wherein the radial distance of the annular surface is constant as the locker moves within a first range of angular displacement, thereby maintaining the leg portion of the locker at a constant leg radial distance relative to the center of the drum.

9. The gear assembly of claim 8, wherein the first range of angular displacement is between 0° to 305°.

10. The gear assembly of claim 5, wherein the radially displaced portion of the annular surface of the housing is positioned such that as the locker moves within a second range of angular displacement, the locker is guided toward the locked position.

11. The gear assembly of claim 10, wherein the second range of angular displacement is between 305° to 360°.

12. The gear assembly of claim 10, wherein when the locker is in the locked position, the leg portion of the locker is prevented by a stop surface of the housing from moving in response to motion of the wheel.

13. The gear assembly of claim 10, wherein as the locker moves within a third range of angular displacement, the body of the locker is radially displaced for a distance relative to a side wall of the wheel.

14. The gear assembly of claim 13, wherein the third range of angular displacement is between 305° to 330° and the distance is from 0 mm to 0.9 mm.

15. The gear assembly of claim 13, wherein the third range of angular displacement is between 335° to 340° and the distance is from 1.2 mm to 1.5 mm.

16. The gear assembly of claim 15, wherein the wheel further comprises an angled surface, such that as the locker moves within the third range of angular displacement, the locker is guided away from a side wall of the wheel and towards the angled surface of the wheel, the angled surface thereby moving the locker against the biasing means and toward the locked position.

17. The gear assembly of claim 13, wherein the third range of angular displacement is between 345° to 360°and the distance is from 1.9 mm to 3 mm.

18. The gear assembly of claim 17, wherein when the locker has been angularly displaced at 360° and the body of the locker is radially displaced relative to the side wall of the wheel at 3 mm, the locker is in the locked position and the leg portion of the locker is prevented by the stop surface from moving in response to motion of the wheel, thereby preventing the drum from moving in response to motion of the wheel.

19. The gear assembly of claim 1, wherein when both the locker and the drum are prevented from moving in response to motion of the wheel, the wheel continues to move in response to motion of the motor.

20. The gear assembly of claim 19, wherein as the wheel is prevented from moving in response to immobility of the motor, the locker is configured to be in the locked position.

21. The gear assembly of claim 20, wherein as the wheel moves in response to reactivation of the motor, the locker is configured to move toward the side wall of the wheel, and the locker thereby moves from the locked position and toward the unlocked position.

22. The gear assembly of claim 1, further comprising a lever coupled to the drum and configured to move in response to motion of the drum.

23. The gear assembly of claim 22, further comprising at least one pawl that is connected to the lever and configured to move in response to motion of the lever, the at least one pawl being movable between a locked position and an unlocked position.

24. The gear assembly of claim 23, wherein the at least one pawl is linked, such that the at least one pawl is connected to a driver, the driver being connected to the lever, such that motion of the lever in response to motion of the drum causes the driver to move, thereby moving the at least one pawl to move to the unlocked position from the locked position.

25. The gear assembly of claim 24, wherein the at least one pawl is extended farther from the housing in the locked position as compared with the unlocked position.

26. The gear assembly of claim 1, further comprising at least one gear interposed between the output shaft of the motor and the wheel, the at least one gear being configured to be driven by the output shaft of the motor.

27. The gear assembly of claim 2, the housing including a track comprising an internal side wall and an external side wall defining the annular surface, the internal and external side walls being radially disposed at an internal wall radial distance and an external wall radial distance, respectively, relative to a center of the drum.

28. A motorized latch comprising the gear assembly of claim 1, the latch being moveable between a latched state and an unlatched state, the latch further comprising:
a motor configured to cause rotation of the wheel;
a lever coupled to the drum and configured to move in response to rotation of the drum;
at least one pawl that is coupled to the lever and configured to move in response to motion of the lever; and
a driver coupled to the at least one pawl and the lever such that motion of the lever in response to rotation of the drum causes the driver to move, thereby moving the at least one pawl between an unlocked position and a locked position;
wherein when the at least one pawl is in the unlocked position, the latch is in the unlatched state, and when the at least one pawl is in the locked position, the latch is in the latched state.

29. A glove box comprising the latch of claim 28, the glove box further comprising a glove box door, the latch being mounted to the glove box door such that the at least one pawl in the locked position prevents opening of the glove box door.

30. The gear assembly of claim 1, further comprising a housing defining a shaft that extends along the wheel axis, the wheel being rotatably mounted to the housing by the shaft.

31. The gear assembly of claim 30, wherein the locker is mounted for movement relative to the wheel and configured to move translationally relative to the wheel axis in response to motion of the wheel, and the drum comprises guide walls configured to guide translational movement of the locker from the unlocked position toward the locked position.

32. The gear assembly of claim 31, further comprising a biasing means disposed within the drum and configured to bias the locker toward the unlocked position and for engagement with the wheel.

33. The gear assembly of claim 31, the locker comprising a ring and a leg portion extending downwardly from a predetermined location along a circumference of the ring.

34. The gear assembly of claim 32, the wheel defining a slot configured to receive at least the leg portion of the locker, such that at least the leg portion of the locker travels along an interior surface of the slot as the ring of the locker rotates about the wheel axis in response to motion of the wheel.

35. The gear assembly of claim 33, wherein as the drum moves within a range of angular displacement, the locker is translationally moved relative to the wheel axis, such that the locker is guided toward the locked position.

36. The gear assembly of claim 35, wherein when the locker is in the locked position, the leg portion of the locker is prevented by a locking surface of the shaft from moving in response to motion of the wheel.

37. The gear assembly of claim 36, wherein as the locker is guided toward the locked position, the leg portion of the locker moves away from the slot of the wheel.

38. The gear assembly of claim 37, wherein the locker comprises a stop surface and the locking surface comprises an angled portion and a locking portion, such that as the locker moves away from the slot of the wheel, the stop surface of the locker is guided by the angled portion for engagement with the locking portion, thereby moving the locker toward the locked position.

39. The gear assembly of claim 38, wherein when the locker is in the locked position and the stop surface of the locker is engaged by the locking portion of the shaft, the locker is prevented from moving in response to motion of the wheel, thereby preventing the drum from moving in response to motion of the wheel.

40. The gear assembly of claim 39, wherein when both the locker and the drum are prevented from moving in response to motion of the wheel, the wheel continues to move in response to motion of the motor.

41. A gear assembly configured to transfer rotational motion of an input into linear motion of an output relative to a rest position and to absorb linear motion of the output relative to the rest position without opposite rotational motion of the input, thereby dissociating the linear motion of the output from the opposite rotational motion of the input, the gear assembly comprising:
a gear mounted for rotational motion about a gear axis and coupled to generate the linear motion of the output relative to the rest position;
a driver coupled directly or indirectly to the gear and mounted for rotational motion about the gear axis, the driver providing the input of the gear assembly; and
a spring disposed in an interface between the gear and the driver, the spring being configured to bias the gear and the driver toward each other;
the interface of the driver and the gear being configured such that rotational movement of the driver as the input of the gear assembly transfers to rotational movement of the gear of the gear assembly, and rotational movement of the gear of the gear assembly transfers to linear motion of the output relative to the rest position;
the interface of the driver and the gear being further configured such that opposite linear motion of the output relative to the rest position causes the opposite rotational movement of the gear of the gear assembly, but the opposite rotational movement of the gear is not transferred to opposite rotational movement of the driver of the gear assembly;
the gear assembly thus absorbing linear motion of the output from the rest position without opposite rotational motion of the driver by dissociating the linear motion of the output from the opposite rotational motion of the driver.

42. A latch comprising the gear assembly of claim 41, the output of the gear assembly comprising at least one pawl that is coupled to the gear and configured for the linear motion in response to rotational motion of the gear, the at least one pawl being movable between a locked position, in which the latch is in the latched state, and an unlocked position, in which the latch is in the unlatched state;
wherein movement of the at least one pawl toward the unlocked position by the driver occurs without requiring compression of the biasing means, thereby restricting the ability of the driver and the gear to move relative to one another.

43. The latch of claim 42, further comprising a motor coupled to drive the driver for rotational movement about the gear axis, wherein manual movement of the at least one pawl to cause opposite rotational movement of the gear does not require operation of the motor.

44. A latch assembly configured to be mounted to a support, the latch assembly comprising:
at least one isolator configured to be engaged to the support;
the at least one isolator having a mounting portion configured to be mounted to the support along a mounting axis, a perimeter portion spaced radially outwardly from the mounting portion relative to the mounting axis, and connectors extending between and connecting the mounting portion to the perimeter portion;
wherein the connectors are configured to support the perimeter portion relative to the mounting portion and inhibit the transmission of vibration between the mounting portion and the perimeter portion; and
wherein the at least one isolator at least partially isolates the latch assembly from the support such that at least some of the vibration associated with the latch assembly or the support are not transmitted to the other of the latch assembly or the support.

45. The latch of claim 44, the at least one isolator further comprising a mounting aperture defined in the mounting portion and the connectors comprise a plurality of mounting arms configured to couple portions of the mounting portion to the perimeter portion.

46. The latch of claim 44, the at least one isolator and the latch assembly being formed integrally.

47. The latch of claim 44, the at least one isolator and the latch assembly being formed from the same material.

48. The latch of claim 44, the at least one isolator and the latch assembly being formed from different materials.

49. The latch of claim 44, the at least one isolator having at least three connectors extending between and connecting the mounting portion to the perimeter portion.

50. The latch of claim 49, the at least one isolator having four connectors extending between and connecting the mounting portion to the perimeter portion.

51. The latch of claim 44, the connectors being equally spaced relative to one another.

52. The latch of claim 44, the connectors extending radially outwardly relative to the mounting axis.

53. The gear assembly of claim 1, further comprising electrically conductive tracks or motor terminals being integrally formed with the housing.

54. The latch assembly of claim 44, further comprising a latch cover having the at least one isolator.

55. The latch assembly of claim 44, the support comprising a panel.

56. The latch assembly of claim 55, the panel comprising a shaft to which the at least one isolator is mounted.

57. The gear assembly of claim 22, wherein the lever comprises a moveable connector comprising an elongated leg.

58. The gear assembly of claim 57, wherein the moveable connector is configured to restrict vertical displacement of the lever relative to the drum or the cover, as the drum rotates in response to rotation of the wheel, thereby mitigating or preventing at least one of noise and vibration.

59. The gear assembly of claim 1, wherein the drum comprises a plurality of clips configured to restrict horizontal displacement of the drum relative to the wheel, as the drum rotates in response to rotation of the wheel, thereby mitigating or preventing at least one of noise and vibration.

60. The gear assembly of claim 59, wherein the plurality of clips is further configured to restrict horizontal displacement of the locker relative to the drum, as the drum rotates in response to rotation of the wheel when the locker is in the unlocked position, thereby mitigating or preventing at least one of noise and vibration.

61. The gear assembly of claim 1, wherein the wheel comprises a radial surface having at least one detent extending radially inward from a side wall of the wheel.

62. The gear assembly of claim 61, wherein the at least one detent is configured for partial or full engagement with at least one protrusion of the locker, the at least one detent having a curved geometry adapted for contact with the at least one protrusion, such that at least one of noise and vibration is mitigated or prevented.

63. The gear assembly of claim 57, wherein the moveable connector comprises a post mounted on the elongated leg.
